(19) United States
(12) Patent Application Publication
(10) Pub. No.: US 2025/0322716 A1
(43) Pub. Date: Oct. 16, 2025

(54) SYSTEMS AND METHODS TO DETECT AND PREVENT FRAUD

(71) Applicant: Acres Technology, Las Vegas, NV (US)

(72) Inventor: John F. Acres, Las Vegas, NV (US)

(21) Appl. No.: 19/179,654

(22) Filed: Apr. 15, 2025

Related U.S. Application Data
(60) Provisional application No. 63/634,211, filed on Apr. 15, 2024.

(51) Int. Cl. G07F 17/32

(52) U.S. Cl. CPC G07F 17/3239; G07F 17/3244; G07F 17/3267

(57) ABSTRACT

Systems and methods are directed to distributed systems that include networked electronic gaming machines. Before, after, or during play, attempted fraud may be detected and prevented.

### CROSS REFERENCE TO RELATED PATENT APPLICATIONS

This application claims priority to U.S. Provisional Patent Application No. 63/634,211, filed Apr. 15, 2024, which is incorporated herein by reference in its entirety.

### FIELD OF THE INVENTION

This disclosure relates generally to gaming systems, and more particularly to systems that connect electronic gaming machines on a network and that provide services to the gaming machines as well as management functions.

### BACKGROUND

Electronic gaming machines, such as slot machines or video poker machines, employ at least one computer processor that generates a random outcome for each game and controls how the outcome is revealed to a player, e.g., using a stepper motor to spin reels on a slot machine or showing cards on a video display of a poker machine. There are also a variety of associated devices that enable wagering and play. For example, wager buttons for selecting the amount of a wager, a game initiation button, a ticket reader, bill validators, speakers, lights, and key pads, combinations, thereof, and the like.

Gaming machines may operate on a stand-alone basis or they may be connected to a network of gaming machines (e.g., networked gaming machines). Networked gaming machines may have a variety of services provided to them via a remote server (e.g., in a secure room or from a secure server on the gaming floor or in a remote location). These may include progressive jackpots, player tracking, electronic funds transfers to or from the gaming machine, cashless ticket transactions (known as ticket-in, ticket out or TITO) and dispatch of casino employees to a gaming machine, among others. In addition, the operator of the networked gaming machines can collect data from the network at a remote server, also in a secure room, including accounting information that can be compiled into various reports. This enables the operator to collect information such as amounts wagered and paid in awards, to account for cashless ticket transactions, and to track the amount wagered by each player enrolled in a player tracking club.

There are a number of technical problems associated with current systems on such networks. Current systems require a slot machine interface board (SMIB) to be installed in each gaming machine. The SMIB interfaces between the gaming machine and the network and requires its own power supply. The SMIB board is bulky and combined with its power supply takes up a lot of space in the gaming machine cabinet. The SMIB may be a multi-protocol interface that monitors communications between the network and at least one gaming machine. It can communicate, in a variety of protocols if necessary, over the network with hosts, i.e., remote servers, that provide the services and accounting features mentioned above.

Each SMIB is connected to a bank controller, which accumulates information from a plurality of the SMIBs and sends it to the servers in the secure room. Each SMIB also receives information from the servers, such as approvals for electronic fund transfers to and from the gaming machine and cashless ticket transactions, which it then relays to the gaming machine. Like the SMIB, each bank controller has its own power supply. There may be numerous bank controllers in a large casino.

In addition, the current system requires network switches, also each with its own power supply, to direct traffic on the network. As a result of these SMIBs, bank controllers, and network switches, and their respective power supplies, current systems are difficult to install and maintain.

Still another problem with the current systems is that they are proprietary so interfacing with third-party vendors is difficult. For example, if a casino wishes to use a different vendor from the one that provided the integrated suite (accounting, cashless tickets, loyalty, and audit functions), (e.g., to provide a progressive bonus), interfacing another company's product with the network is not easy. Interoperability among systems provided by different manufacturers is difficult, expensive, and often impossible.

One reason for these difficulties relates to the technology used in current systems, which are mostly provided by several large companies that have been using the same technology that was developed in the mid-1990s. A third-party vendor needs access to the network data to provide services such as bonuses, progressive jackpots, dispatch, or any other service. For security reasons, this is typically provided via an application programming interface (API) that accesses a read-only database, which stores data from the network. The system provider controls what data is available in the API database as well as the architecture of the API. If the systems provider changes either of these, a third-party vendor's system that uses the API may be adversely affected.

Many transactions, such as bonus or progressive jackpots awards, must be quickly executed. Data is not able to move quickly enough from the gaming machine, through the SMIB, its associated bank controller, and into the API database for processing by the vendor's system, which then must send a command, such as a jackpot pay, back through the various network components to the gaming machine in a timely fashion.

Reliability is a problem with the prior art systems. If a network connection is broken, the gaming machines downstream of the break are not able to function because ticket validation and electronic funds transfers, which are provided by the network, are not available. What is more, if a server crashes, the entire floor is down, i.e., the gaming machines are unplayable.

The SMIB typically includes a large capacitor to temporarily maintain voltage after a power failure and some ferromagnetic RAM that can store data without power to preserve the accounting and transaction data, which can then be accessed when the power is restored. But power backup and management is problematic because of all the power supplies—for the SMIBs, the bank controllers, and the network switches—that must all be dealt with in a coordinated manner when power is lost.

Because the hardware and its functionality may already be approved by gaming regulators, third-party developers of new software services for EGMs may gain ready approval for features provided by the new services. Put differently, a third-party developer need only gain approval of its software and the services it provides, rather than having to gain regulatory approval for hardware or interfaces with the system. This will enable small or even individual developers to create bonus games or other new services without the need to develop hardware and obtain extensive regulatory approval.

The present system addresses all these technical problems in a highly secure environment and provides additional benefits as will become apparent in the following description and related drawings.

Many casinos encourage player loyalty by tracking the gambling of their patrons and compensating or rewarding frequent gamblers, high-stakes gamblers, gamblers who suffer losses, and other patrons. In order to track play, players participating the loyalty program are enrolled in the loyalty program and assigned a player identifier (e.g., a user identifier). While interacting with an electronic gaming machine (EGM) such as a slot machine, the player may cause the player identifier to be associated with EGM, and thus play can be tracked. The player may do this by inserting a player identifier card into the EGM and/or transferring the player identifier by some other means (e.g., via the internet or NFC communication). Typically, a player leaves the card inserted into the machine until play is completed.

However, in some instances, a player may remove the player identifier from the EGM during the course of play and thus some period of play may not be associated with (e.g., attributed to) the player identifier. In this case, wins and losses are not correctly attributed to the player and thus loyalty program rewards may be improperly rewarded. Further income or loss may not be correctly attributed for tax purposes (e.g., on a win/loss slip given to the player upon ending the gambling session).

Thus, improved methods and systems are required.

### SUMMARY

It is to be understood that both the following general description and the following detailed description are exemplary and explanatory only and are not restrictive. Methods, systems, and apparatus for fraud detection and prevention are described. A player identifier may be sent to, inserted into, or otherwise caused to be associated with an electronic gaming machine (EGM). During play on the EGM, a credit balance may increase or decrease. During play, the player identifier may be removed from or otherwise disassociated with the EGM (and thus disassociated from gameplay thereon). Subsequent play may occur while the game play is disassociated from the player identifier). A second player identifier (e.g, a different player identifier or the same player identifier) may be inserted into or otherwise caused to be associated with the EGM and gameplay occurring thereon. Based on the second player identifier being inserted into or otherwise associated with the EGM, unidentified gameplay occurring after the player identifier was removed and before the player identifier was re-inserted, may be attributed to the initial player identifier.

### BRIEF DESCRIPTION OF THE DRAWINGS

FIG. 1 is a system diagram illustrating various components of a gaming system according to embodiments of the system;

FIG. 2 is a functional block diagram that illustrates an example gaming machine that can be a part of the gaming system shown in FIG. 1;

FIG. 3 is a block diagram of an example bonus controller shown in FIG. 1 according to embodiments of the system;

FIGS. 4A and 4B together show a block diagram of the key components on the bridge shown in FIG. 1 for present embodiments of the system showing the main connections between each of the key components on the bridge;

FIGS. 5A and 5B together depict the microcontroller shown in FIG. 4B, which monitors SAS communications and provides Ethernet switch logic;

FIG. 6 shows the isolation circuit of FIG. 4B;

FIGS. 7A and 7B illustrate the game jacks (and related components) shown in FIG. 4B;

FIG. 8 depicts an Ethernet switch, not shown in FIGS. 4A and 4B, that is used to control signals on the game jacks of FIGS. 7A and 7B.

FIGS. 9A, 9B, and 9C together depict Ethernet switch controllers, not shown in FIGS. 4A and 4B, that are used to control signals on the Ethernet switches shown in FIGS. 8 and 13 for the game jacks (FIGS. 7A and 7B) and the network jacks (FIGS. 10A, 10B, and 11), respectively;

FIGS. 10A, 10B, and 11 depict the network jacks of FIG. 4B;

FIG. 12 depicts serial drivers, not shown in FIGS. 4A and 4B, for LED indicators on the network jacks of FIGS. 10A, 10B, and 11;

FIG. 13 depicts an Ethernet switch, not shown in FIGS. 4A and 4B, that is used to control signals on the network jacks shown in FIGS. 10A, 10B, and 11;

FIGS. 14 and 15 show the connectors for the single board computer shown in FIG. 4A;

FIG. 16 illustrates the tamper detection device shown in FIG. 4A;

FIGS. 17-20 show the components on the gaming machine interface board shown in FIG. 1 for present embodiments of the system;

FIG. 21 is a highly schematic depiction of the architecture of one embodiment of the present system;

FIG. 22A is a functional block diagram that illustrates a gaming device according to embodiments of the invention;

FIG. 22B is an isometric view of the gaming device illustrated in FIG. 22A;

FIG. 23A-23C are detail diagrams of exemplary types of gaming devices;

FIG. 24 is a functional block diagram of networked gaming devices;

FIG. 25 shows a block diagram of an example method;

FIG. 26 shows a block diagram of an example method;

FIGS. 27A-27C show a block diagram of an example method;

FIG. 28 shows a block diagram of an example method;

FIG. 29 shows a block diagram of an example method;

FIG. 30 shows a block diagram of an example method;

FIG. 31 shows a block diagram of an example method; and

FIG. 32 shows a block diagram of an example system.

### DETAILED DESCRIPTION

The present disclosure relates to systems and methods for attributing anonymous bonus game play to identified players on electronic gaming machines. In some cases, the systems and methods enable casinos or other gaming establishments to accurately track and attribute gameplay, including bonus game play, even when a player removes their player identification card during a gaming session. The systems and methods provide technological improvements over conventional player tracking systems by maintaining associations between players and gameplay across interruptions in player identification. In some cases, this enables more accurate accounting, reporting, and player rewards programs. The systems and methods may utilize specialized hardware and software components to monitor gaming machine events, track gameplay across identified and unidentified periods, and properly attribute results to the correct player accounts.

The present disclosure relates to systems and methods for attributing anonymous bonus game play to identified players on electronic gaming machines. The systems and methods provide technological improvements over conventional player tracking systems by maintaining associations between players and gameplay across (and/or despite) interruptions in player identification.

A gaming system may comprise multiple electronic gaming machines (EGMs) connected to a network. Each EGM may be equipped with a player tracking device configured to read player identification cards. The EGMs may be connected to the network through gaming machine interfaces and/or bridge control circuits. A bonus controller may be connected to the bridges to enable communication with the EGMs. The gaming system may include servers and/or databases for collecting and storing gameplay data. A player kiosk may allow players to access account information. Wireless transceivers may enable connection of wireless EGMs or mobile devices to the network. The network may also connect to external systems via the internet.

In operation, a player may insert credits and a player tracking card into an EGM to begin gameplay. The EGM may send data about gameplay events through the network to the servers and databases. The bonus controller may monitor gameplay and trigger bonus awards based on certain conditions. If a player removes their identification card during a bonus game, the system may continue to track gameplay and credit accrual without associating it to a specific player. When the player reinserts their card, the system may attribute the anonymous bonus play to the correct player account.

This system represents a technological improvement over conventional gaming systems by enabling accurate tracking and attribution of gameplay across periods of identified and unidentified play. The system may utilize specialized hardware and software to monitor gaming events, maintain gameplay associations, and properly credit results to player accounts even when player identification is interrupted. This enables more accurate accounting, reporting, and player rewards compared to systems that lose the association between a player and their gameplay when identification is removed.

If a bonus game is triggered during play, the system may continue tracking gameplay even if the player removes their identification card. In some cases, the bonus game may allow play without deducting credits from the player's balance. The system may maintain an association between the anonymous bonus play and the previously identified player.

When the player reinserts their identification card, either during or after the bonus game, the system may attribute the results of the anonymous play to the player's account. This allows for more accurate tracking of wins, losses, and other metrics compared to conventional systems that lose the player association when identification is removed.

The system may utilize high-speed polling to collect extensive data about EGM events beyond basic meter readings. This expanded data set enables more sophisticated analysis of player behavior and more targeted bonus offerings.

In some cases, the system may detect if a player removes their card during regular gameplay and maintain the gameplay association through a subsequent bonus round and card reinsertion. This prevents misattribution of losses or gains that occur during temporarily anonymous periods of play.

The system may provide technological improvements over conventional player tracking systems by maintaining consistent player associations across interruptions in identification. This may enable more accurate accounting, reporting, and player rewards programs compared to systems that reset tracking when player cards are removed. The ability to properly attribute anonymous bonus play may be particularly beneficial for casinos implementing complex, multi-stage bonus games.

By collecting and analyzing a richer set of gameplay data, the system may support more engaging and personalized bonus experiences. The bonus controller may monitor play across multiple machines to implement coordinated bonus events or progressive jackpots with greater precision than traditional isolated bonus systems.

Overall, the system's ability to seamlessly track play across identified and anonymous periods, attribute results accurately, and leverage expanded datasets may represent a significant advancement in gaming floor management technology. This may allow casino operators to implement more sophisticated player retention and rewards strategies while providing players with a more cohesive and rewarding gaming experience.

The present disclosure relates to methods for attributing anonymous bonus play to identified players on electronic gaming machines. These methods provide technological improvements over conventional player tracking systems by maintaining associations between players and gameplay across interruptions in player identification.

In some cases, a gaming system may monitor electronic gaming machines (EGMs) for gameplay events. The system may detect when a player inserts an identification card to begin an identified gaming session. Gameplay data and events may be associated with the player's account during this period.

If a bonus game is triggered, the system may continue tracking gameplay even if the player removes their identification card. The bonus game may allow play without deducting credits from the player's balance in some implementations. An association may be maintained between the anonymous bonus play and the previously identified player.

When the player reinserts their identification card, either during or after the bonus game, the system may attribute the results of the anonymous play to the player's account. This may enable more accurate tracking of wins, losses, and other metrics compared to conventional systems that lose the player association when identification is removed.

In some cases, the system may utilize high-speed polling to collect extensive data about EGM events beyond basic meter readings. This expanded data set allows for more sophisticated analysis of player behavior and more targeted bonus offerings.

The system may detect if a player removes their card during regular gameplay and maintain the gameplay association through a subsequent bonus round and card reinsertion. This prevents misattribution of losses or gains that occur during temporarily anonymous periods of play.

A method for attributing anonymous bonus play may comprise, detecting a card-in event with a player identifier, monitoring gameplay events, detecting a bonus game trigger, detecting a card-out event during the bonus game, continuing to track bonus game play anonymously, detecting a subsequent card-in event, and attributing the anonymous bonus play results to the player identifier. In some implementations, the method may involve maintaining the player identifier in temporary storage after the card-out event. The change in credit meter value during anonymous bonus play may be determined. When the subsequent card-in event occurs, the credit meter change may be associated with the original player identifier, even if a different identifier is used for the card-in.

The method may comprise tracking bonus game play by determining credits added without corresponding deductions from the credit meter. In some cases, an initial balance associated with the player identifier may be recorded at the time of the card-out event. A final balance may be determined when the bonus game ends or the subsequent card-in occurs. The difference between initial and final balances may be attributed to the player identifier.

In some implementations, the method may involve monitoring an event stream from the EGM. The event stream may contain detailed gameplay data beyond standard accounting information. The method may detect card-in, bonus game, card-out, and game result events within this expanded data set.

The method may maintain associations between players and gameplay by utilizing non-volatile memory to preserve transaction data across power loss events. In some cases, cryptographic techniques may be employed to ensure data integrity and prevent tampering with stored associations.

These methods represent a one or more technological advancements in player tracking and game management including but not limited to: maintaining player associations across identification interruptions enables more accurate accounting and rewards programs, proper attribution of anonymous bonus play supports implementation of complex, multi-stage bonus games without compromising tracking accuracy, high-speed polling and expanded data collection enable more sophisticated player behavior analysis and personalized gaming experiences, seamless tracking across identified and anonymous play periods provides a more cohesive player experience while supporting precise floor management, and/or enhanced data integrity and security measures protect the accuracy of gameplay attributions in various operational scenarios. By overcoming limitations in conventional systems that reset tracking when player cards are removed, these methods enable casino operators to implement more sophisticated player retention strategies and bonus schemes. The ability to maintain consistent player associations across different game states and identification scenarios represents a significant advancement in gaming technology.

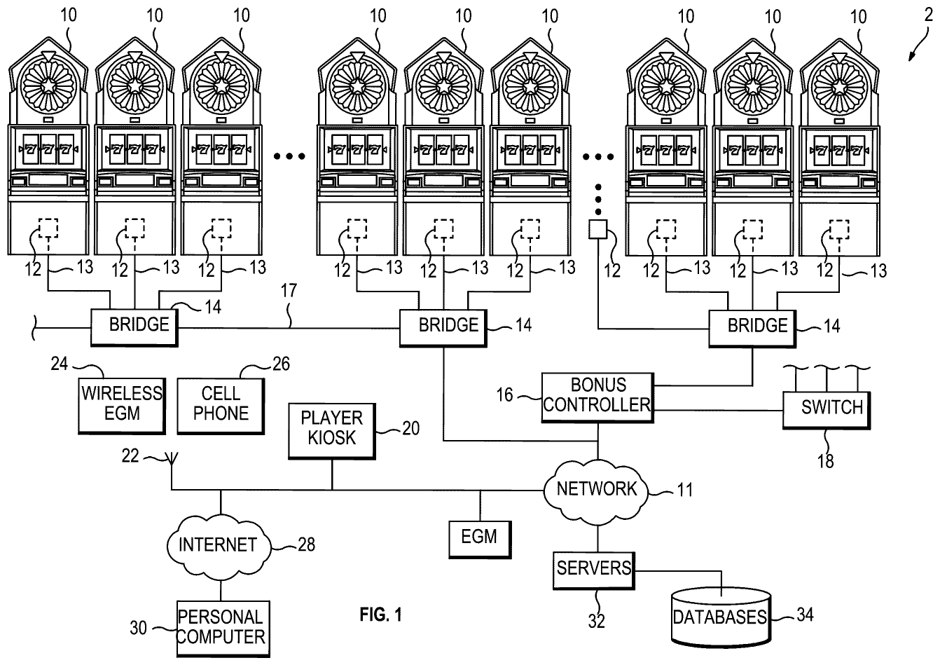

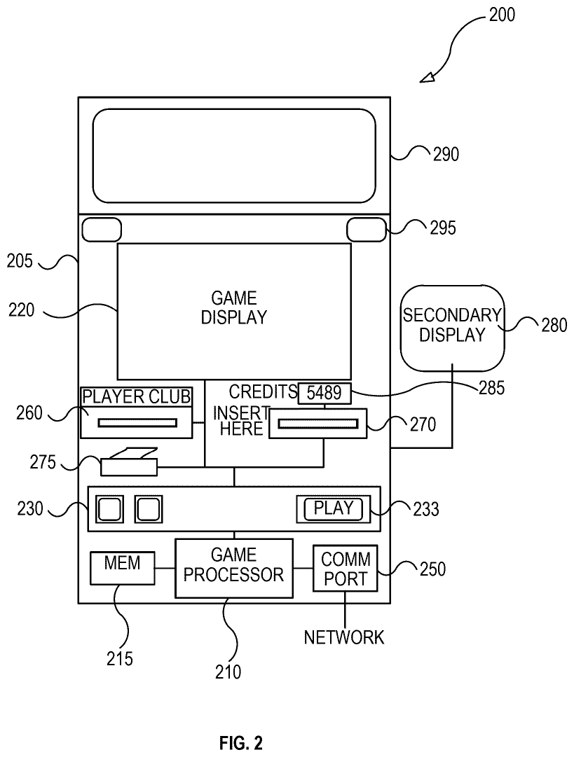

FIG. 1 is a system diagram illustrating various components of a gaming system. The gaming system 2 includes several electronic gaming machines (EGMs) 10, similar to EGM 200 in FIG. 2, that are each ultimately connected to a network 11. Each of the EGMs 10 of FIG. 1 connect to the network 11 (which may be a wireless network, a wired network, the Internet, an Ethernet network, combinations thereof, and the like\) through first, a gaming machine interface (GMI) 12 and then a bridge control circuit (bridge) 14. As can be seen, each GMI 12 is further connected to a bridge 14, each bridge configured to accommodate one or more GMI connections, via their respective cables 13. In the present embodiments, up to 8 EGMs may be connected to each bridge. It should be appreciated that the number of connections is merely a matter of design, and more or less could be connected. For example, a single bridge may accommodate up to 64 EGMs, which would enable a single bridge to serve all of the machines in most all slot machines banks. It should be noted that not all of the jacks must be used. In other words, fewer than 8 GMIs (or whatever the maximum number is) can be connected to each bridge. The dots adjacent the groups of EGMs in FIG. 1 signify additional EGMs each with a corresponding GMI connected to a bridge, but to simplify the drawing only 3 machines in each group are depicted. A bridge box may be contained in the cabinet of one of the EGMs, in a base that supports an EGM, or in another suitable location.

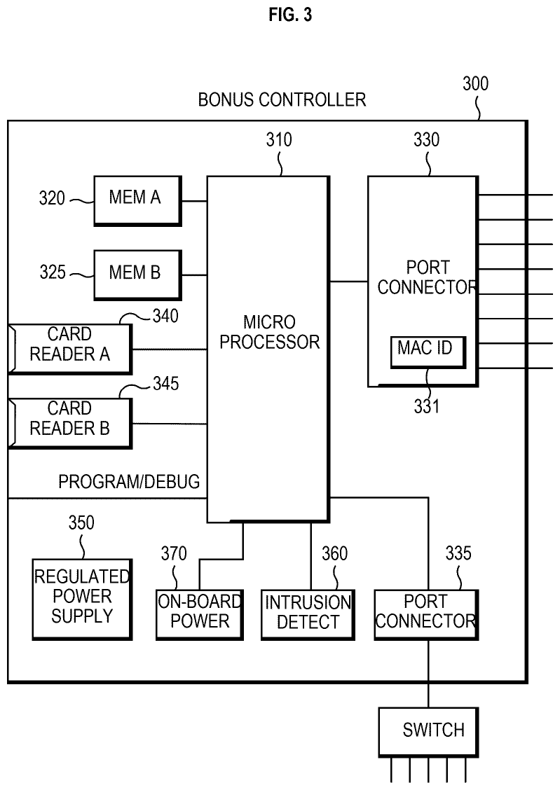

A conventional bonus controller 16 may be connected directly to some of the bridges 14 and may communicate over the network to any of the EGMs so connected in the network. Note that the bridges may communicate via an Ethernet protocol through the bonus controller or may bypass the bonus controller as shown for bridge 14 in the middle group of EGMs in FIG. 1. In addition, bridges 14 can be connected in a daisy chain configuration, as shown via Ethernet link 17 in FIG. 1. The links need not necessarily be Ethernet and the present disclosure contemplates wireless communications as well. The bonus controller 16 generally communicates through a non-SAS protocol, such as another well-known communication protocol known as Gaming Standards Association (GSA). GSA is typically carried over an Ethernet network, and thus the bonus controller 16 includes an Ethernet transceiver, which is described with reference to FIG. 3 below. Because the bonus controller 16 communication may be Ethernet based, a switch 18 may be used to extend the number of EGMs that may be coupled to the bonus controller 16. The bonus controller 16 and/or the bridge 14 may create or convert data or information received according to a particular protocol, such as SAS, into data or information according to another protocol, such as GSA. In this way the bridge 14 and bonus controller 16 are equipped to communicate, seamlessly, between any EGM 10 and network 11 no matter which communication protocols are in use. Further, because the bridge 14 and bonus controller 16 are programmable, and include multiple extensible communication methods, as described below, they are capable of communicating with EGMs 10 that will communicate using protocols and communication methods developed in the future. The functions implemented by any of the controllers or processors mentioned herein might be distributed among a plurality of controllers or processors.

Other games or devices on which games may be played are connected to the gaming network using other connection and/or communication methods. For instance, a player kiosk 20 may be directly coupled to the gaming network. The player kiosk 20 allows players, managers, or other personnel to access data on the network 11, such as a player tracking record, and/or to perform other functions using the network. For example, a player may be able to check the current holdings of the player account, transfer balances, redeem player points for credits, cash, or other merchandise or coupons, such as food or travel coupons, for instance.

A wireless transceiver 22 may couple the network 11 to a wireless EGM 24, such as a handheld device, or, through a cell phone or other compatible data network, the transceiver 22 may connect to a cellular phone 26. The cellular phone 26 may be a “smart phone,” which in essence is a handheld computer (e.g., mobile computing device) capable of playing games or performing other functions.

The network 11 also couples to the Internet 28, which in turn is coupled to a number of computers, such as the personal computer 30. The personal computer 30 may be used much like the kiosk 14, described above, to manage player tracking or other data kept on the network 11. More likely, though, is that the personal computer 30 is used to play actual games in communication with the network 11. Player data related to games and other functions performed on the personal computer 30 may be tracked as if the player were playing on an EGM 10.

In general, in operation, a player applies a starting credit into one of the EGMs, such as an EGM 10. For example, the EGM 10 sends data through its SAS or other data communication port through the GMI 12 and associated bridge 14 to the network 11. Various servers 32 and databases 34 collect historical accounting information about the gameplay on the EGMs 10, such as wagers made jackpots won, gambling patterns, other historical gaming data, combinations thereof, and the like, for example. And, as will be described in more detail, the various servers 32 and databases 34 may continue to provide some services for the EGMs while the present embodiments take over others of the services. As will also be described in more detail, this feature permits any of the services offered by a legacy system, including bonus controller 16, to be taken over by the present system.

In addition, each EGM 10 may accept information from systems external to the EGM itself to cause the EGM 10 to perform other functions. For example, these external systems may cause the EGM 10 to issue additional credits to the player. In another example, a promotional server may cause the EGM 10 to print a promotional coupon on the ticket printer of the EGM.

The bonus controller 16 is configured to perform some of the above-described functions as well. For example, in addition to standard games on the EGM 10, the bonus controller 16 is configured to drive the EGM 10 to pay bonus awards to the player based on any of the factors, or combination of factors, related to the EGM 10, the player playing the EGM 10, particular game outcomes of the game being played, or other factors.

In this manner, the combination of the bonus controller 16 and bridges 14 are a sub-system capable of interfacing with each of the EGMs on a network 11. As a result, each bridge 14 may gather data about the game, gameplay, or player, or other data on the EGM 10, and forward it to the bonus controller 16. The bonus controller 16 may use such collected data as input and, when certain conditions are met, send information and/or data to the EGM 10 to cause it to perform certain functions.

In a more detailed example, suppose a player is playing an EGM 10 coupled to the bridge 14 and the bonus controller 16 described above. The player inserts a player tracking card so the EGM or any other devices connected to the network 11 may determine the player identity. The bridge 14 may be configured to store such identifying information. The bridge may pass such information to bonus controller 16, which may be configured to provide a welcome-back bonus to any level-2 player after he or she has played two games. Gameplay on the EGM 10 may continue and, after the player plays two games, bonus controller 16 may cause EGM 10 to add an additional 40 credits to EGM 10 as the welcome-back bonus. Such monitoring and control of EGM 10 can occur in conjunction with, but completely separate from any player tracking or bonusing function that is already present on the network 11. In other words, the bonus controller 16 may be configured to provide a time-based bonus of 10 credits for every hour played by the player of the EGM 10. The above-described welcome-back bonus may be managed completely separately through the bonus controller 16 and bridge 14. Further, all of the actions on the EGM 10 caused by the bonus controller 16 may be communicated to the standard accounting, tracking, and other systems already present on the network 11. Additionally and/or alternatively, the welcome-back bonus described above may be implemented on servers 32 along with other functions.

With reference back to FIG. 1, the bonus controller 16 may couple to each of the bridges 14, and by extension to their coupled EGMs to cause data and commands to be sent to the EGMs to control functions on each EGM. FIG. 3 is a detailed block diagram of such a bonus controller.

Consideration will now be given to the structure and operation of bonus controller 16 before providing a general overview of the operation of system 2. A bonus controller 300 of FIG. 3 may be an embodiment of the bonus controller 16 illustrated in FIG. 1. The bonus controller 300 may comprise a microprocessor 310. For example, the microprocessor 310 may be an Atmel AT91SAM9G20. The microprocessor 310 may be coupled to one or more memory systems 320, 325. As a non-limiting example, the memory system 320 may be a 2 Megabyte FRAM while memory system 325 may be a 64 Megabyte Synchronous DRAM (SDRAM). 20Of course, the sizes and types of memory included in any bonus controller may be determined to suit a particular implementation. For example, the memory may be computer readable media in the form of volatile memory, such as random access memory (RAM), and/or non-volatile memory, such as read only memory (ROM).

The microprocessor 310 may couple to one or more card readers, 340, 345, which may be configured to accept easily replaceable, portable memory cards. Each card reader of the one or more card readers may further include Electro-Static Discharge (ESD) devices configured to prevent damage to internal circuitry, such as the microprocessor 310, when cards are inserted or removed from the card readers 340, 345. In practice, a card in one of the card readers 340, 345 may store program code for the microprocessor 310 while a card in the other reader may store data for use by the bonus controller 300. Alternatively, a single card in either of the card readers 340, 345 may store both program and data information.

A port connector 330 includes multiple communication ports for communicating with other devices. The communication processor of each bridge 14 may couple to a connected bonus controller through such a communication port. The communication port 330 may be, but is not necessarily an Ethernet interface, as described above, and may comprise a MAC address 331. The port connector 330 may comprise multiple separate connectors, such as eight, each of which connect to a single bridge 14 (FIG. 1), which in turn may connect to up to eight separate EGMs 10. Thus, a single bonus controller 300 may couple to sixty-four separate EGMs by connecting through appropriately connected bridges.

Further, a second port connector 335 may be included in the bonus controller 300. The second port connector may also be, but is not necessarily, an Ethernet connector. The second port connector 335 may be configured to allow additional connectivity to the bonus controller 300. The second port connector 335 may couple to another bonus controller 300 or to other server devices, such as the server 60 on the network 11 of FIG. 1. The second port connector 335 may additionally be coupled to a SMIB, thus providing the bonus controller 300 with the ability to directly connect to nine SMIBs.

Ethernet connections are easily replicated with a switch, external to the bonus controller 300 itself, which may be used to greatly expand the number of devices to which the bonus controller 300 may connect.

Systems to protect the integrity of the bonus controller 300 are included. For example, an intrusion detection circuit 360 may be configured to signal the processor 310 if a cabinet or housing that contains the bonus controller 300 is breached, even if no power is supplied to the bonus controller 300. The intrusion detection circuit may comprise a magnetic switch that closes (or opens) when a breach occurs. The microprocessor 310 may generate a signal that may be detected by one or more devices connected to the network 11. The signal may indicate that a breach occurred and may cause an appropriate response. An on-board power circuit 370 may provide power to the bonus controller 300 for a relatively long time, such as a day or more, so that any data generated by the processor 310 is preserved and so that the processor 310 may continue to function, even when no external power is supplied. The on-board power circuit 370 may comprise an energy-storing material such as a battery or a capacitor.

Similarly to the microprocessor processor 260 of the SAS processor 210 described above, the microprocessor 310 of the bonus controller 300 may be coupled to a program/debug port for programming the microprocessor 310. For example, program and/or other data for the microprocessor may be updated through the program/debug port.

In operation the bonus controller 300 may configure and control bonus features on gaming machines through network 11 or through other communication systems. Bonus features may be implemented through each gaming machine's internal structure and capabilities, and may include integration with additional peripheral devices (e.g., mobile computing devices such as smart phones). Bonusing programs for the connected games may be introduced to the bonus controller 300 by updating data stored in the memory systems directly on the bonus controller, or by inserting new memory cards in one or more of the card readers 340, 345. Such a platform provides a way for game developers, even third-party developers, to define and program new types of bonus games that may be used in conjunction with existing EGMs on existing gaming networks, or on new games and new networks as they are developed.

The bonus controller 300 represents a technological improvement over conventional systems by providing a flexible, updateable platform for implementing and managing complex bonus schemes across multiple gaming machines. The combination of local processing power, expandable storage, robust networking capabilities, and security features enables more engaging and personalized bonus experiences compared to fixed bonus programs built into individual gaming machines. The bonus controller 300's ability to continuously monitor gameplay across multiple machines allows for more sophisticated bonus triggers and coordinated bonus events spanning multiple devices.

Before providing an overview of embodiments of the system disclosed herein, consideration will first be given to an electronic gaming machine.

FIG. 2 is a functional block diagram that illustrates an example electronic gaming machine (EGM) 200. The system may comprise one or more EGMs. The one or more EGMs may comprise one or more types of electronic gaming machines, such as physical reel slot machines, video slot machines, video poker gaming machines, video blackjack machines, keno games, and any other type of devices may be used to wager monetary-based credits on a game of chance.

The illustrated gaming machine 200 may comprise a cabinet 205 configured to house various parts of the gaming machine 200, thereby allowing certain components to remain securely isolated from player interference, while providing access to player input/output devices so that the player may interact with the gaming machine 200. The securely housed components may comprise a game processor 210, memory 215, and connection port 250. The game processor 210, depending on the type of gaming machine 200, may completely or partially control the operation of the gaming machine. For example, if the gaming machine 200 is a standalone gaming machine, game processor 210 may control virtually all the operations of the gaming machine and attached equipment. In other configurations, the game processor 210 may implement instructions generated by or communicated from a remote server or another controller. For example, the game processor 210 may be responsible for running a base game of the gaming machine 200 and executing instructions received over the network from a bonus server or player tracking server. In a server-based gaming environment, the game processor 210 may simply act as a terminal to perform instructions from a remote server that is running game play on the gaming machine 200. The functions implemented by the processor might also be distributed among several processors.

The memory 215 is connected to the game processor 210 and may be configured to store game information about gameplay or player interactions with the gaming machine 200. This memory may be volatile (e.g., RAM), non-volatile (e.g., flash memory), or include both types of memory. The connection port 250 is also connected to the game processor 210. This connection port 250 typically connects the gaming machine 200 to a gaming network (e.g.,, the network 211). The connection port 250 may be configured as a serial port, parallel port, Ethernet port, optical connection, wireless antenna, or any other type of communication port used to transmit and receive data. Although only one connection port 250 is shown in FIG. 2, the gaming machine 200 may include multiple connection ports. Virtually all gaming machines, however, permit transfers of cash or promotional credits between the slot accounting system and the machine via a single designated port. As described above, in many existing gaming machines, this connection port 250 is a serial connection port utilizing a SAS protocol to communicate with one or more remote game servers, such as player tracking servers, bonus servers, accounting servers, etc.

The player input/output devices housed by the gaming cabinet 205 further include a bill/ticket reader 270, a credit meter 285, and one or more game speakers 295. Various gaming machines may include fewer or more input/output devices (e.g., a game handle, a coin acceptor, a coin hopper, etc.) depending upon the configuration of the gaming machine.

The gaming machine 200 may comprise a gaming display 220. The gaming display 220 may comprise one or more mechanical spinning reels, a video display, combinations thereof, and the like. The gaming display may be configured to display aspects of the gameplay to the player. The gaming display 220 may comprise a touchscreen configured to receive one or more user inputs. For example, if the gaming display 220 is a video display, the gaming display may include a touch screen to further allow the player to interact with game indicia, soft buttons, or other displayed objects. The gaming machine 200 may comprise a button panel 230. The button panel 230 may be configured to allow the player to select and place wagers on the game of chance, as well as allow the player to control other aspects of gaming. For example, some gaming machines allow the player to press one of buttons 233 to signal that he or she requires player assistance. Other buttons may bring up a help menu and/or game information. The buttons 233 may also be used to play bonuses or make selections during bonus rounds.

The gaming machine may comprise one or more ticket printers 275. The one or more ticket printers 275 may be configured to print one or more tickets. For example, as discussed in greater detail herein, the one or more ticket printers 275 may be configured to print one or more tip tickets and/or one or more enhanced value tickets. The tickets can typically be redeemed for cash at a cashier cage or kiosk. The one or more ticket printers 275 may be configured to connect to the game processor and/or to a remote server, such as a TITO server to accomplish its intended purpose. In gaming machines that have more than one peripheral device, and which include only a single SAS port, the peripheral devices all share communication time over the connection port 250.

The gaming machine 200 may comprise a player club interface device 260. The player club interface device 260 may include a reader device and one or more input mechanisms. The card reader device is configured to read an object or indicia identifying the player. The identifying object may be a player club card issued by the casino to a player that includes player information encoded on the card. Once the player is identified by a gaming machine, the player club interface device 260 communicates with a remote player server (e.g., player club server) through the connection port 250 to associate a player account with the gaming machine 200. This allows various information regarding the player to be communicated between the gaming machine 200 and the player server, such as amounts wagered, credits won, rate of play, gambling habits, combinations thereof, and the like. In other embodiments, the card reader may read other identifying cards (such as driver licenses, credit cards, etc.) to identify a player. Although FIG. 2 shows the reader as a card reader, other embodiments may include a reader having a biometric scanner, PIN code acceptor, QR code scanner, or other methods of identifying a player to pair the player with their player tracking account.

Other input/output devices of the gaming machine 200 include may a credit meter 285, a bill/ticket acceptor 270, and speakers 295. The credit meter 285 may be configured to indicate a total number of credits remaining on the gaming machine 200 that are eligible to be wagered. The credit meter 285 may be configured to indicate a number of credits eligible to transfer to another player or transfer to an attendant as a tip. The credit meter 285 may reflect a monetary unit, such as dollars, or an amount of credits. The bill/ticket acceptor 270 may be configured to recognize and/or validate currency (e.g., paper bills) and/or printed tickets and may be configured to cause the game processor 210 to display a corresponding amount on the credit meter 285. The speakers 295 may be configured to play auditory signals in response to game play and/or may be configured to play enticing sounds while in an “attract-mode,” when a player is not at the gaming machine. The auditory signals may also convey information about the game, such as by playing a particularly festive sound when a large award is won. The auditory signals and/or any visual outputs may be associated with one or more paytables and or one or more payback variances. For example, the one or more auditory signals or visual outputs may be varied (e.g., adjusted) based on a payback variance associated with the gaming machine. For example, the attract mode may be enhanced when the machine has not been played and a variance with a predetermined payback percentage exists.

The player may initially insert monetary bills or previously printed tickets with a credit value into the bill acceptor 270. The player may also put coins into a coin acceptor (not shown) or a credit, debit, or casino account card into a card reader/authorizer (not shown). In other embodiments, stored player points or special ‘bonus points’ awarded to the player or accumulated and/or stored in a player account may be able to be substituted at or transferred to the gaming machine 200 for credits or other value. For example, a player may convert stored loyalty points to credits or transfer funds from his bank account, credit card, casino account or other source of funding. The selected source of funding may be selected by the player at time of transfer, determined by the casino at the time of transfer or occur automatically according to a predefined selection process.

The gaming machine 200 may comprise various other devices to interact with players, such as light configurations, top box display 290, and secondary display 280. The top box display 290 may include illuminated artwork to announce a game style, a video display (such as an LCD), a mechanical and/or electrical bonus display (such as a wheel), or other known top box devices. The secondary display 280 may be a vacuum fluorescent display (VFD), a liquid crystal display (LCD), a cathode ray tube (CRT), a plasma screen, or the like. The secondary display 280 may be configured to display any combination of primary game information and ancillary information. For example, the secondary display 280 may show player tracking information, secondary bonus information, advertisements, or player selectable game options. The secondary display may be attached to the game cabinet 205 or may be located near the gaming machine 200. The secondary display 280 may also be a display that is associated with multiple gaming machines 200, such as a bank-wide bonus meter, or a common display for linked gaming machines.

In operation, typical play on a gaming machine 200 commences with a player placing a wager on a game to generate a game outcome. The wager may comprise one or more credits and/or currency. In some games, a player need not interact with the game after placing the wager and initiating the game, while in other games, the player may be prompted to interact with the gaming machine 200 during game play. Interaction between the player and the gaming machine 200 is more common during bonuses, but may occur as part of the game, such as with video poker. Play may continue on the gaming machine 200 until a player decides to cash out or until insufficient credits remain on the credit meter 285 to place a minimum wager for the gaming machine.

This gaming machine 200 represents a technological improvement over conventional gaming devices by integrating player tracking, bonus capabilities, cashless wagering, and network connectivity into a single unit. The combination of identification devices, networked communications, and configurable displays enables more engaging gameplay experiences and personalized bonusing compared to traditional mechanical slot machines. The ability to seamlessly transition between identified and anonymous play while maintaining gameplay associations allows for more accurate player tracking and rewards programs.

Before going into detail about the structure and operation of bridge 14 and gaming machine interface 12—as well as a detailed description of the overall operation of system 2—consideration will first be given to a high-level view of the operation of system 2. As mentioned above, prior art systems for providing services to and management functions for networked gaming machines suffer from a number of problems. One of the ways system 2 addresses these problems is by providing the services, such as TITO, dispatch, bonuses, etc. from the bridge circuit as opposed to a server in a secure IT room.

TITO services are described in U.S. Pat. Nos. 5,265,874; 5,290,033; 6,048,269; and 6,729,957, all of which are incorporated herein by reference. Dispatch services are described in U.S. Patent Application Publication 2017/0186270, which is also incorporated herein by reference.

As will be discussed in detail, each bridge circuit has a SAS processor and a network processor. The SAS processor handles SAS communications, which is a commonly used protocol for communicating via a gaming machine port. The network processor handles communication between and among the bridges, the bonus controller—and any other devices connected to network 11—and ultimately to the servers 32 and databases 34. When all services, such as TITO, dispatch, bonuses, etc., are implemented by processes on bridge 14, servers 32 may function only to collect and store (in databases 34) historical data sent from flash memory in each bridge. This is in contrast to prior art systems in which the processes that provide various services to the EGMs are located on the servers in a secure room.

The SAS processor in bridge 14 may be configured to communicate with a SAS port on the EGM to which it is connected via GMI 12. The GMI 12 may be configured to convert signals from the SAS port of the EGM to the commonly used RS232 standard for two-way serial communication over a USB connection to bridge 14. The bridges, bonus controller, switches, (e.g., switch 18 in FIG. 1), and all the other devices, including servers 32, may communicate with one another via the Ethernet protocol or a wireless protocol. The bridge includes a network processor that may be configured to communicate with both the SAS processor in the bridge, via USB, and with network 11, via Ethernet, to relay information to and from the SAS processor.

In operation, bridge 14 conducts high-speed polling to retrieve data that appears at the EGM SAS port. Unlike prior art systems, which typically poll only for EGM meter readings, bridge 14 requests and receives extensive information related to any activity on the EGM. For example, each actuation of a button on the EGM and each reel stop during play of a game are collected, each with its own time stamp. The collected data may be stored in a memory in bridge 14, and may also be sent to flash memory in each of two additional bridges, which functions as a backup system. One manner in which the collected data can be used is described in applicant's U.S. Pat. No. 10,553,072 issued on Feb. 4, 2020, invented by John Acres, which patent is incorporated herein by reference for all purposes.

Computer programs that provide the various services, such as TITO cashless tickets, progressive jackpots, player tracking, and other services may be executed on the SAS processor or on network processor 42. Although all required services may be run by the bridge, if a legacy system that includes a suite of programs to provide services remains in place, selected services can be run on the bridge while letting other of the services continue to be run by the legacy system. This permits the present system to take over services provided by one or more other vendor systems one at a time, if that is desired. Ultimately, the bridge can take over all management and EGM services.

The bridge 14 may comprise a robust power management system. For example, the bridge 14 may comprise one or more large capacitors that provide several functions. For example, in the event of a brownout, a power failure that lasts less than about 30 seconds, all power to bridge 14 and GMI 12 may be supplied from the capacitors. As a result, no functionality is lost during the brownout. For example, in the event of a longer outage, data for transactions in process may be stored, and when power is resumed the transaction may be completed. For example, the SAS processor can run for as many as three days in the event power is lost. This enables the processor to continue to monitor 14tampering during a prolonged power outage. For example, if cable 13, which connects bridge 14 with one of its associated GMIs 12, is unplugged, GMI 12 may be supplied with power via a capacitor configured to permit an orderly shutdown of GMI 12 to preserve data in a current transaction.

The software programs in the bridge may have high-speed access to data as soon as it is stored in the flash memory. The software programs may be provided by the owner of the hardware system described herein or by third parties.

Data may be rapidly moved upstream from the flash memory to a repository managed by a server where specialized software captures, indexes, and correlates real-time, machine-generated data. Software sockets may be used to monitor specific data in the repository. As a result, the repository can be used by third parties, each of whom are granted secure access, to implement any of the services that might be required on the casino floor, including bonus games, progressive jackpots, TITO services, accounting and reports, etc. For example, the present system can provide data in the repository within a typical range of about 50-150 milliseconds from the time the event occurs on the gaming machine. This contrasts with prior art systems that provide data, but not all of the data, to a database where the lag time from the event on the machine to appearance in the database is typically in the range of 1-3 seconds. This delay prevents or impairs implementing robust services using the prior art systems.

Security is maintained via a novel system of manufacturing and venue certificates and tokens as well as a tamper-proof feature for each bridge box.

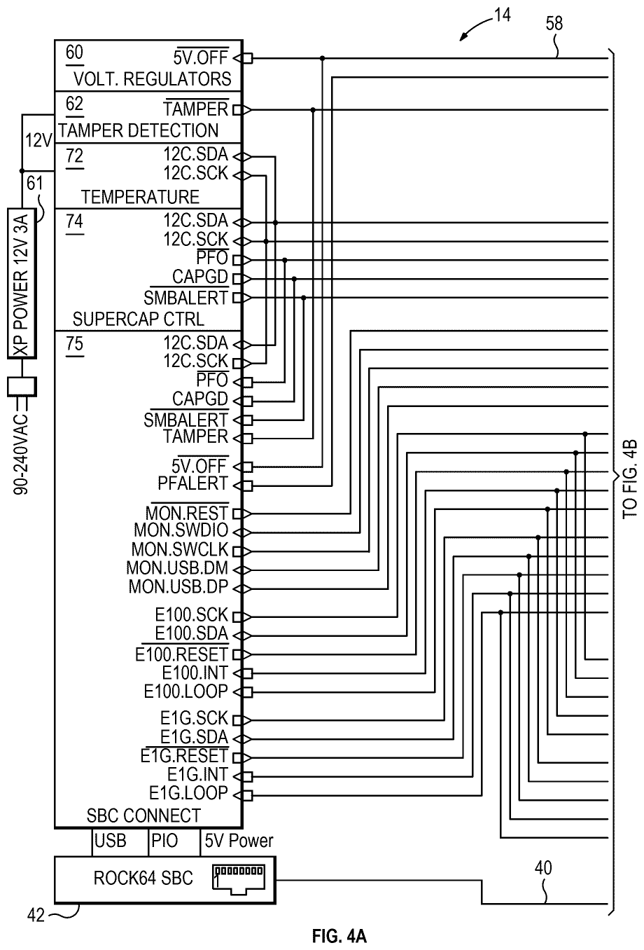

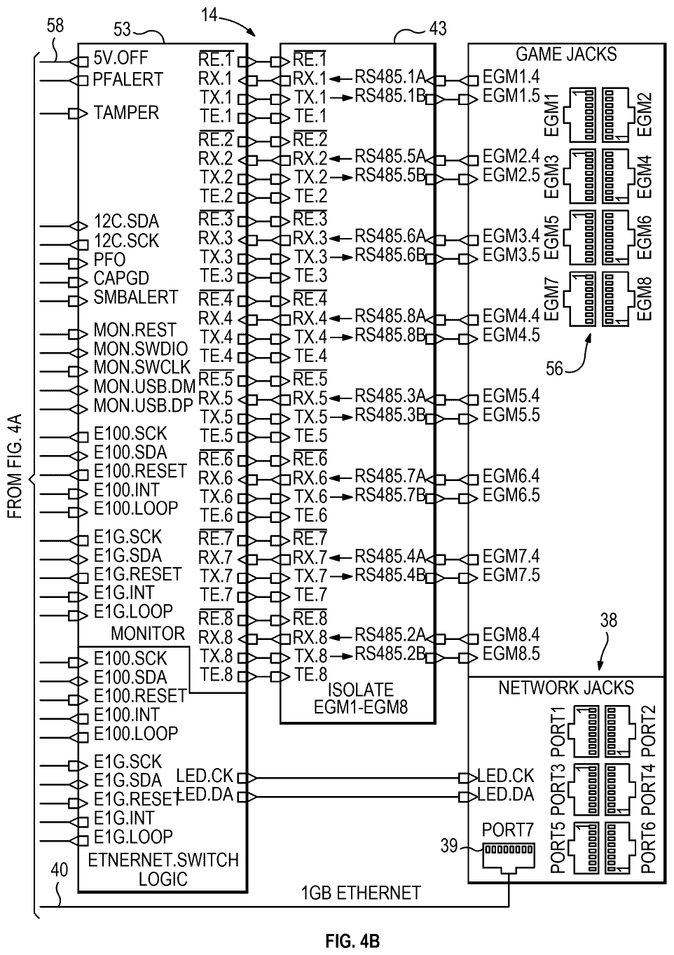

Consideration will now be given to the bridge hardware devices and how they are connected to one another. In FIGS. 4A and 4B, a block diagram illustrates the various components and functionalities provided by the bridge 14. Additional detail will be provided in later description and drawings for some of these, which are shown only generally in the FIG. 4 overview.

Bridge circuit 14 in FIG. 4B may comprise one or more game jacks (e.g., 8 game jacks), indicated generally at 36 in FIG. 4B. Each of the game jacks may comprise a receptacle for an RJ45 jack. Cable 13 (in FIG. 1), which is not shown in FIGS. 4A and 4B, connects each GMI 12 to its associated bridge 14 via RJ45 plugs on either end of the cable. Each GMI 12 is in turn connected to a SAS port on its associated EGM as will be later described in more detail. Each game jacks of the one or more game jacks 36 may comprise one or more pins configured to accommodate RS245 serial communications as well as pins to accommodate 100 MB Ethernet communications between GMI 13 and bridge 14.

Security features may be incorporated into the bridge circuit 14. A tamper detection circuit may alert the system if the bridge enclosure is breached. Cryptographic key management may ensure secure communications and prevent unauthorized access. The bridge circuit 14 represents a technological improvement over conventional gaming network interfaces in several ways. The integration of SAS and Ethernet communications in a single device simplifies network architecture and reduces points of failure. The robust power management and security features enhances system reliability and data integrity. The ability to handle high-speed polling and extensive data collection from gaming machines enables more sophisticated analysis and real-time responsiveness compared to traditional systems that only poll for limited meter readings.

This GMI 13 represents a technological improvement over conventional systems in several ways. The ability to intercept and replicate SAS communications may allow for more seamless integration of new services and features without disrupting existing legacy systems. The use of non-volatile memory enhances data integrity by preserving transaction information even during power loss events. Additionally, the expansion port provides flexibility for adding new capabilities to gaming machines without requiring extensive hardware modifications. The GMI 13's role in high-speed polling and extensive data collection from gaming machines may enable more sophisticated analysis and real-time responsiveness compared to traditional systems that only poll for limited meter readings. This enhanced data collection capability may support more advanced player tracking, bonusing, and analytics features. By serving as an intermediary between individual gaming machines, legacy systems, and newer network components, the GMI 13 facilitates a migration path for casinos looking to upgrade their systems. This enables improvements and feature additions without necessitating a complete overhaul of existing infrastructure.

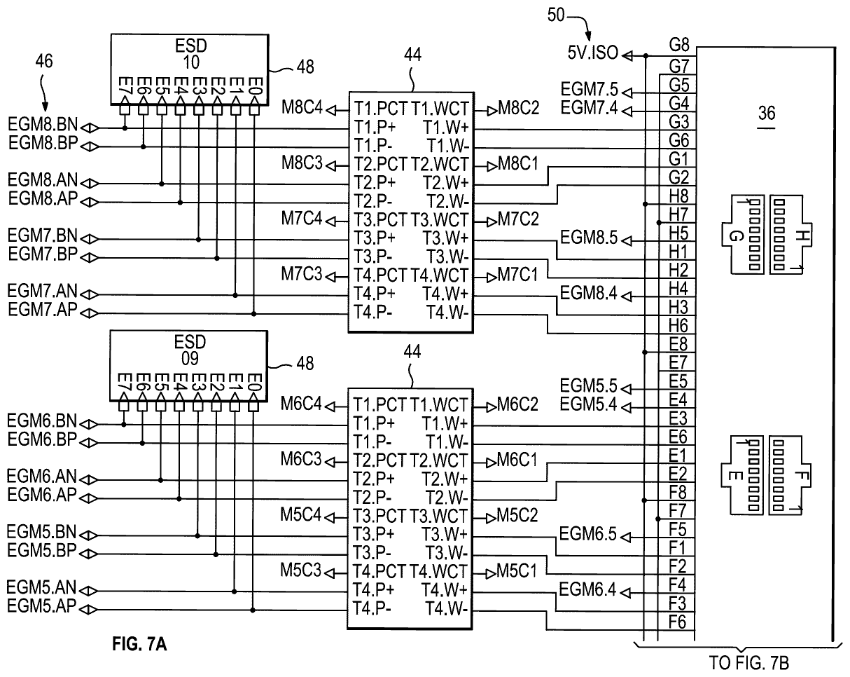

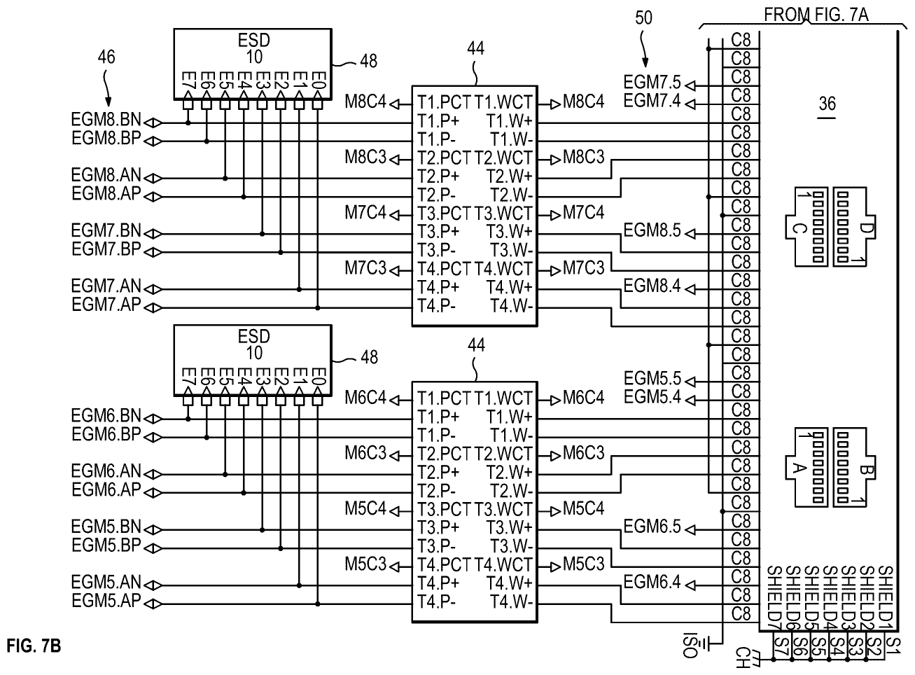

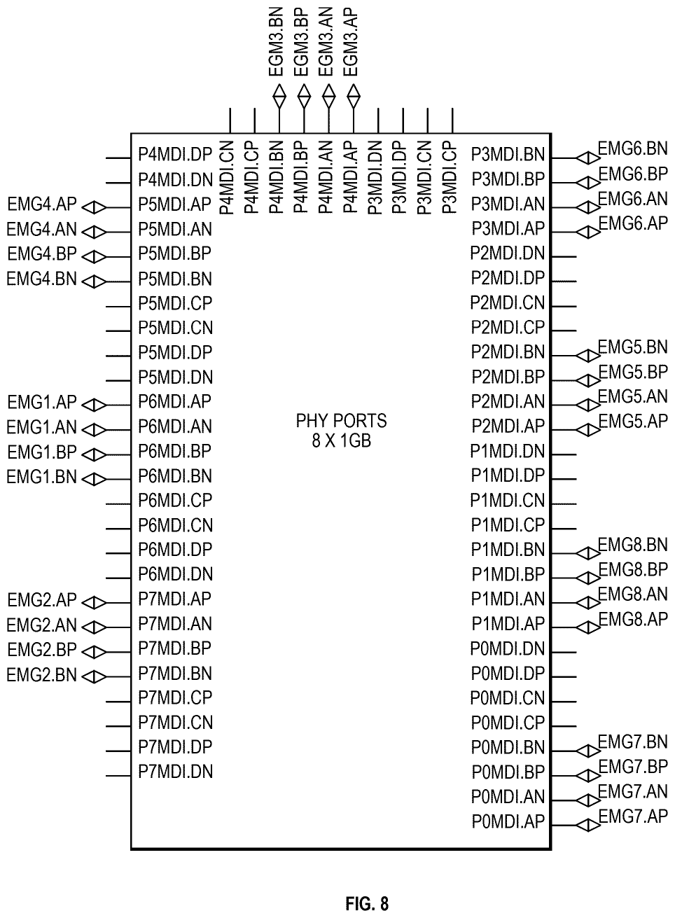

Considering the one or more game jacks 36 in more detail, attention is directed to FIGS. 7A and 7B. As shown in the figures, each game jack of the one or more game jacks 36 is connected to an Ethernet transformer 44, each transformer handling communications to and from two EGMs. The Ethernet 100 MB signal lines for each EGM are shown generally at 46 and are available for expansion of services to the EGM. Electrostatic discharge protection for Ethernet signal lines 46 is provided by components 48. Each game jack of the one or more game jacks 36 may comprise one or more signal lines indicated generally at 50 configured to accommodate the RS245 signals from the GMI that the one or more game jacks are connected to. The one or more signal lines may be configured to carry SAS data from the EGM. Each EGM has 2 signal lines, (e.g., EGM36 in FIG. 7B has lines labeled EGM8.5 and EGM8.4 to indicate the third of eight potential EGM connections to bridge 14), with the connections being on pins 4 and 5 of each jack. Each of the other 7 EGM connections are similarly labeled. Each of the EGM RS245 signal lines is connected to a galvanic isolation circuit 43 in FIG. 4B and each line bears the same label in FIG. 4B as in FIGS. 7A and 7B.

The one or more network jacks 38, are used to connect the bridge to network 11. The one or more network jacks may be configured to connect the bridge 14 to the network 11 via one or more Ethernet connection. In addition, there is a jack 39 in FIG. 4B that is one end of a connection that is internal to bridge 14, which will be shortly described. The one or more network jacks 38 may be used in a variety of ways. For example, two of the network jacks may be connected to the network to provide redundancy in the event that communication over one of the connections (e.g., a network jack of the two network jacks) is impaired. One network jack may be configured to connect to a peripheral device, such as bonus controller 16 in FIG. 1. In addition, bridges 14 can be daisy chained together to facilitate communications with network 11, also shown in FIG. 1.

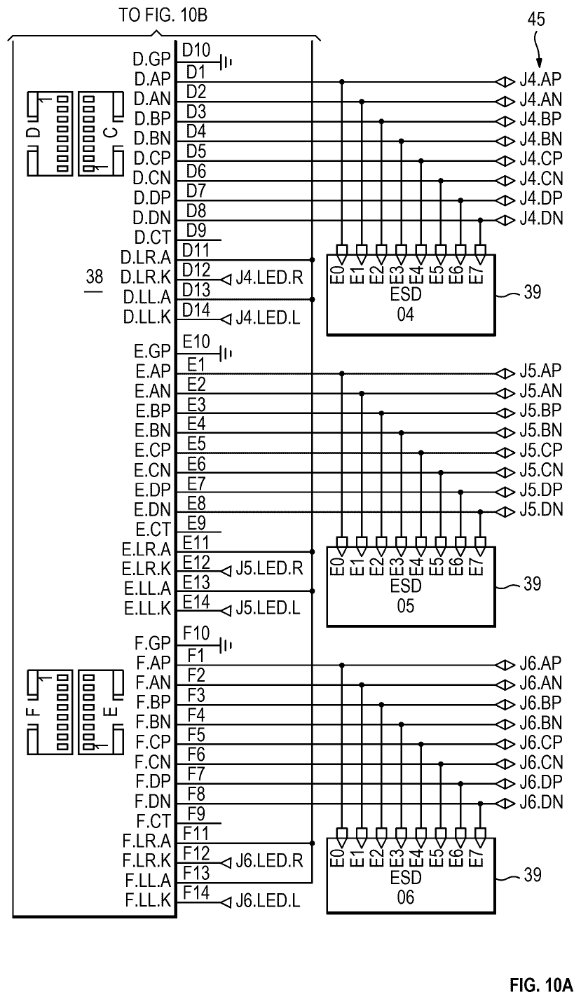

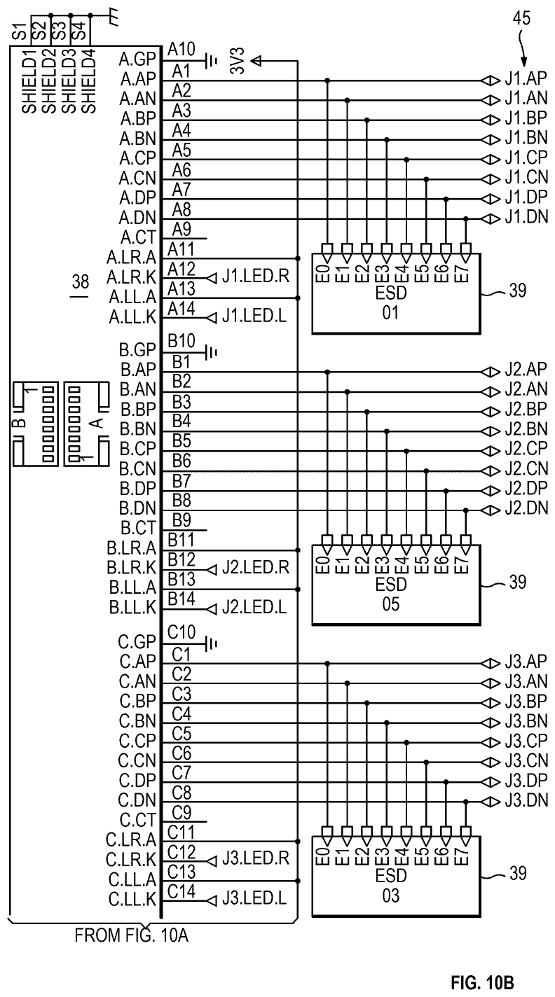

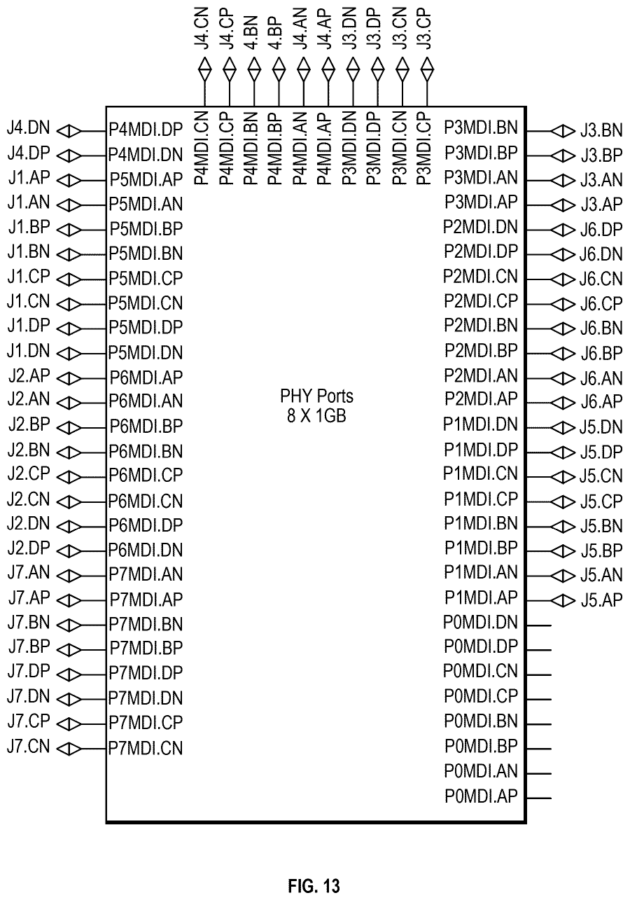

Considering the one or more network jacks 38 in more detail, in FIGS. 10A and 10B, show all 6 jacks labeled A through F. Each of the jack lines internal to bridge 14 are connected to electrostatic protection devices 39. Each of the lines are labeled as shown at 45. These lines connect to a correspondingly labeled pins on an Ethernet switch in FIG. 13.

In addition, jack 39 (also shown in FIG. 4B), which is shown in more detail in FIG. 11, has internal lines labeled as shown that are connected to correspondingly labeled lines on the Ethernet switch of FIG. 13. Jack 39 is connected to one end of a cable 40, in FIGS. 4A and 4B. The other end of the cable is plugged into a jack that is provided on network processor 42 board. As a result, this cable connects the network processor to the network Ethernet switch, depicted schematically in FIGS. 4A and 4B.

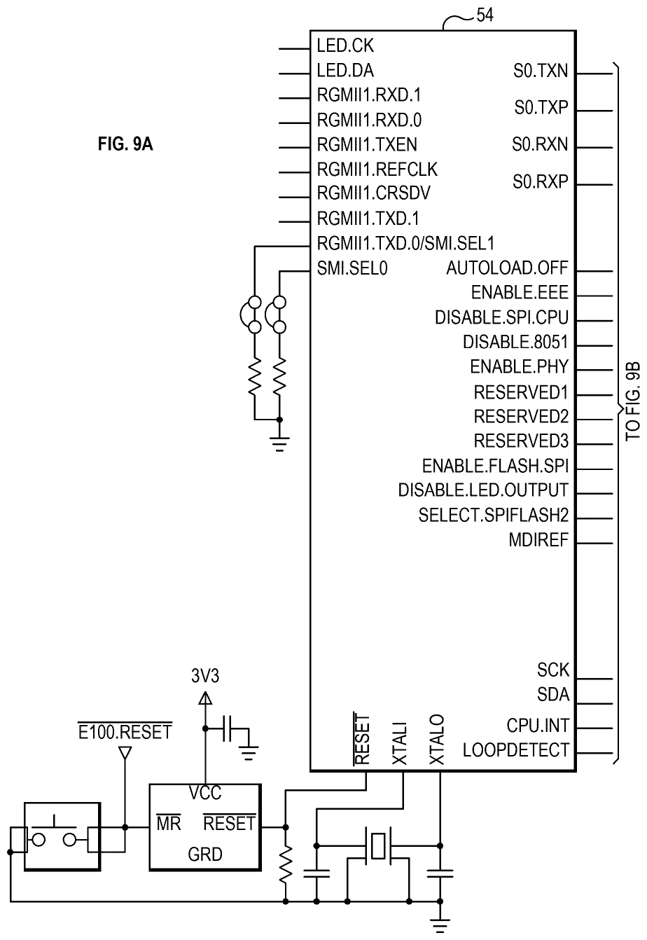

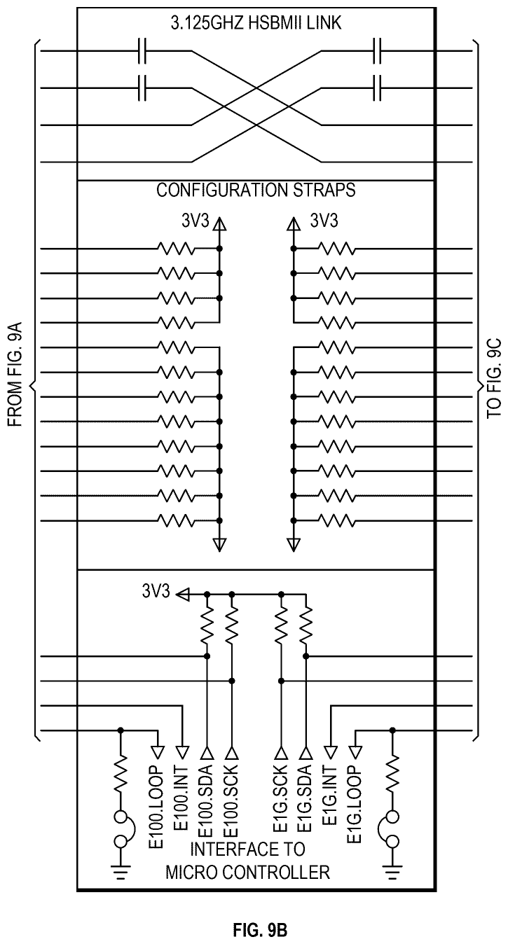

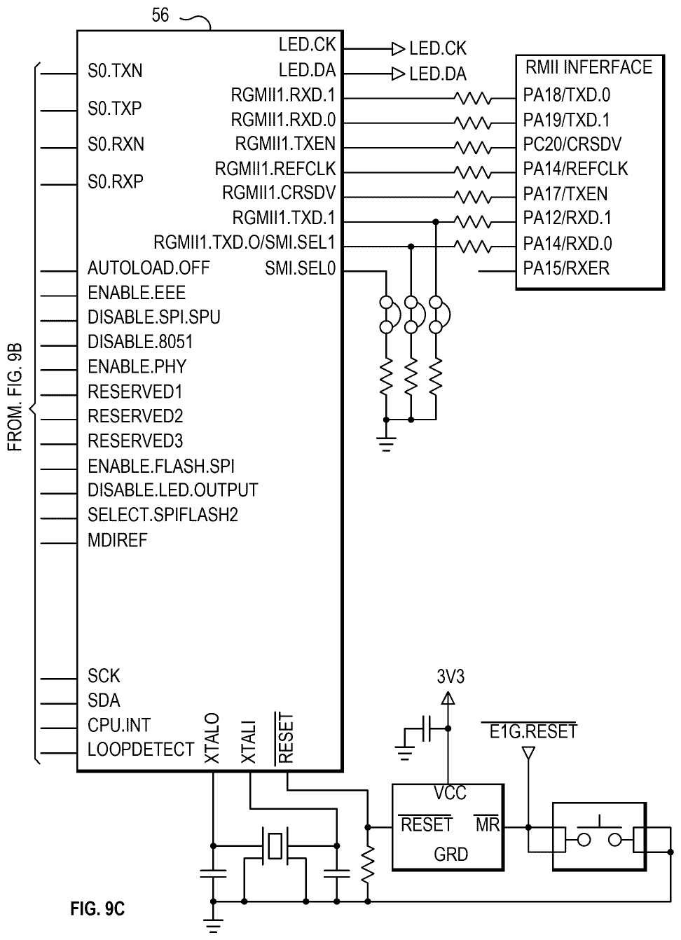

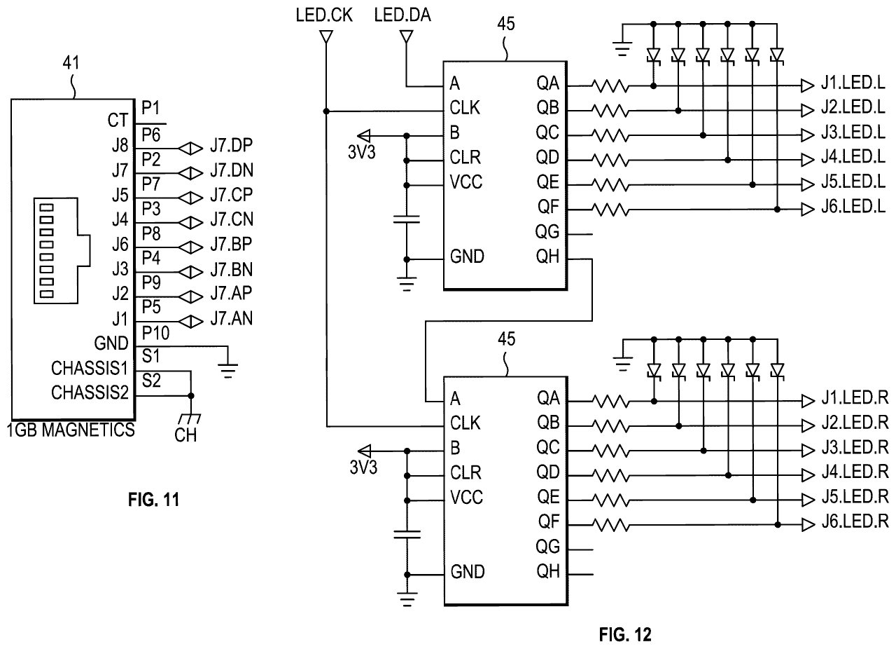

In FIG. 12, shift registers 45 are connected to LEDs on each of network jacks 38 as shown. The shift registers also connect to lines LED.CK and LED.DA, which in turn are connected to the correspondingly labeled lines on an Ethernet switch controller 56 in FIG. 9C. These signals on these lines ultimately light LEDs on each network jack to indicate connection status and when data is moving over the connection.

In the present embodiments, network processor 42 may be a credit-card size, 64-bit, single-board computer with both USB and Ethernet ports. The current embodiment may use the ROCK64 single-board computer manufactured by PINE64, but any suitable single-board computer could be used. As a result of these connections, data in the bridge is transmitted to and from the Ethernet switch in FIG. 13 and from there to and from network 11.

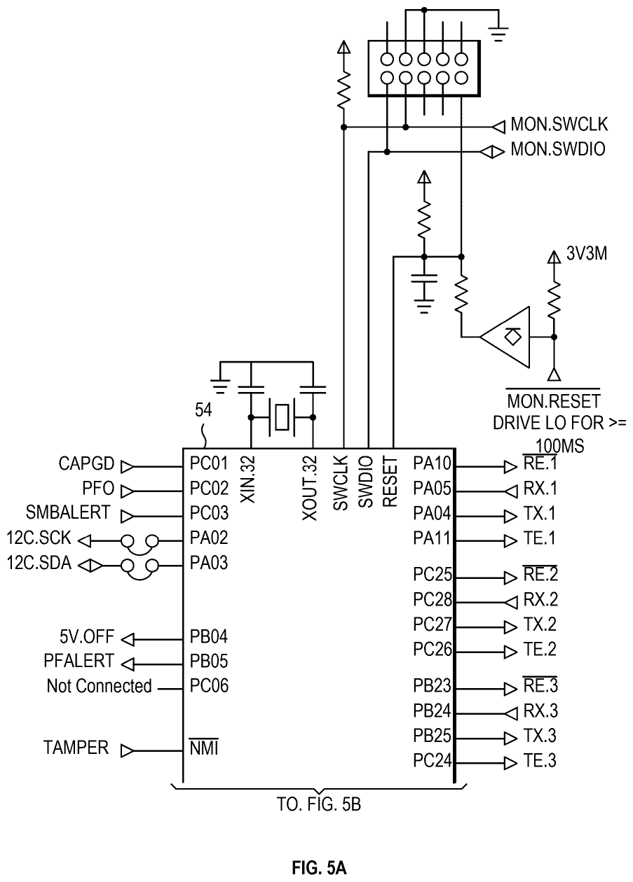

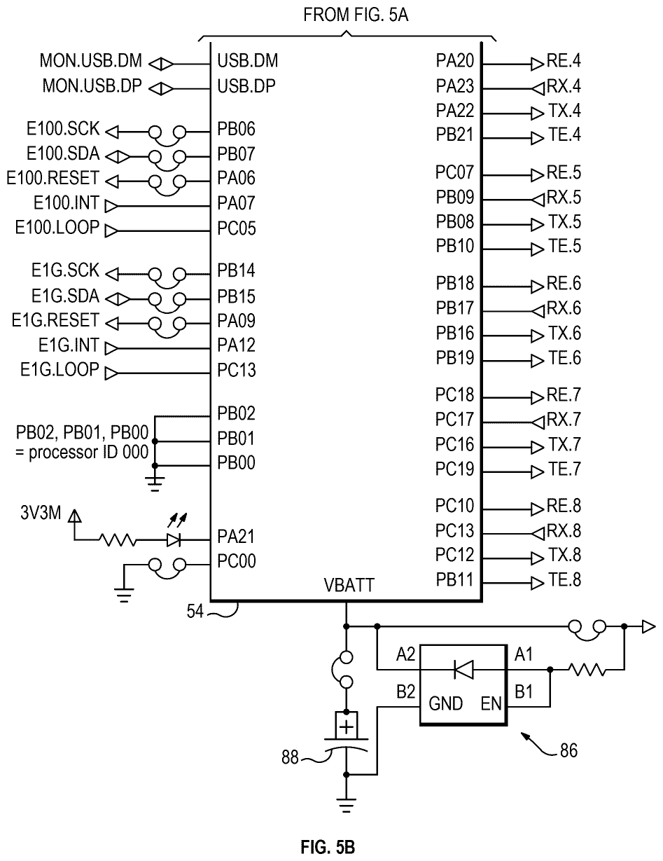

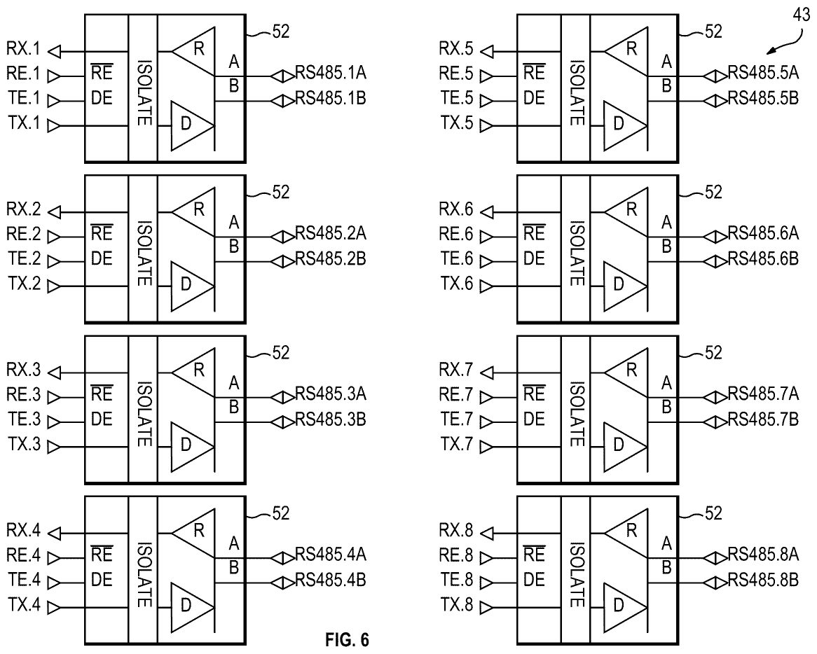

Returning again to FIG. 4B, the SAS data (shown in more detail at 50 in FIGS. 7A and 7B) on the RS485A and RS485B lines from each of game jacks 36 are connected to one side of a galvanic isolator circuit 43 shown in FIG. 4B and in more detail in FIG. 6. In the present embodiment, isolation is provided for each signal pair from the game jacks 36, like signal pair RS485.5A and RS485.5B in FIG. 6, by galvanically-isolated transceivers 52. In the present embodiments, transceivers 52 may comprise model number ISO1410 manufactured by Texas Instruments. The other side of each transceiver 52 generates a TTL signal on 4 lines as shown and is connected to a microcontroller 53, shown generally in FIG. 4B and with more detail in FIGS. 5A and 5B.

In the present embodiments, microcontroller 53 comprises a SAM E53 microcontroller manufactured by Microchip. Each of the four lines of transceivers 52 is connected to microcontroller 53 via the correspondingly labeled lines in FIGS. 5A and 5B, on the one hand, and in FIG. 6. These connections are also shown in the diagram of FIG. 4B.

Microcontroller signal lines are also connected to Ethernet switch controllers 54, 56 in FIGS. 9A and 9C. In the present embodiments, each switch controller is a Realtek RTL8370MB-CG switch controller. Switch controller 54 controls 100 MB Ethernet communications, and switch controller 56 controls 1 G Ethernet communications.

Both switch controllers 54, 56 are connected to microcontroller 53 in FIGS. 5A and 5B via the labeled lines shown at the bottom of FIG. 9B. The labels at the bottom of FIG. 9B correspond to labels on microcontroller 53 lines shown in FIGS. 5B. These connections are also shown in FIG. 4B at the lower portion of the microcontroller marked Ethernet Switch Logic. In addition, Ethernet switch controller 56 is connected to microcontroller 53 as shown in FIG. 9C in the block labeled RMII Interface (Reduced Media-Independent Interface), although these connections are not shown in FIGS. 4A, 5A, and 5B.

Turning again to FIGS. 4A and 4B, microcontroller 53 includes a line 58 that goes to one of the voltage regulators 60 in FIG. 4A. These include a 5V regulated power supply (not shown in the drawings). The 5V supply supplies network processor 42, which requires 5 volts at 3 amps. A signal on line 58 can be used to shut this power supply down under conditions that will be further explained. There is also a regulated 3V power supply for microcontroller 53, which draws considerably less current than network processor 42. In addition, there is an isolated regulated 5V power supply drawing 1 amp that supplies power to each GMI 12 and a 3.3V at 1-amp supply and 1V at 1-amp supply for the Ethernet switches.

Power may be provided by power supply 61 in FIG. 4A, which is a 40-Watt supply that provides 12 volts to the voltage regulators. In the present embodiments the power supple is manufactured by XP Power under model number VEC40US12. The power supply plugs into a conventional power outlet.

Beneath voltage regulators 60 in FIG. 4A is a tamper detection circuit 62, which is shown in more detail in FIG. 16. In the present embodiments, the circuit comprises a switch 63 that includes a magnetic ferrous ball 64, which adheres to a plate 66 that is part of the container for ball 64. The plate is relatively flush against a lid 68 of the metal box (not otherwise shown) that contains bridge 14. When the lid is lifted to gain access to bridge 14, the ball drops onto a contact 70, which completes a circuit between the container for ball 64, which is grounded as shown, and contact 70, which is connected to the TAMPER line in FIG. 4A. This provides a low-state signal to the microcontroller, which in turn generates and sends a signal configured to destroy a cryptographic key in microcontroller 53. The key may be configured to use in encrypting and decrypting data sent to and from bridge 14. Destruction of the key under these circumstances prevents further operation of bridge 14 and the associated GMIs 12 until the box containing the bridge can be inspected (either by the manufacturer or the appropriate gaming authority) to confirm whether or not tampering occurred. If tampering occurred, a new encrypted key may be delivered over the network to return bridge 14 and its associated GMIs 12 to service.

Beneath tamper detection circuit 62 is a temperature monitoring circuit 72. And beneath temperature monitoring circuit 72 is a super-capacitance (supercap) control circuit 74, which will be described in more detail after description of bridge 14 and GMI 12.

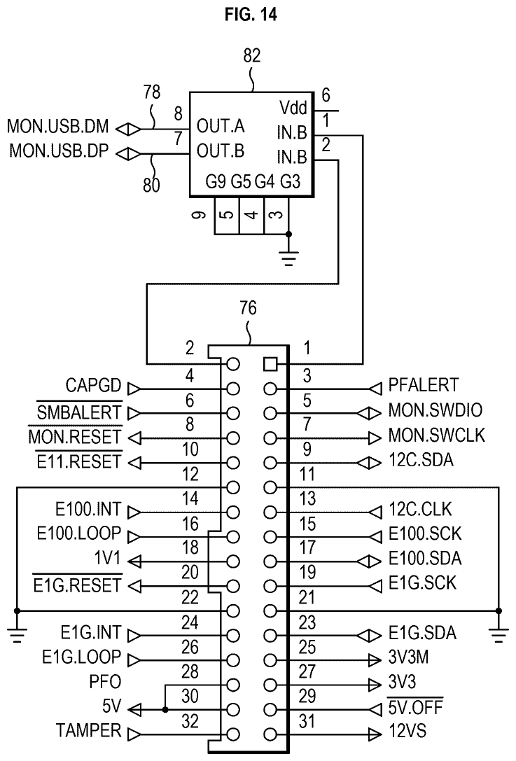

Before considering operation of the supercap control circuit 74, consideration will be given to the manner in which network processor 42 is connected to other components in bridge 14. As previously mentioned, plugs on either end of cable 40 connect at one end to the Ethernet switch in FIG. 13 and at the other end to network processor 42. This connection is shown diagrammatically in FIGS. 4A and 4B. This connects network processor 42 to network 11. Network processor 42 is also connected to microcontroller 53 via a cable that includes USB, PIO (Programmed Input/Output), and 5V power, as shown in FIG. 4A. The jack on bridge 14 that enables this connection is shown at 76 in FIG. 14 with pin labels that correspond to those in FIG. 4A. The FIG. 4A diagram shows these connections in box 75 marked SBC Connect (SBC is single board computer, namely network processor 42). As can be seen on jack 76 in FIG. 14, each of the labeled lines is connected to a correspondingly labeled line in box 75, except for PFO, which is tied to the 5V line in FIG. 14. Two of the connections, namely MON.USB.DM on line 78 and MON.USB.DP on line 80 in FIG. 14 are filtered via a single pair common mode filter 82. The signals on lines 78, 80 are shown with corresponding labels in box 75 in FIG. 4A, which provide USB communication between network processor 42 and microcontroller 53.

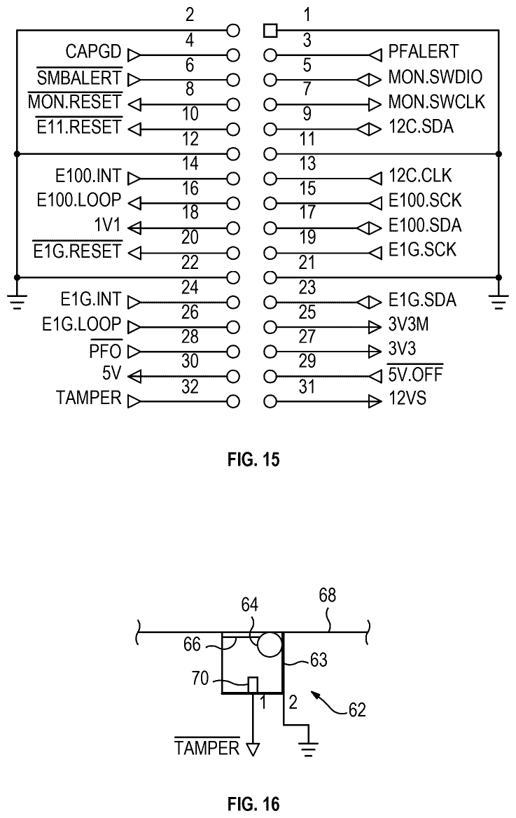

FIG. 15 is a second jack having similar connections to jack 76 in FIG. 14. The jack in FIG. 15 may be used for diagnostics.

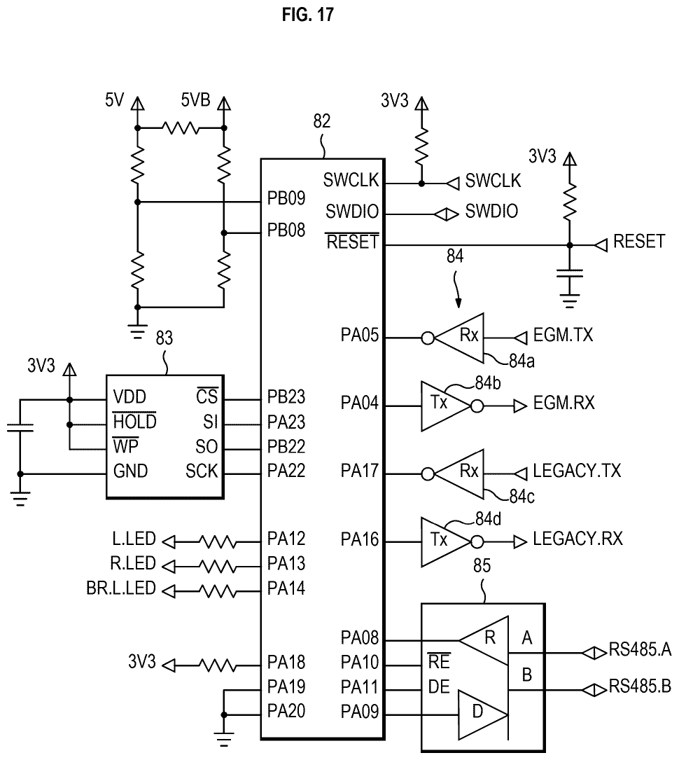

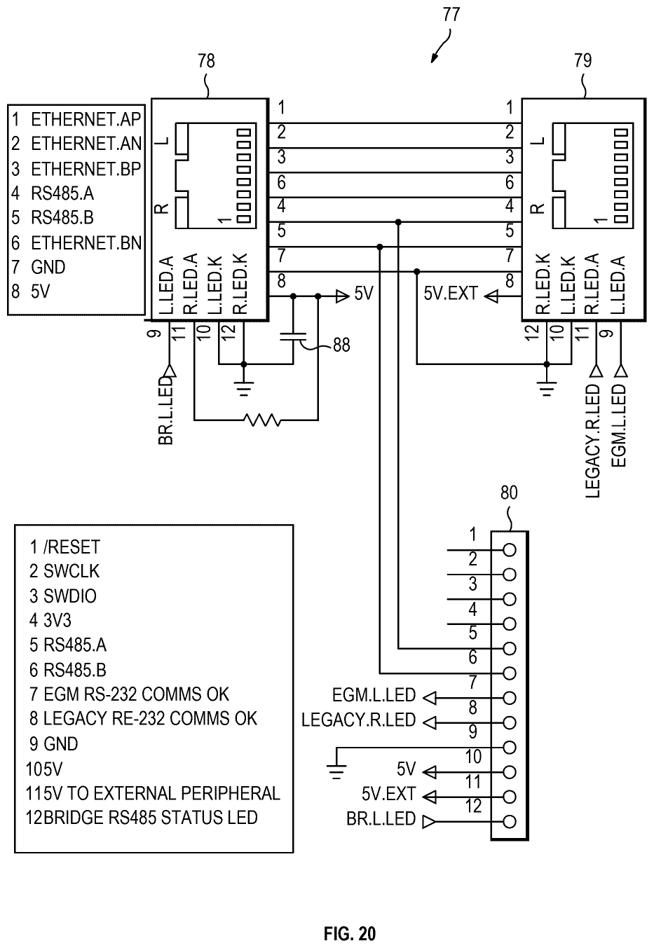

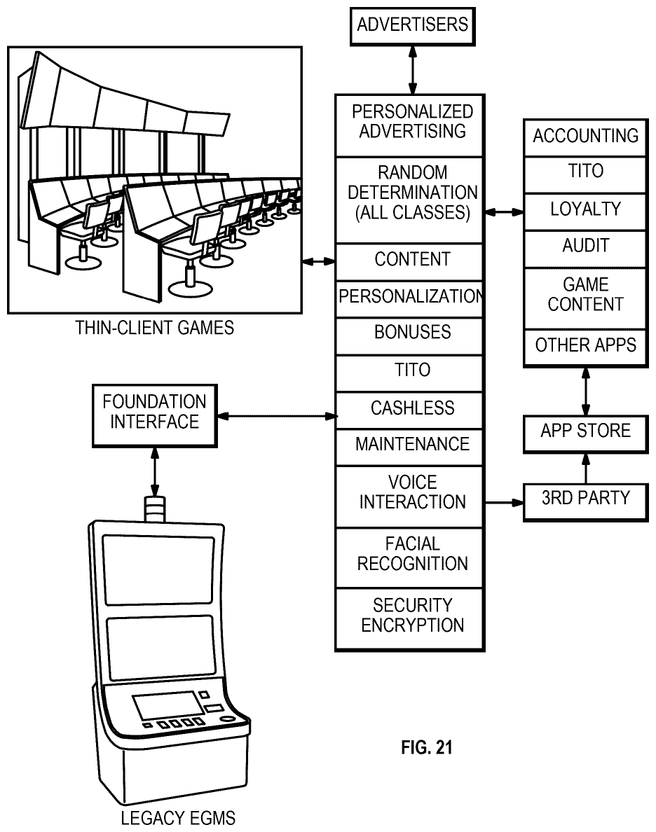

Consideration will now be given to the structure of GMI 12 and how it is connected to its associated EGM and to its associated bridge 14. GMI 12 is shown in several drawings, FIGS. 17-20. GMI 12 may be formed on two boards, one of which may be a motherboard, indicated generally at 77 in FIG. 20. The motherboard includes 3 jacks 78, 79, 80. Jack 78 may be configured to receive a plug (not shown) on one end of a cable 13, in FIG. 1, The other end of cable 13 may include a plug that is connected to any one of game jacks 36 in FIG. 7A and 7B, thus connecting GMI 12 to bridge 14.

Jack 79 may comprise an expansion port. Jack 79 may be available to connect to equipment on an EGM, such as a player tracking unit, a bonus feature, or any other auxiliary device that could be implemented using communications over network 11. The pins in jack 79 may be tied to the pins in jack 78 and therefore may communicate with the pins in the associated gaming jack 36 to which cable 13 is connected in the same manner as jack 78.

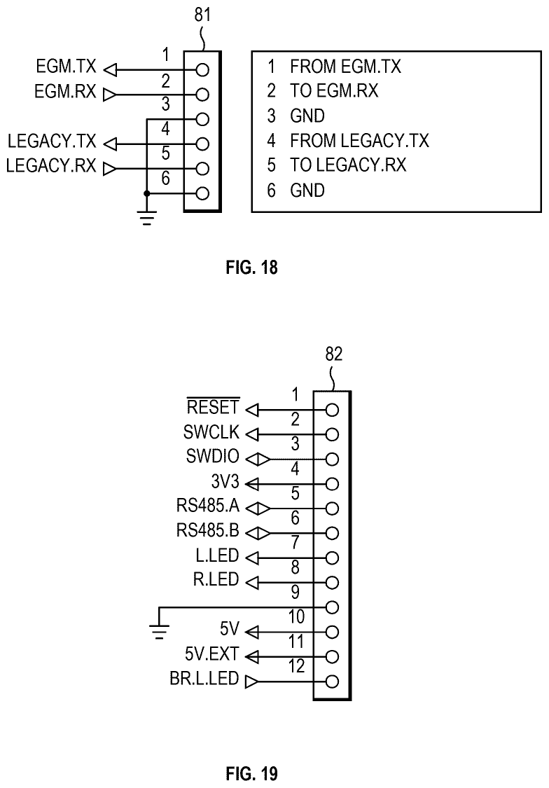

Jack 80 may be configured to provide communication between motherboard 77 and a daughterboard, the components of which are shown in FIGS. 17-18. One end of a cable (not shown) is plugged into jack 80 and the other end of the cable is plugged into a jack 82, in FIG. 19, on the daughterboard. The signal labels shown on the pins of jack 82 are connected to correspondingly labeled lines in FIG. 17.

A brief description of a typical gaming network into which the present embodiments are installed will aid understanding of how GMI 12 is further connected. As mentioned above, prior art systems for managing and providing services to EGMs typically include a suite of programs that deal with such things as accounting, cashless tickets, loyalty, and audit functions. The prior art system is referred to herein as a legacy host system. Communication with each EGM and the network that provides these services is made through the primary SAS port of each EGM. In prior art systems the primary SAS port is the only port that permits transfers of credits to and from the machine. Thus, in prior art systems, the SAS port must be used whenever money is transferred to and from the EGM, (e.g., bonus credits, TITO transactions, etc). As a result, the port to which GMI 12 must be connected is already connected to the network.

The current embodiments address this situation by connecting to network 11 in a manner that interposes bridge 14 between the EGM and the legacy host system. When installing GMI 12 where a legacy system is present, the cable from the legacy system that is plugged into the primary SAS port of EGM 10 is first unplugged. Interposing bridge 14 between the host system and EGM 10 may be accomplished via a jack 81 in FIG. 18, which receives one end of a connector (not shown) that plugs into jack 81. As a result, GMI 12 communicates with both the EGM, the signals of which are labeled EGM.TX (transmit) and EGM.RX (receive) in FIG. 18, and the host legacy system, the signals of which are labeled LEGACY.TX and LEGACY.RX in FIG. 18. These EGM and legacy signals are on lines on a daughterboard that are correspondingly labeled in FIG. 17.

Turning now to FIG. 17, a microcontroller 82 may be responsible for, among other things, SAS communications with associated EGMs. In the present embodiments, microcontroller 82 comprises a SAMD51G18A microcontroller manufactured by Microchip Technology. The microcontroller includes internal memory, and it is also connected to a ferroelectric random-access memory 83. Memory 83 may be an MR45V064B memory manufactured by Lapis Semiconductor Co. in the present embodiments. Memory 83 may be configured to retain data for up to 10 years without a source of power.

A line driver and receiver device, indicated generally at 84, is connected to receive and transmit ports on microcontroller 82 in FIG. 17 as shown. Device 84 includes two receive drivers 84a, 84c and two transmit drivers 84b, 84d. These drivers are connected to transmit and receive lines for the EGM SAS port and the legacy system port via jack 81 in FIG. 18. For example, device 84 may be a TRS3232 manufactured by Texas Instruments.

Microcontroller 82 may be configured as a SAS replicator. As a result, when the legacy system sends a SAS command, it is received at GMI 12 by microcontroller 82 via line driver 84c in FIG. 17. For example, if a player at the EGM presses the cashout button to receive a TITO ticket for the balance on the EGM credit meter, that command is received by line driver 84a and passed to the legacy system via driver 84d. When the legacy system determines all is in order, the legacy system assigns a ticket number for the TITO ticket and sends that data with a command to issue the ticket, which is received by line drier 84c. When this happens, the SAS replicator acknowledges the command, and immediately confirms to the legacy system that it has been executed. The confirmation is sent by microcontroller 82 via the transmit line driven by line driver 84d. Next, microcontroller 82 generates a SAS command to issue the ticket, which is sent to the EGM via line driver 84b.

In the event of a power failure that happens between the time bridge 14 confirms issuance of the ticket to the legacy system and the time the command to issue the ticket is sent to the EGM via line driver 84B, the data for this transaction is stored in memory (FeRAM) 83. When power is restored, the data is retrieved and the transaction is completed. Further attention will be given to the manner in which bridge 14 responds to a power failure.

In this manner bridge 14 is interposed between the legacy system and the EGM. If the operator of the EGMs wishes to implement a TITO system provided by a vendor different from the vendor that provided the legacy system, the new TITO system can be implemented as a computer process run by network processor 42. When that happens the legacy system may still remain in place because it may be providing other services, such as accounting and collecting player-tracking data. But legacy TITO commands received at driver 84c are ignored because all TITO communications and commands are being transmitted via line drivers 84a, 84b.

Many of the new services, such as TITO and bonuses, can be provided via software installed at bridge 14. This vastly reduces the regulatory burden. While the software must be approved, in many cases no additional hardware is required. This enables small design firms and even individuals to provide various products that require only new software.

In this way, various services, such as bonusing, dispatch, player-tracking, etc., can be implemented, one at a time, on bridge 14 while leaving the legacy system in place. An operator of EGMs may be interested in receiving EGM data to use for analytics and reporting. As previously mentioned, most prior art systems poll only for events, such as a cashout, hand-pay jackpot, etc., and current meter values. The present methods and systems poll rapidly and continuously to receive data that represents virtually all activity on the EGM, including reel stops, time between game play, and the like. If new data is detected, the present system generates a request to receive all available data. In other words, if the present system detects any available activity, it requests and polls for all available data. This provides a robust data stream for reporting and analytics.

Another line driver 85 includes a driver and receiver with electrostatic discharge protection. For example, the line driver 85 may comprise an SN65HVD72 half-duplex line driver and receiver manufactured by Texas Instruments. Line driver 85 may be connected to the R485.A and RS485.B lines from jack 82 in FIG. 19, which (as shown in FIG. 20) may be connected via jack 80 to lines on jack 78. As will be recalled jack 78 is connected to one of game jacks 36. These are the transmit and receive lines between GMI 12 and bridge 14.

The signal lines SWCLK and SWDIO may be lines configured to program flash memory contained in microcontroller 82. These lines may be connected to the corresponding lines in jack 82 and from there via a cable (not shown) that connects the motherboard and daughterboard and ultimately via jack 78 to one of game jacks 36 on bridge 14. This enables the flash memory in microcontroller 82 to be programmed with code delivered to it over network 11.

The four lines that connect to memory 83 may be used to store transactions in process that are contained in a memory of microcontroller 82 in the event of a power failure, as will be more fully described.

The LED lines on the lower left of microcontroller 82 may be configured to drive LEDs that are diagnostic indicators to indicate the status of the communications between the EGM and GMI 12 and between the legacy host and GMI 12.

The remaining components in FIG. 17 show power supply connections, biasing resistors, and capacitors, which are routinely used in connection with microcontrollers, like microcontroller 82.

The present embodiments may incorporate a number of existing software programs to build the infrastructure of applications. For example, Consul and Nomad, both open-source programs provided by HashiCorp, may provide dynamic application coordination. For example, Vault, also open source and provided by HashiCorp, may provide the backbone for security and trust. For example, Kafka, an open source program provided by Apache Software Foundation, may provide asynchronous messaging and publish/subscribe functionality for communications from one bridge 14 to another. These programs may enable a single identified bridge 14 to be a master, e.g., in connection with issuing TITO tickets, and all the others to be slaves. For example, the master tracks and issues ticket numbers at the single bridge 14 and authorizes other bridges accordingly when a TITO ticket is authorized to be issued. If the master goes out of service, another board may be automatically selected to become the new master, thus providing seamless operation.

Consideration will now be given to various backup power supplies, which are each provided by large capacitors that are kept charged during normal operation, (e.g., when power supply 61 in FIG. 4A is connected to power). There may be, for example, three sources of backup power that each provide a different function.

The first backup power supply is supercap control 74 in FIG. 4A. Although not depicted in a drawing beyond FIG. 4A, circuit 72 includes a high current supercapacitor backup controller and system monitor. For example, one manufactured by Linear Technology and identified as LTC3350EUHF. This device may be configured to control charging of 4 10-Farrad capacitors connected in series. Along with several power MOSFETs and biasing components, the Linear Technology device maintains a charge on the 4 capacitors. These capacitors back up the 5V and 3.3V regulated power supplies for microcontroller 53 and various other components.

These capacitors have enough stored charge to provide power to all components on bridge 14 for at least 30 seconds. If power is out for less than 30 seconds, or if power drops below normal levels for a short time, supercap control 74 may maintain power to all components on bridge 14. As a result, normal operation continues without interruption for short power failures and brownouts.

If, however, the power failure extends beyond 30 seconds, supercap control 74 generates a signal that goes to microcontroller 53. In response, microcontroller 53 launches a process that notifies network processor 42 that power is about to be lost. In response, bridge 14 and the GMIs 12 associated with the bridge begin a partial-shutdown operation and enter a hibernation mode during which a second backup power supply, indicated generally at 86 in FIG. 5B, provides power to microcontroller 53 only. Power to network processor 42, which draws a large current compared to microcontroller 53 is removed. In addition, any data in microcontroller 82 in FIG. 17 on the GMI daughterboard is stored in memory (e.g., FeRAM) 83.

Second backup power supply 86 may comprise a 1 amp diode 87 with a very low voltage drop. In the present embodiments, diode 87 may be a MAX40200 manufactured by Maxim Integrated. Second backup power supply 86 may also include a 45 Farad capacitor, which has enough charge to run microcontroller 53 for at least 100 hours. Its only function during this time is to detect a tamper signal from circuit 62, in FIGS. 4A and 16. As will be recalled, the cryptographic key expires every 48 hours and a new encrypted key is delivered over the network. If the power is out long enough for the key to expire, no new key will be delivered. Or if the tamper circuit detects that the box containing bridge 14 is opened, the key will be destroyed.

In either of these circumstances, the box containing bridge 14 must be inspected, by either the manufacturer or an appropriate gaming authority, and reset to receive a new key when the box is reinstalled. This procedure provides a highly secure environment for data transactions handled by bridge 14.

A third backup power supply may comprise a capacitor 88 in FIG. 20. This capacitor maintains power to microcontroller 83 for a short time in the event cable 13 is unplugged. As will be recalled, cable 13 provides power to GMI 12. When the voltage on capacitor 88 drops below a predefined value, microcontroller 82 shuts down in the same manner as when it receives a signal from bridge 14 indicating that power supply 61 is no longer providing sufficient power to run bridge 14. As a result, if cable 13 is unplugged, any SAS data in microcontroller 82 is stored in memory (e.g., FeRAM) 83. When power is restored, i.e., when cable 13 is plugged back in, that data is retrieved and microcontroller 82 resumes processing where it left off.

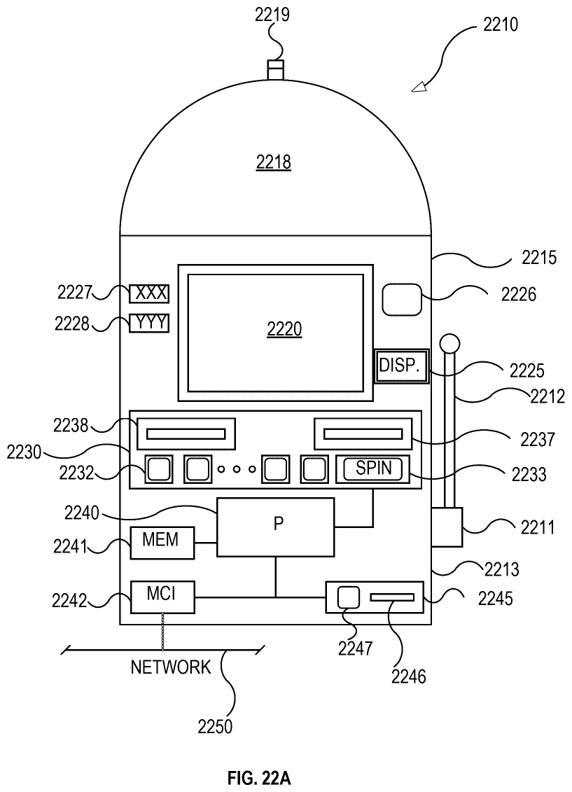

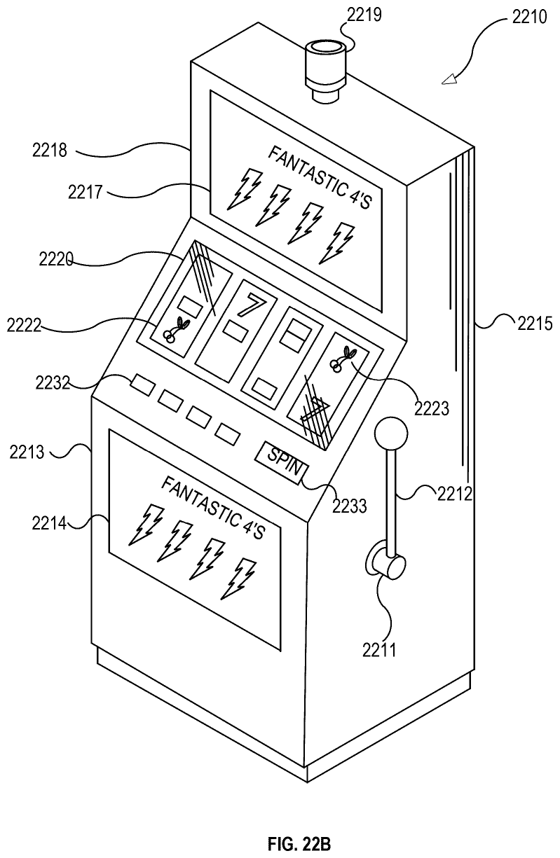

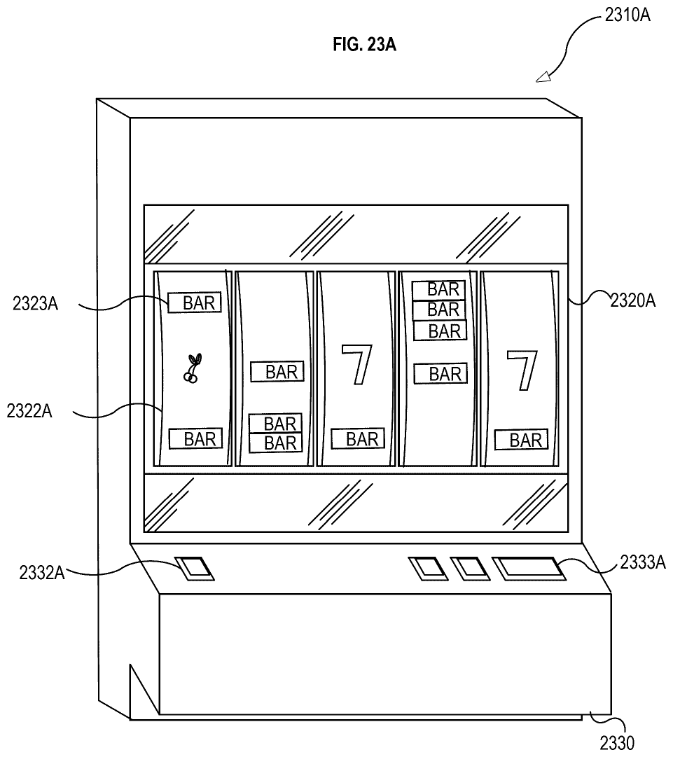

FIGS. 22A and 22B illustrate example gaming devices (e.g., gaming machines). Referring to FIGS. 22A and 22B, a gaming device 2210 is an electronic gaming machine. Although an electronic gaming machine or “slot” machine is illustrated, various other types of devices may be used to wager credits or other value on a game of chance. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. For ease of illustration the present embodiments will be described in reference to the electronic gaming machine 2210 shown in FIGS. 22A and 22B.

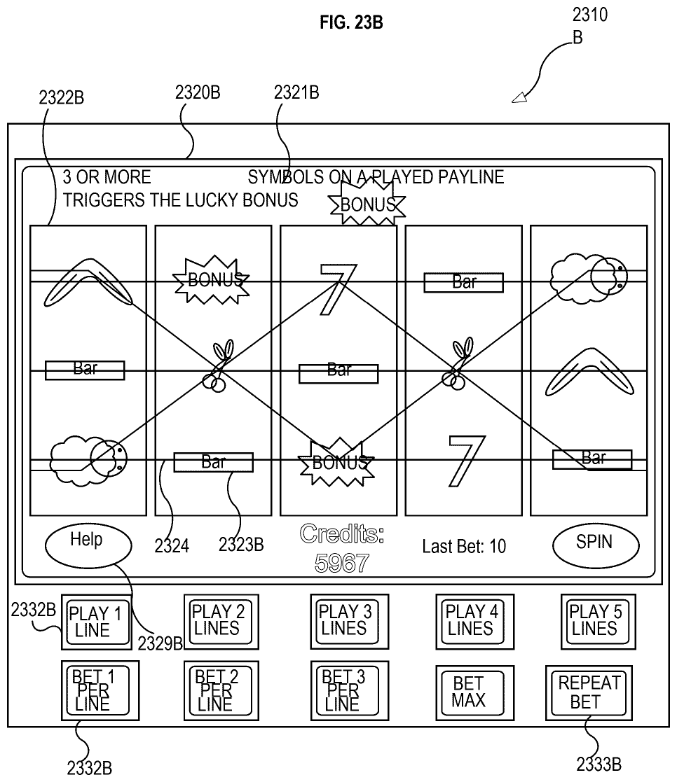

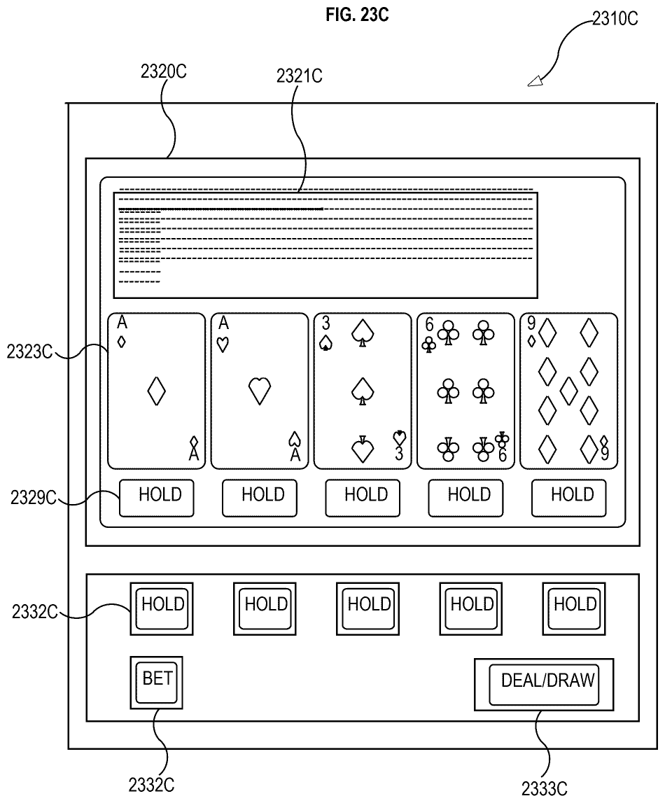

The gaming device 2210 includes a cabinet 2215 housing components to operate the gaming device 2210. The cabinet 2215 may include a gaming display 2220, a base portion 2213, a top box 2218, and a player interface panel 2230. The gaming display 2220 may include mechanical spinning reels (FIG. 23A), a video display (FIGS. 23B and 23C), or a combination of both spinning reels and a video display (not shown). The gaming cabinet 2215 may also include a credit meter 2227 and a coin-in or bet meter 2228. The credit meter 2227 may indicate the total number of credits remaining on the gaming device 2210 that are eligible to be wagered. In some embodiments, the credit meter 2227 may reflect a monetary unit, such as dollars. However, it is often preferable to have the credit meter 2227 reflect a number of ‘credits,’ rather than a monetary unit. The bet meter 2228 may indicate the amount of credits to be wagered on a particular game. Thus, for each game, the player transfers the amount that he or she wants to wager from the credit meter 2227 to the bet meter 2228. In some embodiments, various other meters may be present, such as meters reflecting amounts won, amounts paid, or the like. In embodiments where the gaming display 2220 is a video monitor, the information indicated on the credit meters may be shown on the gaming display itself 2220 (FIG. 23B).

The base portion 2213 may include a lighted panel 2214, a coin return (not shown), and a gaming handle 2212 operable on a partially rotating pivot joint 2211. The game handle 2212 is traditionally included on mechanical spinning-reel games, where the handle may be pulled toward a player to initiate the spinning of reels 2222 after placement of a wager. The top box 2218 may include a lighted panel 2217, a video display (such as an LCD monitor), a mechanical bonus device (not shown), and a candle light indicator 2219. The player interface panel 2230 may include various devices so that a player can interact with the gaming device 10.

The player interface panel 2230 may include one or more game buttons 2232 that can be actuated by the player to cause the gaming device 2210 to perform a specific action. For example, some of the game buttons 2232 may cause the gaming device 2210 to bet a credit to be wagered during the next game, change the number of lines being played on a multi-line game, cash out the credits remaining on the gaming device (as indicated on the credit meter 2227), or request assistance from casino personnel, such as by lighting the candle 2219. In addition, the player interface panel 2230 may include one or more game actuating buttons 2233. The game actuating buttons 2233 may initiate a game with a pre-specified amount of credits. On some gaming devices 2210 a “Max Bet” game actuating button 2233 may be included that places the maximum credit wager on a game and initiates the game. The player interface panel 2230 may further include a bill acceptor 2237 and a ticket printer 2238. The bill acceptor 2237 may accept and validate paper money or previously printed tickets with a credit balance. The ticket printer 2238 may print out tickets reflecting the balance of the credits that remain on the gaming device 2210 when a player cashes out by pressing one of the game buttons 2232 programmed to cause a ‘cashout.’ These tickets may be inserted into other gaming machines or redeemed at a cashier station or kiosk for cash.

The gaming device 2210 may also include one or more speakers 2226 to transmit auditory information or sounds to the player. The auditory information may include specific sounds associated with particular events that occur during game play on the gaming device 2210. For example, a particularly festive sound may be played during a large win or when a bonus is triggered. The speakers 2226 may also transmit “attract” sounds to entice nearby players when the game is not currently being played.

The gaming device 2210 may further include a secondary display 2225. In addition, a player's mobile computing device, typically a cellular phone, may supplement or replace secondary display 2225. The phone may have an app that the player can download from an app store or a website that is compatible with the communications methods used in the gaming system. Alternatively, a web browser on the player's phone may operate as the secondary display. The phone may interface with the gaming system network via a cellular network, a WiFi network, or any other suitable wireless communications means. The secondary display 2225 may be a vacuum fluorescent display (VFD), a liquid crystal display (LCD), a cathode ray tube (CRT), a plasma screen, or the like. The secondary display 2225 may show any combination of primary game information and ancillary information to the player. For example, the secondary display 2225 may show player tracking information, secondary bonus information, advertisements, or player selectable game options.

The gaming device 2210 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window.” Another example is Las Vegas Gaming Incorporated's retrofit technology which allows information to be placed over areas of the game or the secondary display screen at various times and in various situations.

The gaming device 2210 includes a microprocessor 2240 that controls operation of the gaming device 2210. If the gaming device 2210 is a standalone gaming device, the microprocessor 2240 may control virtually all of the operations of the gaming devices and attached equipment, such as operating game logic stored in memory (not shown) as firmware, controlling the display 2220 to represent the outcome of a game, communicating with the other peripheral devices (such as the bill acceptor 2237), and orchestrating the lighting and sound emanating from the gaming device 2210. In other embodiments where the gaming device 2210 is coupled to a network 2250, as described below, the microprocessor 2240 may have different tasks depending on the setup and function of the gaming device. For example, the microprocessor 2240 may be responsible for running the base game of the gaming device and executing instructions received over the network 2250 from a bonus server or player tracking server. In a server-based gaming setup, the microprocessor 2240 may act as a terminal to execute instructions from a remote server that is running game play on the gaming device.

The microprocessor 2240 may be coupled to a machine communication interface (MCI) 4222 that connects the gaming device 2210 to a gaming network 2250. The MCI 2242 may be coupled to the microprocessor 2240 through a serial connection, a parallel connection, an optical connection, or in some cases a wireless connection. The gaming device 2210 may include memory 2241 (MEM), such as a random access memory (RAM), coupled to the microprocessor 2240 and which can be used to store gaming information, such as storing total coin-in statistics about a present or past gaming session, which can be communicated to a remote server or database through the MCI 2242. The MCI 2242 may also facilitate communication between the network 2250 and the secondary display 2225 or a player tracking unit 2245 housed in the gaming cabinet 2215.

The player tracking unit 2245 may include an identification device 2246 and one or more buttons 2247 associated with the player tracking unit 2245. The identification device 2246 serves to identify a player, by, for example, reading a player-tracking device, such as a player tracking card that is issued by the casino to individual players who choose to have such a card. The identification device 2246 may instead, or additionally, identify players through other methods. Player tracking systems using player tracking cards and card readers 2246 are known in the art. Briefly summarizing such a system, a player registers with the casino prior to commencing gaming. The casino issues a unique player-tracking card to the player and opens a corresponding player account that is stored on a server or host computer, described below with reference to FIG. 23. The player account may include the player's name and mailing address and other information of interest to the casino in connection with marketing efforts. Prior to playing one of the gaming devices in the casino, the player inserts the player tracking card into the identification device 2246 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 2225 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 2225 to access their player tracking account, such as to check a total number of points, redeem points for various services, make changes to their account, or download promotional credits to the gaming device 2210. In other embodiments, the identification device 2246 may read other identifying cards (such as driver licenses, credit cards, etc.) to identify a player and match them to a corresponding player tracking account. Although FIG. 22A shows the player tracking unit 2245 with a card reader as the identification device 2246, other embodiments may include a player tracking unit 2245 with a biometric scanner, PIN code acceptor, or other methods of identifying a player to pair the player with their player tracking account.

During typical play on a gaming device 2210, a player plays a game by placing a wager and then initiating a gaming session. The player may initially insert monetary bills or previously printed tickets with a credit value into the bill acceptor 2237. The player may also put coins into a coin acceptor (not shown) or a credit, debit or casino account card into a card reader/authorizer (not shown). In other embodiments, stored player points or special ‘bonus points’ awarded to the player or accumulated and/or stored in a player account may be able to be substituted at or transferred to the gaming device 2210 for credits or other value. For example, a player may convert stored loyalty points to credits or transfer funds from his bank account, credit card, casino account or other source of funding. The selected source of funding may be selected by the player at time of transfer, determined by the casino at the time of transfer or occur automatically according to a predefined selection process. One of skill in the art will readily see that the methods and systems described herein are useful with all gambling devices, regardless of the manner in which wager value-input is accomplished.

The credit meter 2227 may be configured to display the numeric credit value of the money or other value inserted, transferred, or stored dependent on the denomination of the gaming device 2210. That is, if the gaming device 2210 is a nickel slot machine and a $20 bill inserted into the bill acceptor 2237, the credit meter will reflect 400 credits or one credit for each nickel of the inserted twenty dollars. For gaming devices 2210 that support multiple denominations, the credit meter 2227 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 2232, which may be reflected on the bet meter 2228. That is, the player can generally depress a “bet one” button (one of the buttons on the player interface panel 2230, such as 2232), which transfers one credit from the credit meter 2227 to the bet meter 2228. Each time the button 2232 is depressed an additional single credit transfers to the bet meter 2228 up to a maximum bet that can be placed on a single play of the electronic gaming device 2210. The gaming session may be initiated by pulling the gaming handle 2212 or depressing the spin button 2233. On some gaming devices 2210, a “max bet” button (another one of the buttons 2232 on the player interface panel 2230) may be depressed to wager the maximum number of credits supported by the gaming device 2210 and initiate a gaming session.

If the gaming session does not result in any winning combination, the process of placing a wager may be repeated by the player. Alternatively, the player may cash out any remaining credits on the credit meter 2227 by depressing the “cash-out” button (another button 2232 on the player interface panel 2230), which causes the credits on the credit meter 2227 to be paid out in the form of a ticket through the ticket printer 2238, or may be paid out in the form of returning coins from a coin hopper (not shown) to a coin return tray.

If instead a winning combination (win) appears on the display 2220, the award corresponding to the winning combination is immediately applied to the credit meter 2227. For example, if the gaming device 2210 is a slot machine, a winning combination of symbols 2223 may land on a played payline on reels 2222. If any bonus games are initiated, the gaming device 2210 may enter into a bonus mode or simply award the player with a bonus amount of credits that are applied to the credit meter 2227.

FIGS. 23A to 23C illustrate exemplary types of gaming devices. FIG. 23A illustrates an example spinning-reel gaming machine 2310A, FIG. 23B illustrates an example video slot machine 2310B, and FIG. 23C illustrates an example video poker machine 2310C.

Referring to FIG. 23A, a spinning-reel gaming machine 2310A includes a gaming display 2320A having a plurality of mechanical spinning reels 2322A. Typically, spinning-reel gaming machines 2310A have three to five spinning reels 2322A. Each of the spinning reels 2322A has multiple symbols 2323A that may be separated by blank areas on the spinning reels 2322A, although the presence of blank areas typically depends on the number of reels 2322A present in the gaming device 2310A and the number of different symbols 2323A that may appear on the spinning reels 2322A. Each of the symbols 2322A or blank areas makes up a “stop” on the spinning reel 2322A where the reel 2322A comes to rest after a spin. Although the spinning reels 2322A of various games 2310A may have various numbers of stops, many conventional spinning-reel gaming devices 2310A have reels 2322A with twenty two stops.

During game play, the spinning reels 2222A may be controlled by stepper motors (not shown) under the direction of the microprocessor 2240 (FIG. 22A). Thus, although the spinning-reel gaming device 2310A has mechanical based spinning reels 2322A, the movement of the reels themselves is electronically controlled to spin and stop. This electronic control is advantageous because it allows a virtual reel strip to be stored in the memory 2341 of the gaming device 2310A, where various “virtual stops” are mapped to each physical stop on the physical reel 2322A. This mapping allows the gaming device 2310A to establish greater awards and bonuses available to the player because of the increased number of possible combinations afforded by the virtual reel strips.

A gaming session on a spinning reel slot machine 2310A typically includes the player pressing the “bet-one” button (one of the game buttons 2332A) to wager a desired number of credits followed by pulling the gaming handle 2312 (FIGS. 22A, 22B) or pressing the spin button 2333A to spin the reels 2322A. Alternatively, the player may simply press the “max-bet” button (another one of the game buttons 2332A) to both wager the maximum number of credits permitted and initiate the spinning of the reels 22A. The spinning reels 2322A may all stop at the same time or may individually stop one after another (typically from left to right) to build player anticipation. Because the display 2320A usually cannot be physically modified, some spinning reel slot machines 2310A include an electronic display screen in the top box 2318 (FIG. 22B), a mechanical bonus mechanism in the top box 2318, or a secondary display 2325 (FIG. 22A) to execute a bonus.

Referring to FIG. 23B, a video gaming machine 2310B may include a video display 2320B to display virtual spinning reels 2322B and various other gaming information 2321B. The video display 2320B may be a CRT, LCD, plasma screen, or the like. It is usually preferable that the video display 2320B be a touchscreen to accept player input. A number of symbols 2323A appear on each of the virtual spinning reels 2322B. Although FIG. 23B shows five virtual spinning reels 2322B, the flexibility of the video display 2320B allows for various reel 2322B and game configurations. For example, some video slot games 10B spin reels for each individual symbol position (or stop) that appears on the video display 2320B. That is, each symbol position on the screen is independent of every other position during the gaming sessions. In these types of games, very large numbers of pay lines or multiple super scatter pays can be utilized since similar symbols could appear at every symbol position on the video display 2320B. On the other hand, other video slot games 2310B more closely resemble the mechanical spinning reel games where symbols that are vertically adjacent to each other are part of the same continuous virtual spinning reel 2322B.

Because the virtual spinning reels 2322B, by virtue of being computer implemented, can have almost any number of stops on a reel strip, it is much easier to have a greater variety of displayed outcomes as compared to spinning-reel slot machines 2310A (FIG. 23A) that have a fixed number of physical stops on each spinning reel 2322A.

With the possible increases in reel 2322B numbers and configurations over the mechanical gaming device 2310A, video gaming devices 2310B often have multiple paylines 2324 that may be played. By having more paylines 2324 available to play, the player may be more likely to have a winning combination when the reels 2322B stop and the gaming session ends. However, since the player typically must wager at least a minimum number of credits to enable each payline 2324 to be eligible for winning, the overall odds of winning are not much different, if at all, than if the player is wagering only on a single payline. For example, in a five line game, the player may bet one credit per payline 2324 and be eligible for winning symbol combinations that appear on any of the five played paylines 2324. This gives a total of five credits wagered and five possible winning paylines 2324. If, on the other hand, the player only wagers one credit on one payline 2324, but plays five gaming sessions, the odds of winning would be identical as above: five credits wagered and five possible winning paylines 2324.

Because the video display 2320B can easily modify the image output by the video display 2320B, bonuses, such as second screen bonuses are relatively easy to award on the video slot game 2310B. That is, if a bonus is triggered during game play, the video display 2320B may simply store the resulting screen shot in memory and display a bonus sequence on the video display 2320B. After the bonus sequence is completed, the video display 2320B may then retrieve the previous screen shot and information from memory, and re-display that image.

Also, as mentioned above, the video display 2320B may allow various other game information 2321B to be displayed. For example, as shown in FIG. 23B, banner information may be displayed above the spinning reels 2322B to inform the player, perhaps, which symbol combination is needed to trigger a bonus. Also, instead of providing a separate credit meter 2327 (FIG. 22A) and bet meter 2328, the same information can instead be displayed on the video display 2320B. In addition, “soft buttons” 2329B such as a “spin” button or “help/see pays” button may be built using the touch screen video display 2320B. Such customization and ease of changing the image shown on the display 2320B adds to the flexibility of the game 2310B.

Even with the improved flexibility afforded by the video display 2320B, several physical buttons 2332B and 2333B are usually provided on video slot machines 2310B. These buttons may include game buttons 2332B that allow a player to choose the number of paylines 2324 he or she would like to play and the number of credits wagered on each payline 2324. In addition, a max bet button (one of the game buttons 2332B) allows a player to place a maximum credit wager on the maximum number of available paylines 2324 and initiate a gaming session. A repeat bet or spin button 2333B may also be used to initiate each gaming session when the max bet button is not used.

Referring to FIG. 23C, a video poker gaming device 2310C may include a video display 2320C that is physically similar to the video display 2320B shown in FIG. 23B. The video display 2320C may show a poker hand of five cards 2323C and various other player information 2321C including a paytable for various winning hands, as well as a plurality of player selectable soft buttons 2329C. The video display 2320C may present a poker hand of five cards 23C and various other player information 2321C including a number of player selectable soft (touch-screen) buttons 2329C and a paytable for various winning hands. Although the embodiment illustrated in FIG. 23C shows only one hand of poker on the video display 2320C, various other video poker machines 2310C may show several poker hands (multi-hand poker). Typically, video poker machines 2310C play “draw” poker in which a player is dealt a hand of five cards, has the opportunity to hold any combination of those five cards, and then draws new cards to replace the discarded ones. All pays are usually given for winning combinations resulting from the final hand, although some video poker games 2310C may give bonus credits for certain combinations received on the first hand before the draw. In the example shown in FIG. 23C a player has been dealt two aces, a three, a six, and a nine. The video poker game 2310C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 2310C typically awards any credits won to the credit meter.

The player selectable soft buttons 2329C appearing on the screen respectively correspond to each card on the video display 2320C. These soft buttons 2329C allow players to select specific cards on the video display 2320C such that the card corresponding to the selected soft button is “held” before the draw. Typically, video poker machines 2310C also include physical game buttons 2332C that correspond to the cards in the hand and may be selected to hold a corresponding card. A deal/draw button 2333C may also be included to initiate a gaming session after credits have been wagered (with a bet button 2332C, for example) and to draw any cards not held after the first hand is displayed.

Although examples of a spinning reel slot machine 2310A, a video slot machine 10B, and a video poker machine 2310C have been illustrated in FIGS. 23A-23C, gaming machines and various other types of gaming devices known in the art are contemplated.

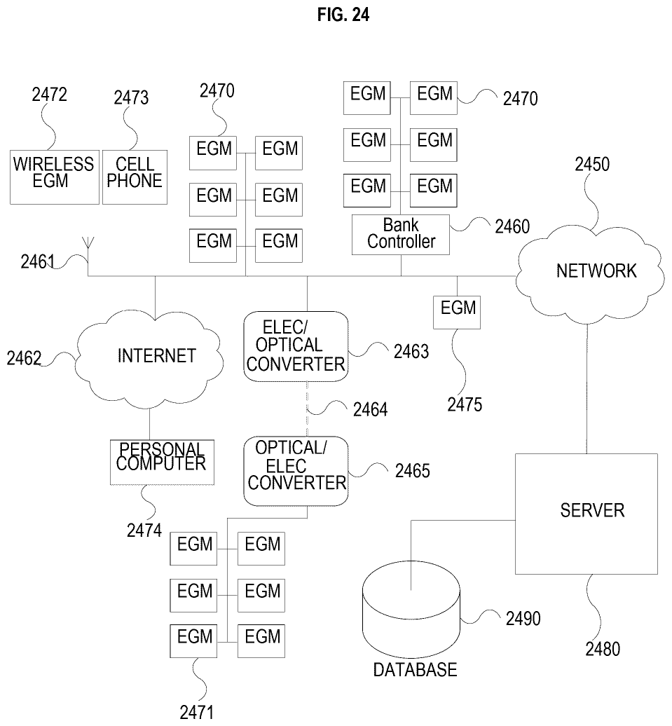

FIG. 24 is a block diagram illustrating networked gaming devices. Referring to FIG. 24, multiple electronic gaming devices (EGMs) 2470, 2471, 2472, 2473, 2474, and 2475 may be coupled to one another and coupled to a remote server 2480 through a network 2450. For ease of understanding, gaming devices or EGMs 2470, 2471, 2472, 2473, 2474, and 2475 are generically referred to as EGMs 2470-2475. The term EGMs 2470-2475, however, may refer to any combination of one or more of EGMs 2470, 2471, 2472, 2473, 2474, and 2475. Additionally, the gaming server 2480 may be coupled to one or more gaming databases 2490. These gaming network 2450 connections may allow multiple gaming devices 2470-2475 to remain in communication with one another during particular gaming modes such as tournament play or remote head-to-head play. Although some of the gaming devices 2470-2475 coupled on the gaming network 2450 may resemble the gaming devices 2210, 2310A, 2310B, and 2310C shown in FIGS. 22A-22B and 23A-23C, other coupled gaming devices 2470-2475 may include differently configured gaming devices. For example, the gaming devices 2470-2475 may include traditional slot machines 2475 directly coupled to the network 2450, banks of gaming devices 2470 coupled to the network 2450, banks of gaming devices 2470 coupled to the network 2450 through a bank controller 2460, wireless handheld gaming machines 2472 and cell phones 2473 coupled to the gaming network 2450 through one or more wireless routers or antennas 2461, personal computers 2474 coupled to the network 2450 through the internet 2462, and banks of gaming devices 2471 coupled to the network through one or more optical connection lines 2464. Additionally, some of the traditional gaming devices 2470, 2471, and 2475 may include electronic gaming tables, multi-station gaming devices, or electronic components operating in conjunction with non-gaming components, such as automatic card readers, chip readers, and chip counters, for example.

Gaming devices 2471 coupled over an optical line 2464 may be remote gaming devices in a different location or casino. The optical line 2464 may be coupled to the gaming network 2450 through an electronic to optical signal converter 2463 and may be coupled to the gaming devices 2471 through an optical to electronic signal converter 2465. The banks of gaming devices 2470 coupled to the network 2450 may be coupled through a bank controller 2460 for compatibility purposes, for local organization and control, or for signal buffering purposes. The network 2450 may include serial or parallel signal transmission lines and carry data in accordance with data transfer protocols such as Ethernet transmission lines, Rs-232 lines, firewire lines, USB lines, or other communication protocols. Although not shown in FIG. 24, substantially the entire network 2450 may be made of fiber optic lines or may be a wireless network utilizing a wireless protocol such as IEEE 802.11 a, b, g, or n, Zigbee, RF protocols, optical transmission, near-field transmission, or the like.

As mentioned above, each gaming device 2470-2475 may have an individual processor 2440 (FIG. 22A) and memory 2441 to run and control game play on the gaming device 2470-2475, or some of the gaming devices 2470-2475 may be terminals that are run by a remote server 2480 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 2450, server 2480, and database 2490 may be dedicated to communications regarding specific game or tournament play. In other embodiments, however, the network 2450, server 2480, and database 2490 may be part of a player tracking network. For player tracking capabilities, when a player inserts a player tracking card in the card reader 2446 (FIG. 22A), the player tracking unit 2245 sends player identification information obtained on the card reader 2246 through the MCI 2242 over the network 2250 to the player tracking server 2480, where the player identification information is compared to player information records in the player database 2490 to provide the player with information regarding their player account or other features at the gaming device 2210 where the player is wagering. Additionally, multiple databases 2490 and/or servers 2480 may be present and coupled to one or more networks 2250 to provide a variety of gaming services, such as both game/tournament data and player tracking data.

The various systems described with reference to FIGS. 22A-24 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

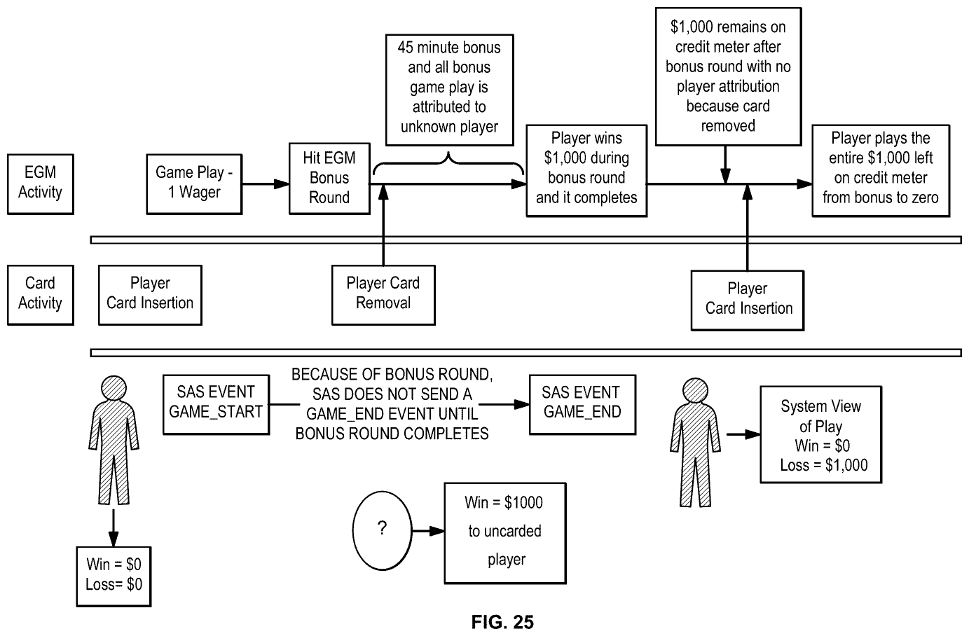

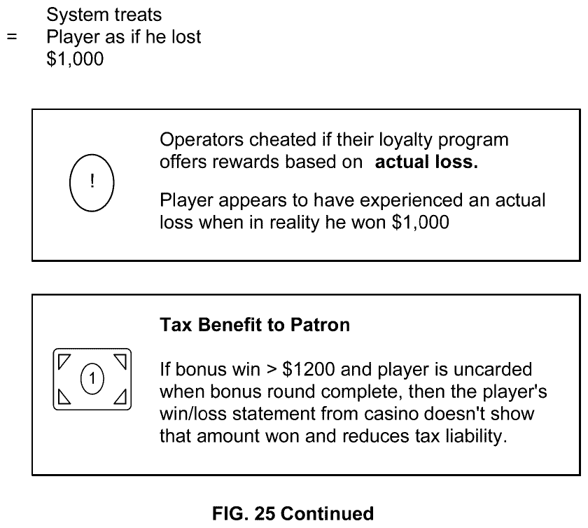

FIG. 25 shows an example method 2500. The method 2500 may be carried out via any one or more devices as described herein. Throughout this description, “card-in” “card-out,” “player identifier card,” and similar terms are used. It is to be understood that the method can be implemented with virtual card-ins, virtual card-outs, and mobile device embodiments as well (e.g., a mobile device associating with an EGM may be or trigger a card-in signal, a mobile device disassociating from an EGM may be or trigger a card-out signal). For example, a player may have an application installed on a mobile device wherein the application is configured to serve as a player identifier card and is configured to cause transfer of identifying information and/or wagering information between the mobile device and the EGM.

For example, the system may comprise a player tracking device configured to track one or more account balances and/or credit meters associated with a user identifier. For example, the system may comprise a computing device configured to receive data (e.g., an event feed), and electronic game machine (e.g., an electronic casino gaming machine, a slot machine, a table game, combinations thereof, and the like, and which may be referred to as an “EGM”) configured to send data (e.g., the event feed) to the computing device.

The method may begin with detection of and/or reception of a card-in signal configured to indicate a player has inserted a player identifier card into the EGM. For example, upon the player inserting the player identifier card into the EGM, the EGM may send the card-in signal. The card-in signal may comprise a user identifier (e.g., a name, address, one or more account numbers and/or balances, combinations thereof, and the like). The card-in signal may be a slots accounting system (SAS) event.

A game start signal may be sent to the computing device. The game state signal may be configured to cause the computing device to monitor an event feed from the EGM. The game start signal may comprise an SAS event. One or more credit meters associated with the player (and/or the EGM) may begin at an initial value. For example, a win indication and a loss indication may both indicate zero dollars won or lost.

A bonus game signal may be detected. The bonus game signal may indicate that subsequent game play on the will be part of a bonus game until a bonus game end signal is received. In an embodiment, game play in the event feed from the EGM may indicate a series of game plays (e.g., a series of wagers and results) that occur without credits being deducted from a credit meter. The computing device may determine this play (that occurs without deduction of credits) comprises bonus game play.

A card-out signal may be received. The card-out signal may be configured to indicate the player has removed an associated with player identifier card. Based on receiving the card-out signal, the EGM sending the event stream or the computing device receiving the event stream from the EGM may no longer associate game play (e.g., wagers and results) with the player identifier. In this way, players may play the bonus game anonymously. In other words, subsequent game play, even without a game event, ordinarily causes either or both of the EGM and the computing device to not associate the subsequent game play, with a user identifier (e.g., player ID). During bonus game play, one or more credits may be accrued by the player.

A bonus game end event may be received. The bonus game event signal may be configured to indicate the bonus game has ended, and subsequent game play on the EGM, received before a base game end game event is part of the base game (e.g., game play occurring with deductions from credit meters in the form of wagers).

A card-in signal may be received. The card-in signal may be configured to indicate a player has inserted a player identifier card. The card-in signal may comprise the user identifier (e.g., the user identifier of the player that was playing previously). The card-in signal may be received after bonus play concludes. The one or more credits accrued during the bonus game may remain on the credit meter (at least until the base game end event). The one or more credits accrued during the bonus game that were not previously associated with a user identifier, may now be associated with that user identifier as an initial balance.

Base game play may continue and, by virtue of placing and losing wagers, the balance on the credit meter may drop. If a base game end event is received after the credit meter drops, it appears as though the player has suffered a loss. In other words, because the increase in credits accrued during the bonus game was not tracked, game play logs may indicate an actual loss when in fact, an actual loss has not occurred. For example, upon receiving the card-in signal the user identifier, legacy systems treat the credits remaining on the meter as a player's coin-in credits, rather than as credits accrued during game play (of either the base game of the bonus game).

For example, a player may initiate a game with 100 credits. During game play, a bonus game may be triggered. During bonus game player, the player may remove their player card and accrue 900 unidentified (e.g., anonymous credits or credits that are not associated with a user identifier) credits (bringing the total on the credit meter to 1,000). After bonus play, the player may insert the player card while the 1,000 credits are on the credit meter. The player may play the 1,000 credits down to 0 and end the game. In that case, the system would indicate the player lost 1,000 credits when in fact he only lost his initial 100 credits, a misattribution of 900 credits. In the case of a casino loyalty program that compensates or rewards players based on losses, the casino would misattribute and improperly reward the player.

In an alternative example, the player inserts their card and initiates the game with 100 credits (thus 100 credits are associated with the user identifier). The player then triggers the 900 bonus credits (bringing the total credits associated with the user identifier to 1,000, as above). If the player cashes out now, records would accurately reflect an increase in 900 credits. However, if the player merely removes their card without terminating game play, future game play during the present session will not be associated with the user identifier. This card removal dissociates game play on the machine from the user identifier.

Thus, for example, if the player plays the credit meter down to 500 from 1,000, and then reinserts the card, the 1,000 credits are attributed to the user as an initial credit deposit and the 500 credit decrease is associated with the user identifier. Thus, records would reflect a 500 credit decrease, even though the player is actually up 400 credits. The present methods and systems address this shortcoming of prior systems and methods.

In another scenario, a guest playing at an electronic gaming machine (EGM) triggers a bonus feature while their player card is inserted. Before playing the bonus game, the guest removes their card, which causes a card-out signal to be generated and sent to the casino's player tracking or casino management system (CMS). At that moment, the system disassociates ongoing gameplay from the player's profile.

When the guest plays the bonus game with their card removed and wins $1,000, that win is not recorded or attributed to their player tracking account because there is no active user identifier associated with the machine at that time. Later, when the guest re-inserts their card and begins to play again—spending the $1,000 they won—those wagers and resulting losses are fully attributed to the player's account. The system now sees only the loss of $1,000 without recognizing that it originated from an untracked win. As a result, the player's win/loss record in the Casino Management Platform (CMP) reflects a net loss of $1,000, despite the fact that the player is essentially “even” from their own perspective.

When this behavior is repeated multiple times—removing the card before bonus features and re-inserting it afterward to play through the winnings—the CMP records consistent losses without accounting for the untracked bonus wins. This skews the player's theoretical loss and actual win/loss data, making the guest appear to be a high-value, heavily losing player. In practice, this discrepancy can lead to distorted comp calculations, inaccurate player valuations, and potentially abusive comping strategies if not monitored and corrected.

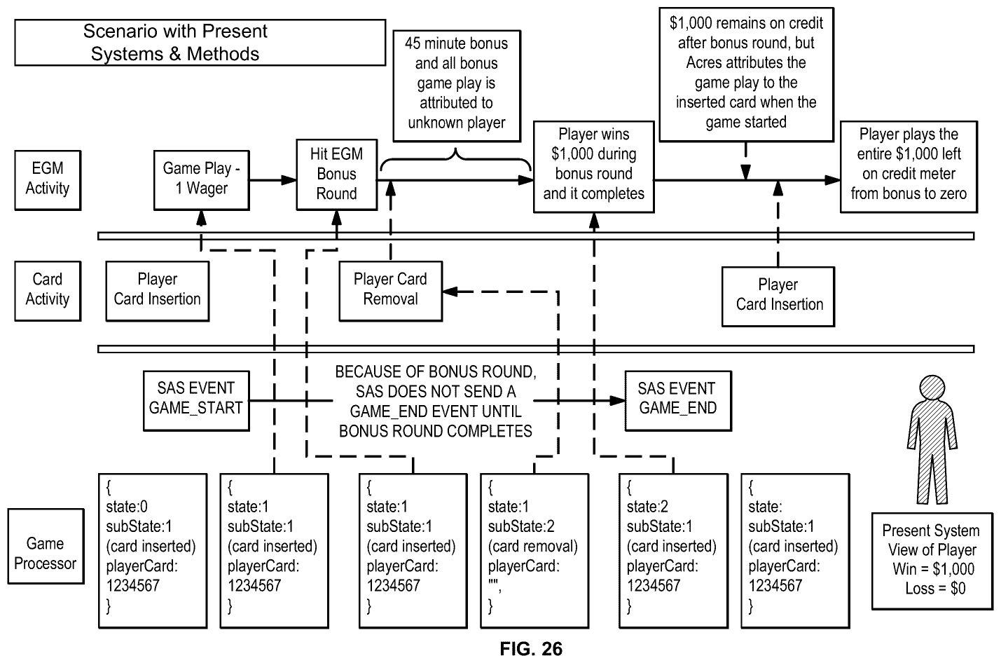

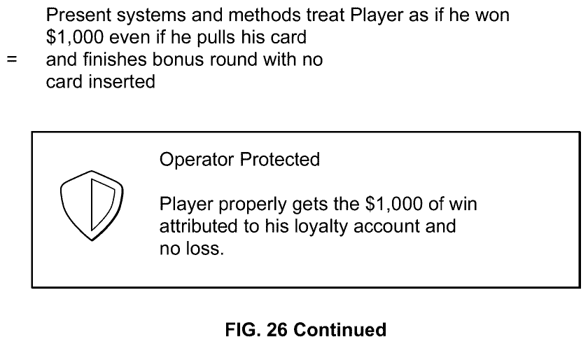

FIG. 26 shows an example method 2600. The method 2600 may be carried out via any one or more devices as described herein. The method 2600 has similarities to the method 2500. For example, a player inserts a player card, makes a wager, hits a bonus game, removes the player card, wins or loses credits during the bonus game, and then re-inserts his card. The method 2600 however, upon receiving a second card-in signal (regardless of whether or not the card-in signal comprises the same user identifier as the initial card-in signal), the computing device may attribute any game play and results thereof occurring after the card-out signal and a subsequent card-in signal to the user identifier associated with the initial card-in signal. Thus, game play and results thereof are properly attributed.

This method may comprise monitoring and identifying a specific sequence of player behavior that may lead to skewed win/loss data. For example, the system may detect carded play by player XYZ, meaning the player's card is inserted and their activity is being tracked. Next, the system may determine a removal of the player's card, generating a card-out signal. Following card removal, the player may continue to interact with the machine. During this period, the system may determine additional play that results in credits being added to the credit meter without a corresponding deduction, indicating the player is receiving winnings (e.g., from a triggered bonus game) while uncarded. The system may then detect the re-insertion of the same player's card, reestablishing the link to player XYZ's profile.

By monitoring these steps in sequence, the system maintains a running count of all credits added to the credit meter during the uncarded period. This count can then be used to adjust player XYZ's recorded winnings, ensuring the system accurately reflects their total play, even during untracked bonus sessions. In response to this behavior, the system could be configured to take additional actions, such as displaying a message on the TSD (touch screen display), notifying security personnel, or triggering other predefined protocols.

The methods and systems described herein may be configured to send one or more alerts and/or take one or more security actions (e.g., notify casino personnel, freeze game play, freeze funds etc. . . . ). The methods and systems described herein may be configured to adjust one or more paytables or one or more rules or policies based on detection of untracked game play fitting the above patterns. The method may comprise automatically transferring any credits, funds, or promotional credits to a player account associated with the user identifier in the initial card-in signal.

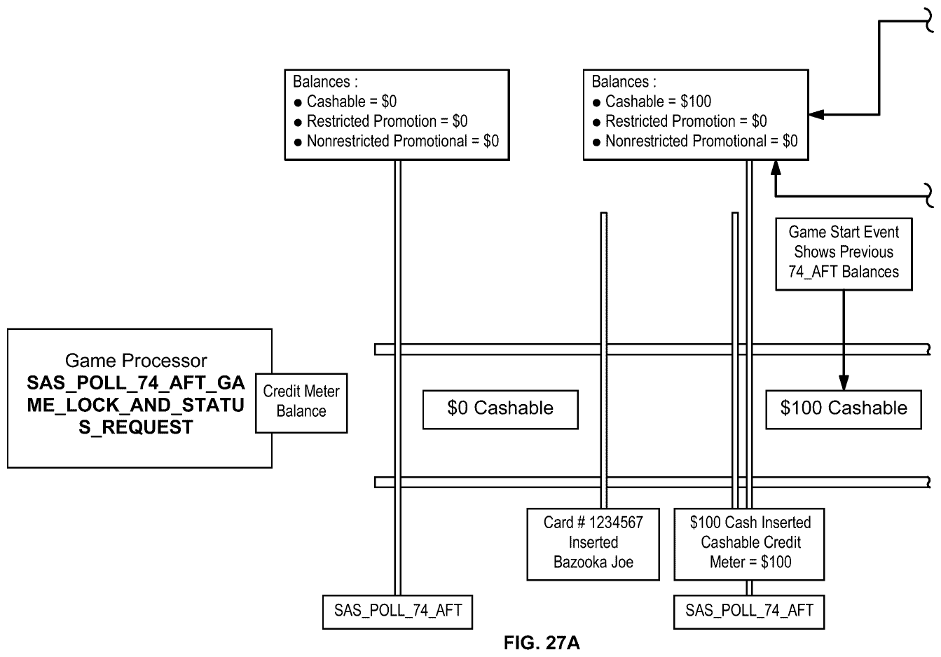

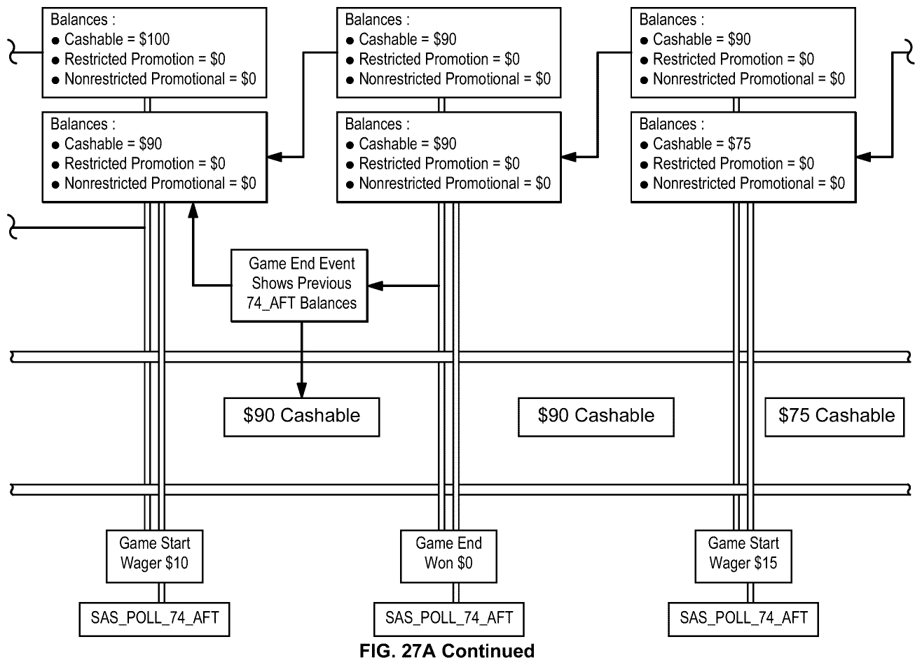

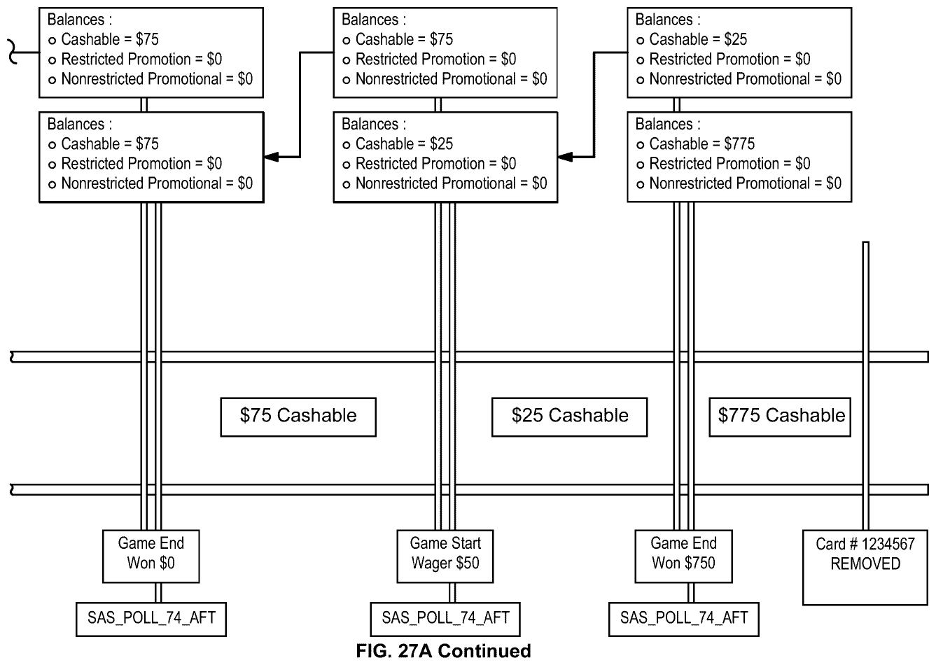

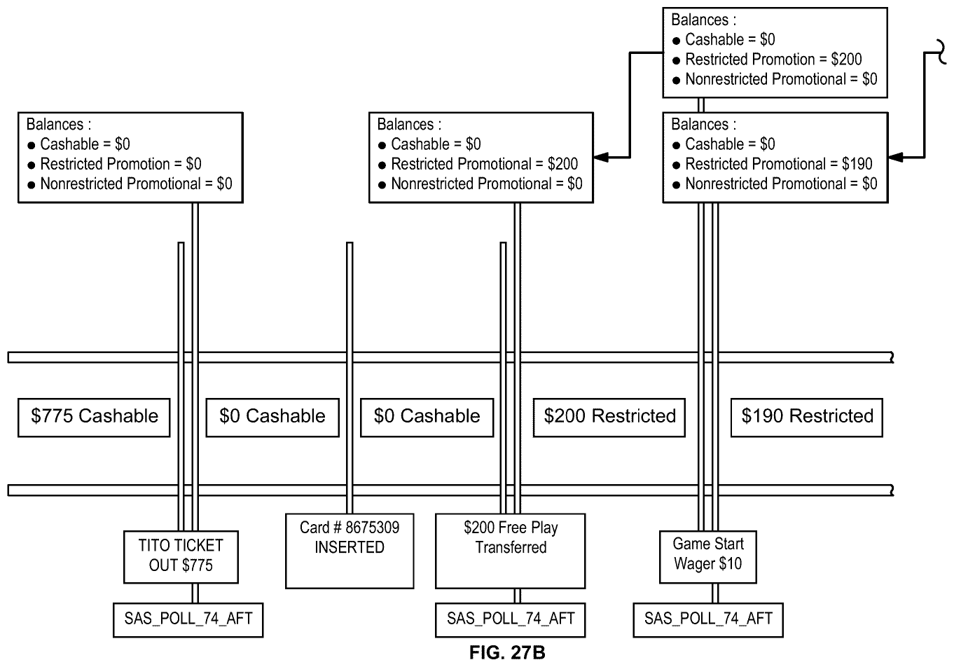

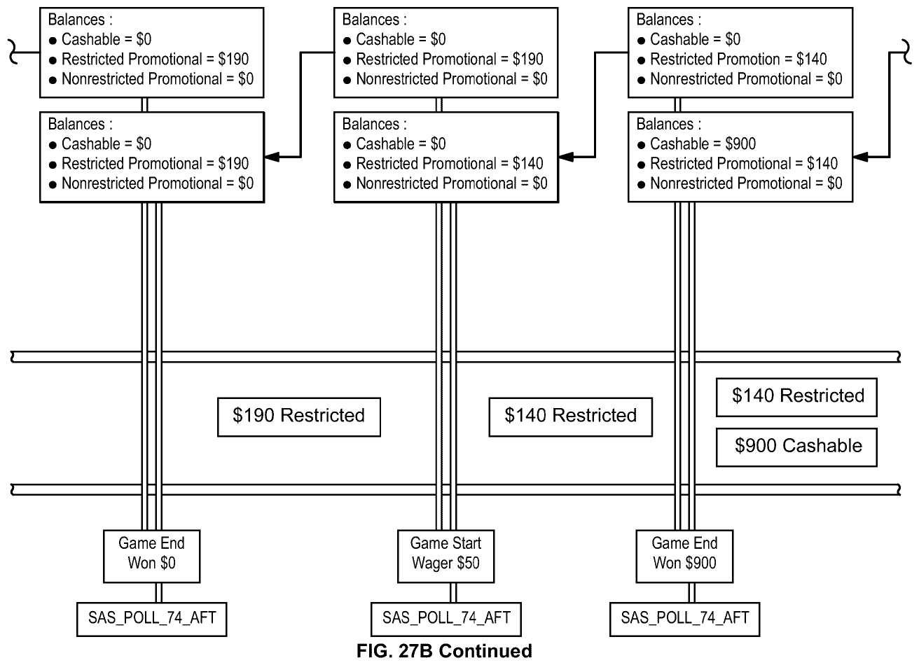

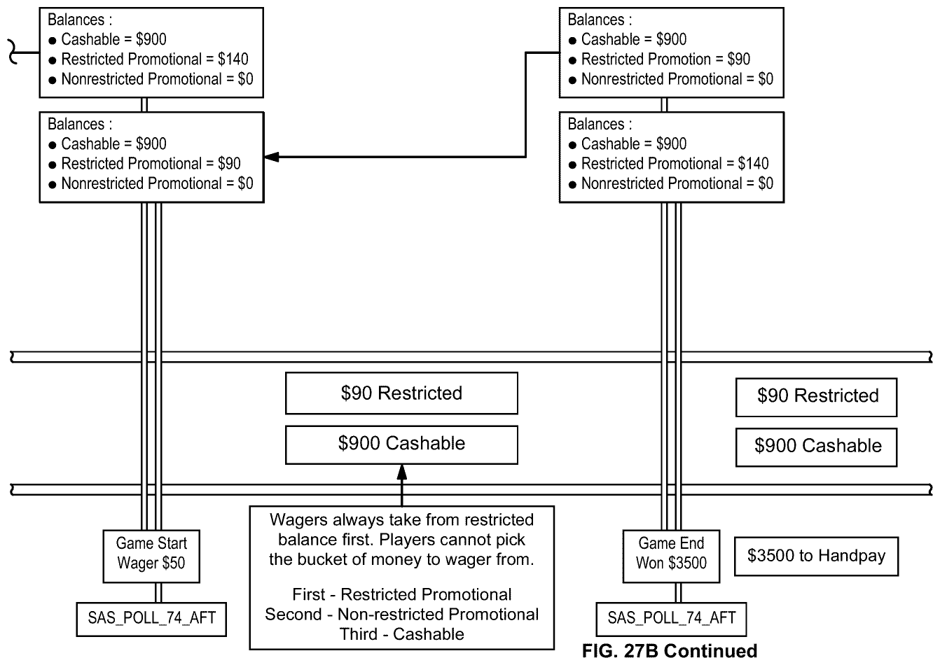

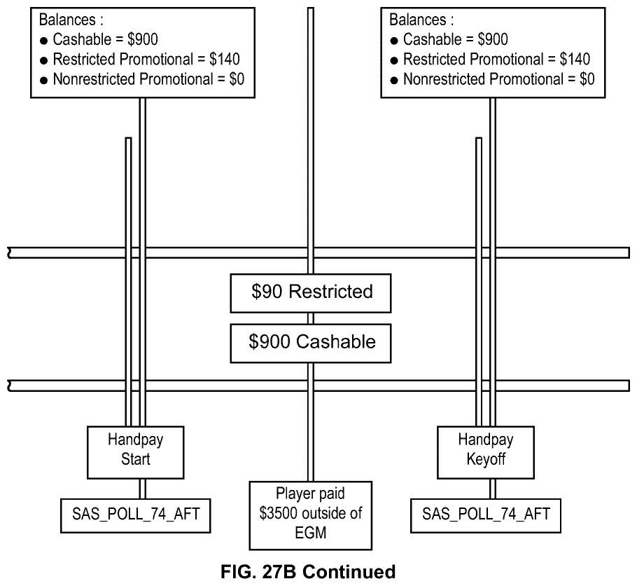

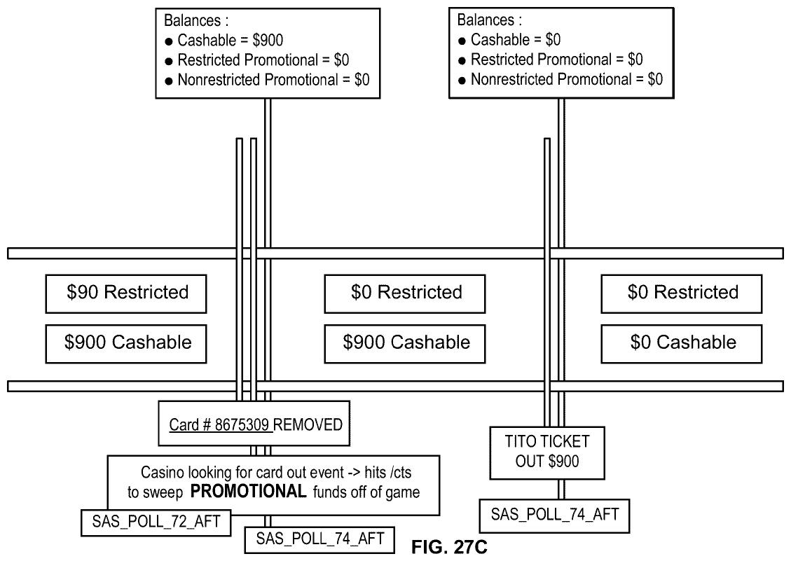

FIGS. 27A-27C show a method 2700. The method may be a game processor event timeline. In the method 2700, in response to receiving the card-out signal, an indication may be sent indicating the card-out occurred during game play (e.g., before a cash-out or other game termination event). The card-out signal is saved (e.g., in temporary storage), and upon receiving the game-end signal, the card-out signal may be sent upstream.

An event stream device (as described above) may determine the card-out signal occurred during game play and may post into a data stream (e.g., the event stream), the card-out signal. The computing device (e.g., a game processor) may monitor the event stream and populate one or more fields based on events in the event stream (e.g., identifiers, card values, credit values). The event may comprise one or more fields (e.g., instantaneous value of card, and card value for the game). At the start of the game, the instantaneous value is populated to the game value, thereby associating the card (e.g., the user identifier) with all game events in the stream from that EGM. When the player removes the card, the event stream device may send a card-out signal. In the card-out signal, the instantaneous value is blank (because there is no card in, and the card state for the game will remain at the same value as when it started).

At a later time, when the game resumes, the total amount of the win is populated to a process game event and a final game result is sent upstream. The final game result will still have the card state that began the game in the game card state field. On the next game start, the instantaneous value is populated to the card state for the duration of the game. Thus, the card value for the game state is locked at the time the game begins.

The gaming system may provide improved player tracking and bonus game management through sophisticated handling of identified and anonymous play. In operation, a player may insert a player identification card into an electronic gaming machine (EGM) to begin an identified gaming session. The system may associate gameplay data and events with the player's account during this period.

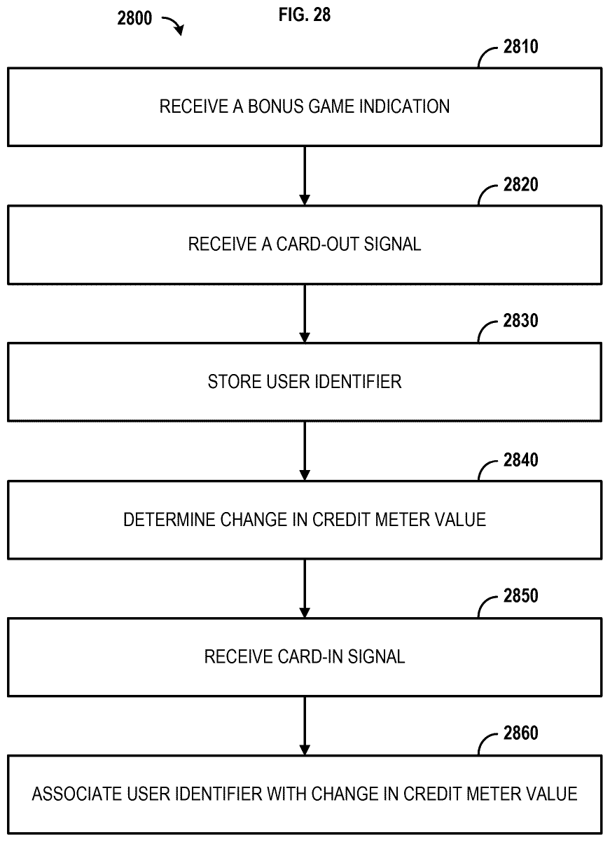

FIG. 28 shows an example method 2800. The method 2800 may be carried out via any one or more devices as described herein. At 2810, a bonus game indication may be received. A bonus game indication may comprise, for example, a digital signal sent when a bonus game is triggered. The bonus game may triggered based on one or more game outcomes. For example, the bonus game may be triggered based one on or more symbols, reel positions, combinations thereof, and the like. For example, one common trigger is the appearance of designated symbol combinations—such as three “BONUS” symbols—on a payline or within specified reel positions. Alternatively, a bonus game may be triggered randomly by the game logic, independent of visible outcomes, to maintain excitement and unpredictability. In some systems, the bonus is unlocked after a player places a minimum wager or plays a certain number of games, or upon accumulating certain in-game items or symbols over multiple spins. Player-specific factors, such as loyalty status or gameplay history linked to a player tracking card, may also serve as conditions for triggering a bonus. In networked gaming environments, a bonus game might be initiated system-wide, for example when a shared progressive jackpot threshold is reached.

The bonus game indication may comprise one or more identifiers associated with one or more players of the EGM, one or more credit balances associated with the EGM, one or more credit balances associated with one or more players of the EGM, one or more identifiers associated with one or more paytables, timing information, combinations thereof, and the like. The bonus game indication may be received by a computing device. The computing device may be in communication with an electronic gaming machine (EGM). The bonus game indication may be received in an event stream from the EGM. An event stream may comprise data indicating events on the EGM. For example, the event stream may comprise a card-in signal, card-out signal, credit balances (and changes therein), wagers, game results, maintenance events, combinations thereof, one or more identifiers associated with one or more players or accounts, timing information, location information, one or more identifiers associated with one or more players, combinations thereof, and the like. The computing device (e.g., a game processor) may monitor the event stream and populate one or more fields based on events in the event stream (e.g., identifiers, card values, credit values, wagers, came outcomes, bonus triggers, etc. . . . ). The event stream data may comprise one or more fields (e.g., instantaneous value of card, and card value for the game). For example, t the start of the game, an instantaneous value is populated to the game value, thereby associating the card (e.g., the user identifier) with all game events in the event stream from that EGM. When the player removes the card, the event stream device may send a card-out signal in the event stream. In the card-out signal, the instantaneous value is blank (because there is no card in, and the card state for the game will remain at the same value as when it started). The event stream may be sent from an electronic gaming machine (EGM). The event stream may comprise one or more events detected at/determined by the EGM. For example, the event stream may comprise a card-in event, a game start event, a bonus game event, a wager event, a result event, a card-out event, a game end event, combinations thereof, and the like. The one or more events may be sent as slot accounting system (SAS) events. An SAS event may comprise, for example, card-in events, card-out events, operational metrics such as coin-in and coin-out values, ticket issuance and redemption data, and real-time machine status indicators, player tracking such as player identification information, time-on-device metrics, loyalty point accumulation, promotional play usage, and behavioral analytics. The SAS may be further operable to produce compliance reports suitable for submission to regulatory authorities and to support audits and performance evaluations by casino operators. The SAS events may be communicated via one or more protocols, such as the SAS protocol developed by International Game Technology (IGT), or other suitable industry protocols (e.g., Game-to-System (G2S)). The SAS protocol may define a set of message structures and transmission rules for polling metering data, transmitting event logs, authenticating connections, and enabling features such as player tracking and bonusing. In some embodiments, communication may be secured via authentication procedures or encrypted data packets to ensure data integrity and prevent unauthorized access or tampering.

The bonus game indication may be received during the course of primary game play (e.g., base game play, underlying game play). The primary game play and results thereof may be associated with (e.g., attributed to) a user identifier previously determined. “Primary game play” may refer to the foundational or base-level gaming activity conducted on an electronic gaming machine or digital platform prior to the initiation of any secondary features or bonus events. The primary game play may comprise execution of a standard wagering game such as, but not limited to, a virtual slot machine game, a video poker game, a virtual table game (e.g., blackjack, roulette, baccarat), or any other electronically presented game of chance or skill configured to accept wagers, generate outcomes, and provide payouts according to predefined rules. For example, in the case of a virtual slot machine, the primary game play may include the act of placing a wager, initiating a spin of virtual reels, and determining a game outcome based on a random number generator (RNG) and symbol alignment on one or more paylines. In a virtual card game, such as video poker, primary game play may involve dealing a hand of cards, permitting player input for holding or discarding cards, and determining a result based on the final hand ranking. In a virtual table game, primary game play may involve the selection of a wager amount and bet type, the system-simulated dealing or spinning of game elements (e.g., cards, dice, wheels), and evaluation of the result against the game's rules.

The outcomes generated during primary game play may trigger other features, such as a bonus game or progressive jackpot eligibility. In this regard, a “bonus game indication” received during the course of primary game play may signify that a bonus event—separate and distinct from the base wagering activity—has been activated. The primary game play and any results therefrom may be associated with, and attributed to, a user identifier, which may correspond to a player account, loyalty card number, session ID, or other unique player-tracking data previously determined or stored within the system.

At 2820, a card-out signal may be received. For example, the card-out signal may be triggered based on a removal of a card (e.g., a player identifier card, loyalty card, etc) from the EGM. This removal may be detected by the hardware through a change in card reader status, which in turn initiates a message from the gaming device or slot machine interface board (SMIB) to the casino management system (CMS) or player tracking system. In some configurations, the card-out signal may also be triggered automatically after a period of inactivity or session timeout, depending on system settings. The card-out signal may be caused by a disassociation of a mobile device or other electronic device from the EGM. For example, if a player initiates play via a mobile device and then severs the connection between the mobile device and the EGM, the card-out signal may be triggered. The card-out signal may comprise the user identifier. The card-out signal may comprise a timestamp marking the exact moment the card was removed. The signal may also include the identifier of the gaming device from which the card was withdrawn, allowing the system to associate the event with a specific location on the casino floor. Additionally, the card-out signal may encapsulate session-related metrics, such as total coin-in and coin-out values, number of games played, total wagers made, loyalty points accrued, and any promotional rewards earned during the session. In certain implementations, the signal may also include the game state at the time of card removal, player status data (e.g., tier level or comp balance), and security information such as event codes, software versioning, or session authentication tokens. The card-out signal may be received by a computing device. The card-out signal may occur during game play on an electronic gaming machine (EGM). The card-out signal may be received after a bonus-game signal. The bonus-game signal may be configured to indicate a bonus game has been triggered. The card-out signal may comprise a slot account system (SAS).

At 2830, the user identifier may be maintained in storage. The card-out signal may be configured to indicate the player has removed a player identifier card. This action typically causes a disassociation of the user identifier with subsequent gameplay. However, in the present method, maintaining the user identifier may comprise contemporaneously associating game play with a user identifier despite the card-out signal and/or attributing uncarded play to the user identifier associated with the previous game play. For example, based on the bonus game indication and the card-out signal, the user identifier that was initially associated with the EGM and gameplay thereon, may be maintained in a database. In prior systems, the card-out signal typically causes the EGM sending the event stream or the computing device receiving the event stream from the EGM to no longer associate game play (e.g., wagers and results) with the player identifier. In other words, in prior systems, subsequent game play, even without a game event, ordinarily causes either or both of the EGM and the computing device to not associate the subsequent game play, with a user identifier (e.g., player ID) and thus play on a machine which occurs after the card-out signal is effectively anonymous. The present systems and methods, however, maintain the user identifier in storage despite the card-out signal.

For example, the user identifier is may be communicated to and stored within a casino management system (CMS) or player tracking system, which may be resident on the EGM or on another computer and which may comprise one or more servers, data processing modules, and storage components configured to handle real-time gaming and player interaction data. For example, if a triggering event occurs—such as a bonus game indication generated by the EGM's game logic—a message may be transmitted from the EGM or its slot machine interface board (SMIB) to the CMS, including the current game state, the triggering event type, and the user identifier associated with the ongoing session. Typically, upon receipt of a card-out signal, the user identifier is cleared from storage. The present systems and methods maintain the user identifier despite the card-out signal.

At 2840, a change in a credit meter value may be determined. The credit meter may be configured to indicate a total number of credits remaining on the gaming machine 200 that are eligible to be wagered. The credit meter may be configured to indicate a number of credits eligible to transfer to another player or transfer to an attendant as a tip. The credit meter may reflect a monetary unit, such as dollars, or an amount of credits. The bill/ticket acceptor may be configured to recognize and/or validate currency (e.g., paper bills) and/or printed tickets and may be configured to cause the game processor to display a corresponding amount on the credit meter. The change in the credit meter value may reflect changes occurring during the bonus game play. The bonus game play may not be associated with the user identifier.

At 2850, a card-in signal may be received (e.g., detected, determined). The “card-in” signal may be triggered when a player inserts a loyalty or player tracking card into the card reader of an electronic gaming machine (EGM). The card reader detects the physical insertion of the card and reads the encoded data, typically including a unique user identifier such as a player ID or loyalty account number. Once the card is validated, the card reader transmits this data to a Slot Machine Interface Board (SMIB) or, in some configurations, directly to the casino management system (CMS) or player tracking system. The SMIB may generates a card-in message and communicate it to the CMS using, for example, serial protocols such as RS-232 or RS-485, or network-based protocols such as TCP/IP over Ethernet. The CMS may respond with an acknowledgment, confirming the successful initiation of the session and enabling tracking of player activity.

The card-in signal may comprise, for example the user identifier, a timestamp marking the exact time of card insertion, the machine identifier (which uniquely identifies the EGM or its location), and the identifier of the specific card reader used. Additional information may include a session ID, the player's loyalty tier or status, current game configuration details (such as paytables, denominations or game titles), and versioning data for system audit purposes. In some cases, the signal may also contain authentication tokens to validate the session and promotional flags indicating player eligibility for rewards or targeted marketing. The card-in signal typically marks the start of a “carded session,” enabling personalized experiences, accurate player tracking, and compliance with operational and regulatory standards. The card-in signal may comprise the user identifier. The method may determine the user identifier in the card-in signal is the same as the user identifier maintained in storage. The method may comprise determining timing information associated with and/or based on the card-in signal. For example, a difference in time between the card-out signal and the card-in signal.

At 2860, based on receiving the card-in signal, the change in the credit meter value may be associated with (e.g., attributed to) the user identifier. For example, after the card-in signal is received, the system may initiate a process to associate the newly initiated session (e.g., the session initiated by virtue of the card-in signal) with data from a previous session (e.g., session data associated with the previously received card-out signal), including a balance or other session metrics determined at the time of a prior card-out signal. When the player's card is inserted and the card-in signal is received by the casino management system (CMS) or player tracking system, the system may extract the user identifier embedded in the card-in data. This identifier may be used as a key to query a database or persistent storage system where records of previous player activity are maintained.

If a prior card-out signal had been recorded for that same user identifier, the CMS may have stored the session-ending data—such as credit balance, accrued loyalty points, or pending promotional awards—associated with the user's last interaction on a particular electronic gaming machine (EGM) or across the network. Upon receiving the card-in signal, the CMS may retrieve this previously stored data and associate it with the new session initiated by the current card-in event.

The method may comprise tracking play during the bonus game and determining additional game play without deduction from a credit meter. Tracking bonus game play may comprise determining an amount of credits added to a credit meter from game wins not associated with deductions from the credit meter. Tracking bonus game play may comprise determining an amount of credits deducted from a credit meter associated with the bonus game wherein the amount of credits deducted from the credit meter is not associated with the user identifier during the bonus game. The method may comprise determining, based on the change in the credit meter value, one or more account balance changes associated with the user identifier.

The method may comprise determining and/or confirming a player identity. For example upon either or both of the card-out signal and/or the card-in signal, image data may be captured. For example, a camera at the EGM may capture the image data. The image data may comprise an image of a user in proximity to the EGM at the time of the card-out and/or card-in signals. The image data may be used to confirm the identity of a user who triggered the card-out or card-in signal. Other data may be collected such as audio data (for voice recognition), biometric data such finger prints via fingerprint scanner, iris scans, combinations, thereof, and the like. This data may be used to verify player identity.

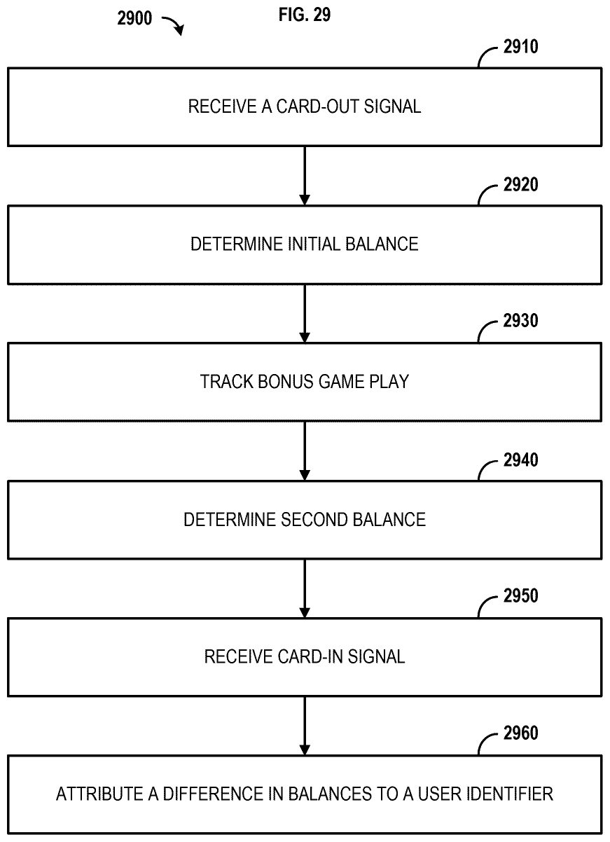

FIG. 29 shows an example method 2900. The method 2900 may be carried out via any one or more devices as described herein. At 2910, a card-out signal, wherein the card-out signal comprises a user identifier. The card-out signal may be received by a computing device. The card-out signal may occur during game play (e.g., base game or bonus game) on an electronic gaming machine (EGM). The card-out signal may be received via an event stream. For example, an event stream device may determine the card-out signal occurred during game play and may post into a data stream (e.g., the event stream), the card-out signal. The computing device (e.g., a game processor) may monitor the event stream and populate one or more fields based on events in the event stream (e.g., identifiers, card values, credit values). The event may comprise one or more fields (e.g., instantaneous value of card, and card value for the game). At the start of the game, the instantaneous value is populated to the game value, thereby associating the card (e.g., the user identifier) with all game events in the stream from that EGM. When the player removes the card, the event stream device may send a card-out signal. In the card-out signal, the instantaneous value is blank (because there is no card in, and the card state for the game will remain at the same value as when it started).

The card-out signal may be configured to indicate the player has removed a player identifier card. Based on receiving the card-out signal, the EGM sending the event stream or the computing device receiving the event stream from the EGM may no longer associate game play (e.g., wagers and results) with the player identifier. In this way, players may play the bonus game anonymously. In other words, subsequent game play, even without a game event, ordinarily causes either or both of the EGM and the computing device to not associate the subsequent game play, with a user identifier (e.g., player ID). The card-out signal may be received after a bonus-game signal. The bonus-game signal may be configured to indicate a bonus game has been triggered. The card-out signal may comprise a slot account system (SAS) event and wherein the card-in signal comprises an SAS event.

At 2920, an initial balance associated with the user identifier may be determined. The initial balance associated with the user identifier may reflect a credit meter value associated with the credit meter of the EGM at the time the card-out signal was received.

At 2930, bonus game play on the EGM may be tracked. In prior art systems, the bonus game play, by virtue of the card-out signal, would not be associated with the user identifier. However, in the present method, tracking the bonus game play may comprise associating the bonus game play with the user identifier despite the card-out signal. Tracking the bonus game play may comprise contemporaneously associating game events from the event stream with the user identifier despite the card-out signal which ordinarily causes a disassociation between the events in the event stream and the user identifier. Tracking the bonus game play may comprise retroactively attributing uncarded (e.g., anonymous game play) with a previous user identifier. This may be referred to as “retroactive attribution,” “post hoc attribution,” “deferred attribution,” or “back-attribution.”

At 2940, a second balance associated with the credit meter of the EGM may be determined. For example, the second balance may be less than then initial balance. For example, a player may initiate a game with 100 credits. During game play, a bonus game may be triggered. During bonus game player, the player may remove their player card and accrue 900 unidentified (e.g., anonymous credits or credits that are not associated with a user identifier) credits (bringing the total on the credit meter to 1,000). After bonus play, the player may insert the player card while the 1,000 credits are on the credit meter. The player may play the 1,000 credits down to 0 and end the game. In that case, the system would indicate the player lost 1,000 credits when in fact he only lost his initial 100 credits, a misattribution of 900 credits. In the case of a casino loyalty program that compensates or rewards players based on losses, the casino would misattribute and improperly reward the player.

In an alternative example, the player inserts their card and initiates the game with 100 credits (thus 100 credits are associated with the user identifier). The player then triggers the 900 bonus credits (bringing the total credits associated with the user identifier to 1,000, as above). If the player cashes out now, records would accurately reflect an increase in 900 credits. However, if the player merely removes their card without terminating game play, future game play during the present session will not be associated with the user identifier. This card removal typically dissociates game play on the machine from the user identifier. However, the present methods and systems maintain the association between identifier and gameplay despite the card-out signal.

Thus, for example, if the player plays the credit meter down to 500 from 1,000, and then reinserts the card, the 1,000 credits are attributed to the user as an initial credit deposit and the 500 credit decrease is associated with the user identifier. Thus, records would reflect a 500 credit decrease, even though the player is actually up 400 credits. The present methods and systems address this shortcoming of prior systems and methods.

At 2950, a card-in signal may be received. The card-in signal may comprise a second user identifier. The second user identifier may be the same as the user identifier. The second user identifier may be different from the user identifier. The method may determine whether the second identifier is the same as the user identifier or different from the user identifier. If the second user identifier is the same as the user identifier associated with the card-out signal (e.g., the identifier associated with game play at the time the card-out signal was triggered, sent and/or received the system may attribute game play occurring after the card-out signal to the user identifier and thus determine an accurate record of game play to be associated with the user identifier.

At 2960, based on receiving the card-in signal, attributing a difference between the initial balance and the second balance to the user identifier. In prior art systems, the bonus game play, by virtue of the card-out signal, would not be associated with the user identifier. However, in the present method, tracking the bonus game play may comprise associating the bonus game play with the user identifier despite the card-out signal. Tracking the bonus game play may comprise contemporaneously associating game events from the event stream with the user identifier despite the card-out signal which ordinarily causes a disassociation between the events in the event stream and the user identifier. Tracking the bonus game play may comprise retroactively attributing uncarded (e.g., anonymous game play) with a previous user identifier. This may be referred to as “retroactive attribution,” “post hoc attribution,” “deferred attribution,” or “back-attribution.”

The method may comprise sending, based on the card-out signal, an alert to a security device. The method may further comprise receiving a second card-in signal comprising a second user identifier. The method may further comprise adjusting an account balance associated with the user identifier according to the difference between the initial balance and the second balance.

The method may comprise determining and/or confirming a player identity. For example upon either or both of the card-out signal and/or the card-in signal, image data may be captured. For example, a camera at the EGM may capture the image data. The image data may comprise an image of a user in proximity to the EGM at the time of the card-out and/or card-in signals. The image data may be used to confirm the identity of a user who triggered the card-out or card-in signal.

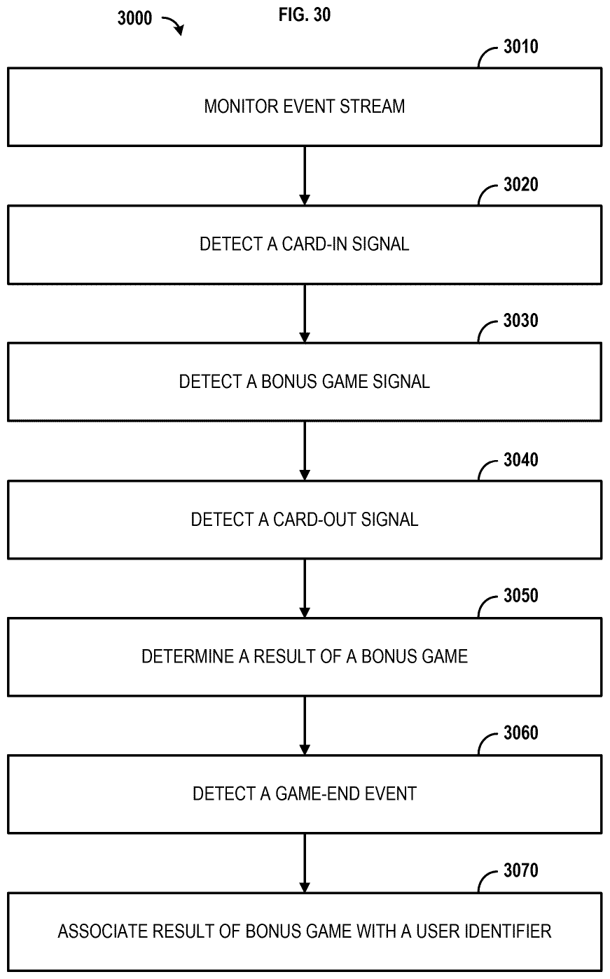

FIG. 30 shows an example method 3000. The method 3000 may be carried out via any one or more devices as described herein. At 3010, an event stream may be monitored. The event stream may, for example, be monitored by a computing device. The event stream may be sent from an electronic gaming machine (EGM). The event stream may comprise one or more events detected at/determined by the EGM. The event stream may comprise one or more fields (e.g., instantaneous value of card, card value for the game, one or more identifiers associated with a player, one or more identifiers associated with a game, location information, timing information, wager data, game outcome data, bonus data, combinations thereof, and the like). At the start of the game, the instantaneous value is populated to the game value, thereby associating the card (e.g., the user identifier) with all game events in the stream from that EGM. For example, the event stream may comprise a card-in event, a game start event, a bonus game event, a wager event, a result event, a card-out event, a game end event, combinations thereof, and the like. The one or more events may be sent as slot accounting system (SAS) events.

At 3020, a card-in signal (e.g., card-in event) may be detected in the event stream. For example, upon the player inserting the player identifier card into the EGM, the EGM may send the card-in signal. The card-in signal may comprise a user identifier (e.g., a name, address, one or more account numbers and/or balances, combinations thereof, and the like). The card-in signal may be a slots accounting system (SAS) event. The card-in signal may comprise a user identifier. The user identifier may be associated with a user account. An account balance of the user account may be determined. The card-in signal may be configured to indicate a player has inserted or otherwise caused a player identifier to be associated with the EGM and gameplay thereon. The card-in signal may comprise one or more fields. For example, the one or more fields may comprise a card value field. The card value field may be populated with a user identifier. The one or more fields may comprise a credit balance field configured to indicate an initial amount of credits transferred to a credit meter.

At 3030, a bonus game signal may be detected in the event stream. The bonus game signal may be configured to indicate a bonus game has been triggered. The bonus game may comprise gameplay that occurs without deduction of credits from the credit meter associated with the EGM (e.g., the player is playing with “bonus” credits). The bonus game signal may indicate that subsequent game play on the will be part of a bonus game until a bonus game end signal is received. In an embodiment, game play in the event feed from the EGM may indicate a series of game plays (e.g., a series of wagers and results) that occur without credits being deducted from a credit meter. The computing device may determine this play (that occurs without deduction of credits) comprises bonus game play.

At 3040, a card-out signal may be detected in the event stream. The card out signal may be configured to indicate the player has removed the player identifier from the EGM (or otherwise caused the player identifier to no longer be associated with the EGM or gameplay occurring thereon). The card-out signal may be configured to indicate the player has removed an associated with player identifier card. Based on receiving the card-out signal, the EGM sending the event stream or the computing device receiving the event stream from the EGM may no longer associate game play (e.g., wagers and results) with the player identifier. In this way, players may play the bonus game anonymously. In other words, subsequent game play, even without a game event, ordinarily causes either or both of the EGM and the computing device to not associate the subsequent game play, with a user identifier (e.g., player ID). During bonus game play, one or more credits may be accrued by the player.

At 3050, a result of the bonus game may be determined. The result of the bonus game may be determined by the computing device. By virtue of the player identifier being removed, the result of the bonus game may not be associated with the player identifier. For example, a player may initiate a game with 100 credits. During game play, a bonus game may be triggered. During bonus game player, the player may remove their player card and accrue 900 unidentified (e.g., anonymous credits or credits that are not associated with a user identifier) credits (bringing the total on the credit meter to 1,000). After bonus play, the player may insert the player card while the 1,000 credits are on the credit meter. The player may play the 1,000 credits down to 0 and end the game. In that case, the system would indicate the player lost 1,000 credits when in fact he only lost his initial 100 credits, a misattribution of 900 credits. In the case of a casino loyalty program that compensates or rewards players based on losses, the casino would misattribute and improperly reward the player.

In an alternative example, the player inserts their card and initiates the game with 100 credits (thus 100 credits are associated with the user identifier). The player then triggers the 900 bonus credits (bringing the total credits associated with the user identifier to 1,000, as above). If the player cashes out now, records would accurately reflect an increase in 900 credits. However, if the player merely removes their card without terminating game play, future game play during the present session will not be associated with the user identifier. This card removal dissociates game play on the machine from the user identifier.

Thus, for example, if the player plays the credit meter down to 500 from 1,000, and then reinserts the card, the 1,000 credits are attributed to the user as an initial credit deposit and the 500 credit decrease is associated with the user identifier. Thus, records would reflect a 500 credit decrease, even though the player is actually up 400 credits. The present methods and systems address this shortcoming of prior systems and methods.

In another scenario, a guest playing at an electronic gaming machine (EGM) triggers a bonus feature while their player card is inserted. Before playing the bonus game, the guest removes their card, which causes a card-out signal to be generated and sent to the casino's player tracking or casino management system (CMS). At that moment, the system disassociates ongoing gameplay from the player's profile.

When the guest plays the bonus game with their card removed and wins $1,000, that win is not recorded or attributed to their player tracking account because there is no active user identifier associated with the machine at that time. Later, when the guest re-inserts their card and begins to play again—spending the $1,000 they won—those wagers and resulting losses are fully attributed to the player's account. The system now sees only the loss of $1,000 without recognizing that it originated from an untracked win. As a result, the player's win/loss record in the Casino Management Platform (CMP) reflects a net loss of $1,000, despite the fact that the player is essentially “even” from their own perspective.

At 3060, a game-end event may be determined. The game-end event may be configured to indicate a player has caused game play on the EGM to cease. The game-end event may be triggered by a user input (e.g., a user selecting a “game end” button), a cash-out event, or a disassociation of a mobile device from the EGM. One or more credits may remain on the credit meter.

At 3070, based on detecting the game-end event, associating the result of the bonus game with the user identifier. This method may comprise monitoring and identifying a specific sequence of player behavior that may lead to skewed win/loss data. For example, the system may detect carded play by player XYZ, meaning the player's card is inserted and their activity is being tracked. Next, the system may determine a removal of the player's card, generating a card-out signal. Following card removal, the player may continue to interact with the machine. During this period, the system may determine additional play that results in credits being added to the credit meter without a corresponding deduction, indicating the player is receiving winnings (e.g., from a triggered bonus game) while uncarded. The system may then detect the re-insertion of the same player's card, reestablishing the link to player XYZ's profile.

By monitoring these steps in sequence, the system maintains a running count of all credits added to the credit meter during the uncarded period. This count can then be used to adjust player XYZ's recorded winnings, ensuring the system accurately reflects their total play, even during untracked bonus sessions. In response to this behavior, the system could be configured to take additional actions, such as displaying a message on the TSD (touch screen display), notifying security personnel, or triggering other predefined protocols.

The methods and systems described herein may be configured to send one or more alerts and/or take one or more security actions (e.g., notify casino personnel, freeze game play, freeze funds etc. . . . ). The methods and systems described herein may be configured to adjust one or more paytables or one or more rules or policies based on detection of untracked game play fitting the above patterns. The method may comprise automatically transferring any credits, funds, or promotional credits to a player account associated with the user identifier in the initial card-in signal.

The method may comprise receiving a card-in signal comprising the user identifier. The method may further comprise adjusting, based on the result of the bonus game, an account balance associated with the user identifier. The method may comprise sending, based on the card-out signal, an alert to a security device.

The method may comprise determining and/or confirming a player identity. For example upon either or both of the card-out signal and/or the card-in signal, image data may be captured. For example, a camera at the EGM may capture the image data. The image data may comprise an image of a user in proximity to the EGM at the time of the card-out and/or card-in signals. The image data may be used to confirm the identity of a user who triggered the card-out or card-in signal.

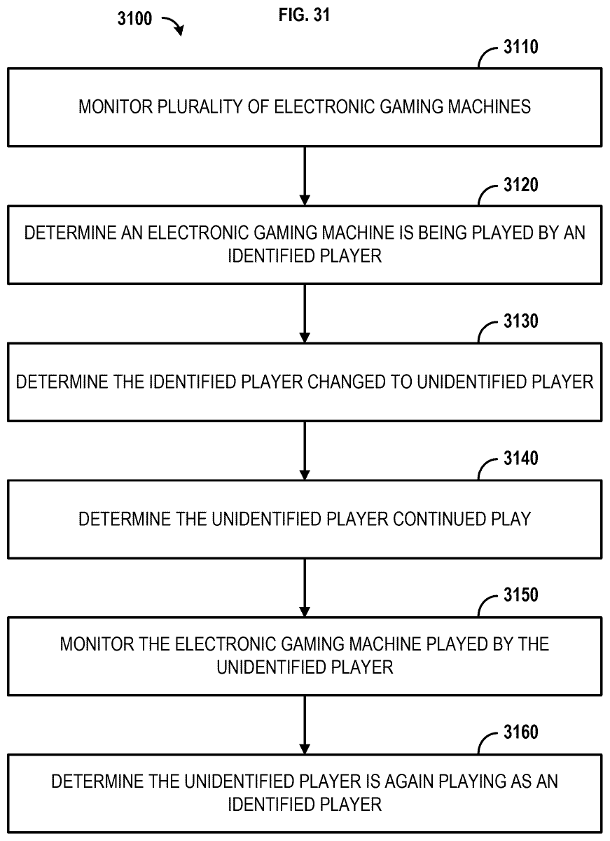

FIG. 31 shows an example method 3100. The method 3100 may be carried out via any one or more devices as described herein. At 3110, a computing device may monitor a plurality of electronic gaming machines (EGMs). The plurality of EGMs may comprise, for example, one or more casino games such as slot machines, card games, table games, dice games, spinning wheel games, combinations thereof, and the like. The plurality of EGMs may be monitored by a computing device. The computing device may receive a plurality of event streams from the plurality of EGMs (e.g., one or more event streams per EGM). The plurality of event streams may comprise one or more events such as card-in event, a card-out event, a game start event, a game end event, a wager event, a wager result event, combinations thereof, and the like.

Monitoring the plurality of EGMs may comprise receiving, from the one or more EGMs, one or more event streams. For example, an event stream device may determine the card-out signal occurred during game play and may post into a data stream (e.g., the event stream), the card-out signal. The computing device (e.g., a game processor) may monitor the event stream and populate one or more fields based on events in the event stream (e.g., identifiers, card values, credit values). The event may comprise one or more fields (e.g., instantaneous value of card, and card value for the game). At the start of the game, the instantaneous value is populated to the game value, thereby associating the card (e.g., the user identifier) with all game events in the stream from that EGM. When the player removes the card, the event stream device may send a card-out signal. In the card-out signal, the instantaneous value is blank (because there is no card in, and the card state for the game will remain at the same value as when it started).

An event stream may comprise data indicating events on the EGM. For example, the event stream may comprise a card-in signal, card-out signal, credit balances (and changes therein), wagers, game results, maintenance events, combinations thereof, one or more identifiers associated with one or more players or accounts, timing information, location information, one or more identifiers associated with one or more players, combinations thereof, and the like. The computing device (e.g., a game processor) may monitor the event stream and populate one or more fields based on events in the event stream (e.g., identifiers, card values, credit values, wagers, came outcomes, bonus triggers, etc. . . . ). The event stream data may comprise one or more fields (e.g., instantaneous value of card, and card value for the game). For example, t the start of the game, an instantaneous value is populated to the game value, thereby associating the card (e.g., the user identifier) with all game events in the event stream from that EGM. When the player removes the card, the event stream device may send a card-out signal in the event stream. In the card-out signal, the instantaneous value is blank (because there is no card in, and the card state for the game will remain at the same value as when it started). The event stream may be sent from an electronic gaming machine (EGM). The event stream may comprise one or more events detected at/determined by the EGM. For example, the event stream may comprise a card-in event, a game start event, a bonus game event, a wager event, a result event, a card-out event, a game end event, combinations thereof, and the like. The one or more events may be sent as slot accounting system (SAS) events. An SAS event may comprise, for example, card-in events, card-out events, operational metrics such as coin-in and coin-out values, ticket issuance and redemption data, and real-time machine status indicators, player tracking such as player identification information, time-on-device metrics, loyalty point accumulation, promotional play usage, and behavioral analytics. The SAS may be further operable to produce compliance reports suitable for submission to regulatory authorities and to support audits and performance evaluations by casino operators.

At 3120, the computing device may determine an EGM of the plurality of EGMs is being played by an identified player. For example, the computing device may receive a card-in signal from the EGM. The card-in signal may comprise a player identifier. The card-in signal may comprise an account balance. The “card-in” signal may be triggered when a player inserts a loyalty or player tracking card into the card reader of an electronic gaming machine (EGM). The card reader detects the physical insertion of the card and reads the encoded data, typically including a unique user identifier such as a player ID or loyalty account number. Once the card is validated, the card reader transmits this data to a Slot Machine Interface Board (SMIB) or, in some configurations, directly to the casino management system (CMS) or player tracking system. The SMIB may generates a card-in message and communicate it to the CMS using, for example, serial protocols such as RS-232 or RS-485, or network-based protocols such as TCP/IP over Ethernet. The CMS may respond with an acknowledgment, confirming the successful initiation of the session and enabling tracking of player activity.

The card-in signal may comprise, for example the user identifier, a timestamp marking the exact time of card insertion, the machine identifier (which uniquely identifies the EGM or its location), and the identifier of the specific card reader used. Additional information may include a session ID, the player's loyalty tier or status, current game configuration details (such as paytables, denominations or game titles), and versioning data for system audit purposes. In some cases, the signal may also contain authentication tokens to validate the session and promotional flags indicating player eligibility for rewards or targeted marketing. The card-in signal typically marks the start of a “carded session,” enabling personalized experiences, accurate player tracking, and compliance with operational and regulatory standards. The card-in signal may comprise the user identifier. The method may determine the user identifier in the card-in signal is the same as the user identifier maintained in storage. The method may comprise determining timing information associated with and/or based on the card-in signal. For example, a difference in time between the card-out signal and the card-in signal.

At 3130, the computing device may determine the player has changed from being an identified player to an unidentified player. For example, during play, the player identifier may be removed from or otherwise disassociated with the EGM (and thus disassociated from gameplay thereon). Determining the player has changed from being an identified player to an unidentified player may comprise determining a card-out signal. The card-out signal may be received by a computing device. The card-out signal may occur during game play (e.g., base game or bonus game) on an electronic gaming machine (EGM). The card-out signal may be received via an event stream. For example, an event stream device may determine the card-out signal occurred during game play and may post into a data stream (e.g., the event stream), the card-out signal. The computing device (e.g., a game processor) may monitor the event stream and populate one or more fields based on events in the event stream (e.g., identifiers, card values, credit values). The event may comprise one or more fields (e.g., instantaneous value of card, and card value for the game). At the start of the game, the instantaneous value is populated to the game value, thereby associating the card (e.g., the user identifier) with all game events in the stream from that EGM. When the player removes the card, the event stream device may send a card-out signal. In the card-out signal, the instantaneous value is blank (because there is no card in, and the card state for the game will remain at the same value as when it started).

The card-out signal may be configured to indicate the player has removed a player identifier card. Based on receiving the card-out signal, the EGM sending the event stream or the computing device receiving the event stream from the EGM may no longer associate game play (e.g., wagers and results) with the player identifier. In this way, players may play the bonus game anonymously. In other words, subsequent game play, even without a game event, ordinarily causes either or both of the EGM and the computing device to not associate the subsequent game play, with a user identifier (e.g., player ID). The card-out signal may be received after a bonus-game signal. The bonus-game signal may be configured to indicate a bonus game has been triggered. The card-out signal may comprise a slot account system (SAS) event and wherein the card-in signal comprises an SAS event.

At 3140, the computing device may determine that the unidentified player continues to play the EGM after changing from the identified player to the unidentified. For example, the computing device may receive one or more game events after the card-out signal. For example, hardware components such as the card reader, credit meter, game input interface, and various sensors (e.g., touch or motion sensors) may determine player presence and actions. The system software may monitor player activity through the card tracking system and the casino management system (CMS), noting the insertion and removal of player cards and logging the corresponding player identifiers. Once a card-out signal is detected, the system may transition the session into an “unidentified” state, but continues to log game events, including button presses, credits won, and gameplay progression. If the system observes that gameplay continues immediately after the card is removed—such as credits being added to the meter or spins being initiated—it may determine that the same player is likely still at the machine. For example using pattern recognition and behavioral analysis (e.g., consistency in bet size or game selection), the system may conclude that the unidentified activity is a continuation of the previously carded session. When the player reinserts their card, the system may retroactively associate—or perform post hoc attribution of—the untracked gameplay events to the original player identifier. This may include attributing unrecorded (and/or unidentified, uncarded, anonymous) wins, bonus rounds, or wagers to the player's session history. The CMS may then update the player's win/loss records and loyalty data accordingly. Additionally, the system can be configured to trigger alerts on the touch screen display (TSD), notify security personnel, or flag the behavior for review.

At 3150, the computing device may monitor the EGM played by the unidentified player to determine play continued without a deduction from a credit meter associated with the EGM. For example, the computing device may determine there has been no change in the credit meter value of the credit meter associated with the EGM. For example, bonus game play typically occurs without a deduction from the credit meter because the credit meter typically monitors credits associated with a base game, as opposed to a bonus game (which are essentially “free” spins or credits etc. . . . )

At 3160, the computing device may determine that the unidentified player is again playing as the identified player. For example, a card-in signal (e.g., card-in event) may be detected in the event stream. The card-in signal may comprise a user identifier. The user identifier may be associated with a user account. An account balance of the user account may be determined. The card-in signal may be configured to indicate a player has inserted or otherwise caused a player identifier to be associated with the EGM and gameplay thereon. The card-in signal may comprise one or more fields. For example, the one or more fields may comprise a card value field. The card value field may be populated with a user identifier. The one or more fields may comprise a credit balance field configured to indicate an initial amount of credits transferred to a credit meter.

The method may comprise ending the game based on a card-out signal. The method may comprise determining a result of the continued play. The method may comprise adjusting, based on the result of the continued play, a player account balance associated with the user identifier. The method may comprise attributing unattributed game play to the user identifier.

The method may comprise determining and/or confirming a player identity. For example upon either or both of the card-out signal and/or the card-in signal, image data may be captured. For example, a camera at the EGM may capture the image data. The image data may comprise an image of a user in proximity to the EGM at the time of the card-out and/or card-in signals. The image data may be used to confirm the identity of a user who triggered the card-out or card-in signal.

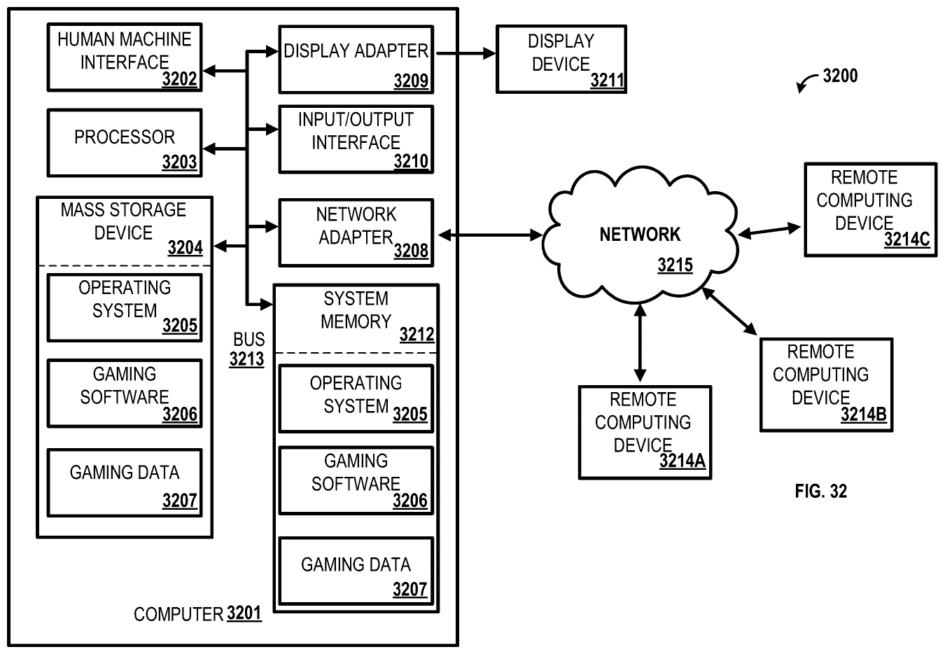

FIG. 32 shows an example system 3200. The methods and systems may be implemented on a computer 3201 as shown in FIG. 32 and described below. The methods and systems described may utilize one or more computers to perform one or more functions in one or more locations. FIG. 32 is a block diagram of an operating environment for performing the present methods. This operating environment is a single configuration of many possible configurations of an operating environment, and it is not intended to suggest any limitation as to the scope of use or functionality of operating environment architecture. Neither should the operating environment be interpreted as having any dependency or requirement relating to any one or combination of components shown in the operating environment.

The present methods and systems may be operational with numerous other general purpose or special purpose computing system environments or configurations. Well-known computing systems, environments, and/or configurations that may be suitable for use with the systems and methods may be, but are not limited to, personal computers, server computers, laptop devices, and multiprocessor systems. Additional computing systems, environments, and/or configurations are set top boxes, programmable consumer electronics, network PCs, minicomputers, mainframe computers, distributed computing environments that are composed of any of the above systems or devices, and the like.

The processing of the present methods and systems may be performed by software components. The described systems and methods may be described in the general context of computer-executable instructions, such as program modules, being executed by one or more computers or other devices. Generally, program modules are composed of computer code, routines, programs, objects, components, data structures, etc. that perform particular tasks or implement particular abstract data types. The described methods may also be practiced in grid-based and distributed computing environments where tasks are performed by remote processing devices that are linked through a communications network. In a distributed computing environment, program modules may be located in both local and remote computer storage media including memory storage devices.

Further, one skilled in the art will appreciate that the systems and methods described herein may be implemented via a general-purpose computing device in the form of a computer 3201. The components of the computer 3201 may be, but are not limited to, one or more processors 3203, a system memory 3213, and a system bus 3213 that couples various system components including the one or more processors 3203 to the system memory 3213. The system may utilize parallel computing.

The system bus 3213 represents one or more of several possible types of bus structures, including a memory bus or memory controller, a peripheral bus, an accelerated graphics port, or local bus using any of a variety of bus architectures. Such architectures may be an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 3213, and all buses specified in this description may also be implemented over a wired or wireless network connection and each of the subsystems, including the one or more processors 3203, a mass storage device 3204, an operating system 3205, wagering software 3206, wagering data 3207, a network adapter 3208, the system memory 3213, an Input/Output Interface 3210, a display adapter 3209, a display device 3211, and a human machine interface 3202, may be contained within one or more remote computing devices 3214a,b,c at physically separate locations, connected through buses of this form, in effect implementing a fully distributed system.

The computer 3201 is typically composed of a variety of computer readable media. Readable media may be any available media that is accessible by the computer 3201 and may be both volatile and non-volatile media, removable and non-removable media. The system memory 3213 may be computer readable media in the form of volatile memory, such as random access memory (RAM), and/or non-volatile memory, such as read only memory (ROM). The system memory 3213 is typically composed of data such as the gaming data 3207 and/or program modules such as the operating system 3205 and the object identification and gaming software 3206 that are immediately accessible to and/or are presently operated on by the one or more processors 3203.

The computer 3201 may also be composed of other removable/non-removable, volatile/non-volatile computer storage media. FIG. 32 shows a mass storage device 3204, which may provide non-volatile storage of computer code, computer readable instructions, data structures, program modules, and other data for the computer 3201. The mass storage device 3204 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules may be stored on the mass storage device 3204, such as the operating system 3205 and the gaming software 3206. Each of the operating system 3205 and the gaming software 3206 (or some combination thereof) may be elements of the programming and the gaming software 3206. The wagering data 3207 may also be stored on the mass storage device 3204. The gaming data 3207 may be stored in any of one or more databases known in the art. Such databases are DB2®, Microsoft® Access, Microsoft® SQL Server, Oracle®, MySQL, PostgreSQL, and the like. The databases may be centralized or distributed across multiple systems.

The user may enter commands and information into the computer 3201 via an input device (not shown). Such input devices may be, but are not limited to, a keyboard, pointing device (e.g., a “mouse”), a microphone, a joystick, a scanner, tactile input devices such as gloves, and other body coverings, and the like These and other input devices may be connected to the one or more processors 3203 via the human machine interface 3202 that is coupled to the system bus 3213, but may be connected by other interface and bus structures, such as a parallel port, game port, an IEEE 3294 Port (also known as a Firewire port), a serial port, or a universal serial bus (USB).

The display device 3211 may also be connected to the system bus 3213 via an interface, such as the display adapter 3209. It is contemplated that the computer 3201 may have more than one display adapter 3209 and the computer 3201 may have more than one display device 3211. The display device 3211 may be a monitor, an LCD (Liquid Crystal Display), or a projector. In addition to the display device 3211, other output peripheral devices may be components such as speakers (not shown) and a printer (not shown) which may be connected to the computer 3201 via the Input/Output Interface 3210. Any step and/or result of the methods may be output in any form to an output device. Such output may be any form of visual representation, including, but not limited to, textual, graphical, animation, audio, tactile, and the like. The display device 3211 and computer 3201 may be part of one device, or separate devices.

The computer 3201 may operate in a networked environment using logical connections to one or more remote computing devices 3214a,b,c. A remote computing device may be a personal computer, portable computer, smartphone, a server, a router, a network computer, a peer device or other common network node, and so on. Logical connections between the computer 3201 and a remote computing device 3214a,b,c may be made via a network 3215, such as a local area network (LAN) and/or a general wide area network (WAN). Such network connections may be through the network adapter 3208. The network adapter 3208 may be implemented in both wired and wireless environments. Such networking environments are conventional and commonplace in dwellings, offices, enterprise-wide computer networks, intranets, and the Internet.

Application programs and other executable program components such as the operating system 3205 are shown herein as discrete blocks, although it is recognized that such programs and components reside at various times in different storage components of the computing device 3201, and are executed by the one or more processors 3203 of the computer. An implementation of the gaming software 3206 may be stored on or sent across some form of computer readable media. Any of the described methods may be performed by computer readable instructions embodied on computer readable media. Computer readable media may be any available media that may be accessed by a computer. Computer readable media may be “computer storage media” and “communications media.” “Computer storage media” may be composed of volatile and non-volatile, removable and non-removable media implemented in any methods or technology for storage of information such as computer readable instructions, data structures, program modules, or other data. Further, computer storage media may be, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

The methods and systems may employ Artificial Intelligence techniques such as machine learning and iterative learning. Such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and methods and systems described therein be considered exemplary only, with a true scope and spirit being indicated by the following claims.

What is claimed is:

1. A method comprising:
receiving, during a primary game, a bonus game indication configured to indicate a bonus game has been triggered;
receiving, during the bonus game, a card-out signal;
based on receiving the card-out signal, maintaining, in storage, during the bonus game, a user identifier;
determining, based on bonus game play during the bonus game, a change in a credit meter value;
receiving a card-in signal; and
based on receiving the card-in signal, associating the user identifier with the change in credit meter value.

2. The method of claim 1, further comprising tracking play during the bonus game and determining additional game play without deduction from a credit meter.

3. The method of claim 2, wherein tracking bonus game play comprises determining an amount of credits added to a credit meter from game wins not associated with deductions from the credit meter.

4. The method of claim 2, wherein tracking bonus game play comprises determining an amount of credits deducted from a credit meter associated with the bonus game wherein the amount of credits deducted from the credit meter is not associated with the user identifier during the bonus game.

5. The method of claim 1, further comprising determining, based on the change in the credit meter value, one or more account balance changes associated with the user identifier.

6. The method of claim 1, wherein associating the user identifier with the change in the credit meter value comprises associating the user identifier with the change in the credit meter value despite the card-out signal.

7. The method of claim 1, wherein maintaining, in storage, during the bonus game, a user identifier comprises maintaining, in storage, during the bonus game, a user identifier despite the card-out signal.

8. One or more non-transitory computer readable media storing processor-executable instructions thereon, that, when executed by at least one processor, cause the at least one processor to:
receive, during a primary game, a bonus game indication configured to indicate a bonus game has been triggered;
receive, during the bonus game, a card-out signal;
based on receiving the card-out signal, maintain, in storage, during the bonus game, a user identifier;
determine, based on bonus game play during the bonus game, a change in a credit meter value;
receive a card-in signal; and
based on receiving the card-in signal, associate the user identifier with the change in credit meter value.

9. The one or more non-transitory computer readable media of claim 8, wherein the processor-executable instructions, when executed by the at least one processor, further cause the at least one processor to track play during the bonus game and determining additional game play without deduction from a credit meter.

10. The one or more non-transitory computer readable media of claim 9, wherein the processor-executable instructions that, when executed by the at least one processor, cause the at least one processor to track play during the bonus game and determining additional game play without deduction from a credit meter, further cause the at least one processor to determine an amount of credits added to a credit meter from game wins not associated with deductions from the credit meter.

11. The one or more non-transitory computer readable media of claim 9, wherein the processor-executable instructions that, when executed by the at least one processor, cause the at least one processor to track play during the bonus game and determining additional game play without deduction from a credit meter, further cause the at least one processor to determine an amount of credits deducted from a credit meter associated with the bonus game wherein the amount of credits deducted from the credit meter is not associated with the user identifier during the bonus game.

12. The one or more non-transitory computer readable media of claim 8, wherein the processor-executable instructions, when executed by the at least one processor, further cause the at least one processor to determine, based on the change in the credit meter value, one or more account balance changes associated with the user identifier.

13. The one or more non-transitory computer readable media of claim 8, wherein the processor-executable instructions that, when executed by the at least one processor, cause the at least one processor to associate the user identifier with the change in the credit meter value, further cause the at least one processor to associate the user identifier with the change in the credit meter value despite the card-out signal.

14. The one or more non-transitory computer readable media of claim 8, wherein the processor-executable instructions that, when executed by the at least one processor, cause the at least one processor to maintain, in storage, during the bonus game, a user identifier, further cause the at least one processor to maintain, in storage, during the bonus game, a user identifier despite the card-out signal.

15. An apparatus comprising:
one or more processors; and
memory storing processor-executable instructions that, when executed by the one or more processors, cause the apparatus to:
receive, during a primary game, a bonus game indication configured to indicate a bonus game has been triggered;
receive, during the bonus game, a card-out signal;
based on receiving the card-out signal, maintain, in storage, during the bonus game, a user identifier;
determine, based on bonus game play during the bonus game, a change in a credit meter value;
receive a card-in signal; and
based on receiving the card-in signal, associate the user identifier with the change in credit meter value.

16. The apparatus of claim 15, wherein the processor-executable instructions, when executed by the one or more processors, further cause the one or more processors to track play during the bonus game and determining additional game play without deduction from a credit meter.

17. The apparatus of claim 16, wherein the processor-executable instructions that, when executed by the one or more processors, cause the one or more processors to track play during the bonus game and determining additional game play without deduction from a credit meter, further cause the one or more processors to determine an amount of credits added to a credit meter from game wins not associated with deductions from the credit meter.

18. The apparatus of claim 16, wherein the processor-executable instructions that, when executed by the one or more processors, cause the one or more processors to track play during the bonus game and determining additional game play without deduction from a credit meter, further cause the one or more processors to determine an amount of credits deducted from a credit meter associated with the bonus game wherein the amount of credits deducted from the credit meter is not associated with the user identifier during the bonus game.

19. The apparatus of claim 15, wherein the processor-executable instructions that, when executed by the one or more processors, cause the one or more processors to associate the user identifier with the change in the credit meter value, further cause the at least one processor to associate the user identifier with the change in the credit meter value despite the card-out signal.

20. The apparatus of claim 15, wherein the processor-executable instructions that, when executed by the one or more processors, cause the one or more processors to maintain, in storage, during the bonus game, a user identifier, further cause the one or more processors to maintain, in storage, during the bonus game, a user identifier despite the card-out signal.
